(19) United States
(12) Patent Application Publication
(10) Pub. No.: US 2025/0227705 A1
(43) Pub. Date: Jul. 10, 2025

(54) UE-INITIATED REPORTING PROCEDURE

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US); Md. Saifur Rahman, Plano, TX (US)

(21) Appl. No.: 19/007,267

(22) Filed: Dec. 31, 2024

Related U.S. Application Data
(60) Provisional application No. 63/619,210, filed on Jan. 9, 2024.
(60) Provisional application No. 63/624,185, filed on Jan. 23, 2024.
(60) Provisional application No. 63/551,290, filed on Feb. 8, 2024.
(60) Provisional application No. 63/575,424, filed on Apr. 5, 2024.

(51) Int. Cl. H04W 72/21; H04B 7/06; H04B 17/318; H04W 24/10; H04W 72/0446

(52) U.S. Cl. CPC H04W 72/21; H04B 7/0626; H04B 17/328; H04W 24/10; H04W 72/0446

(57) ABSTRACT

Methods and apparatuses for a user equipment (UE)-initiated reporting procedure. A method performed by a UE includes transmitting, via a physical UL control channel (PUCCH) resource of a first uplink (UL) channel, a first instance of an indicator, starting a prohibit timer from a last symbol or slot of the PUCCH resource, and receiving information to determine one or more physical UL shared channel (PUSCH) resources of a second UL channel. The method further includes determining, based on the information, the one or more PUSCH resources of the second UL channel and transmitting, via the determined one or more PUSCH resources, a beam report.

### CROSS-REFERENCE TO RELATED AND CLAIM OF PRIORITY

The present application claims priority under 35 U.S.C. § 119(e) to U.S. Provisional Patent Application No. 63/619,210 filed on Jan. 9, 2024; U.S. Provisional Patent Application No. 63/624,185 filed on Jan. 23, 2024; U.S. Provisional Patent Application No. 63/551,290 filed on Feb. 8, 2024; and U.S. Provisional Patent Application No. 63/575,424 filed on Apr. 5, 2024, which are hereby incorporated by reference in their entirety.

### TECHNICAL FIELD

The present disclosure relates generally to wireless communication systems and, more specifically, the present disclosure relates to methods and apparatuses for a user equipment (UE)-initiated reporting procedure.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to a UE-initiated reporting procedure(s).

In one embodiment, a user equipment (UE) is provided. The UE includes a transceiver configured to transmit, via a physical UL control channel (PUCCH) resource of a first uplink (UL) channel, a first instance of an indicator and a processor operably coupled with the transceiver. The processor is configured to start a prohibit timer from a last symbol or slot of the PUCCH resource. The transceiver is further configured to receive information to determine one or more physical UL shared channel (PUSCH) resources of a second UL channel. The processor is further configured to determine, based on the information, the one or more PUSCH resources of the second UL channel. The transceiver is further configured to transmit, via the determined one or more PUSCH resources, a beam report.

In another embodiment, a base station (BS) is provided. The BS includes a processor and a transceiver operably coupled to the processor. The transceiver configured to receive, via a PUCCH resource of a first UL channel, a first instance of an indicator, transmit information to indicate one or more PUSCH resources of a second UL channel, and receive, via the one or more PUSCH resources, a beam report. A prohibit timer runs from a last symbol or slot of the PUCCH resource.

In yet another embodiment, a method performed by a UE is provided. The method includes transmitting, via a PUCCH resource of a first UL channel, a first instance of an indicator, starting a prohibit timer from a last symbol or slot of the PUCCH resource, and receiving information to determine one or more PUSCH resources of a second UL channel. The method further includes determining, based on the information, the one or more PUSCH resources of the second UL channel and transmitting, via the determined one or more PUSCH resources, a beam report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the disclosure;

FIG. 2 illustrates an example gNodeB (gNB) according to embodiments of the disclosure;

FIG. 3 illustrates an example user equipment (UE) according to embodiments of the disclosure;

FIGS. 4A and 4B illustrate an example of a wireless transmit and receive paths according to embodiments of the present disclosure;

FIG. 5A illustrates an example wireless system according to embodiments of the disclosure;

FIG. 5B illustrates example multi-beam operation according to embodiments of the disclosure;

FIG. 6 illustrates an example of a transmitter structure for beamforming according to embodiments of the present disclosure;

FIG. 7 illustrates a flowchart of an example procedure for UE reporting according to embodiments of the present disclosure;

FIG. 8 illustrates a flowchart of an example procedure for UE reporting according to embodiments of the present disclosure;

FIG. 9 illustrates a flowchart of an example procedure for UE reporting according to embodiments of the present disclosure;

FIG. 10 illustrates a diagram of example report quantities according to embodiments of the present disclosure;

FIG. 11 illustrates a diagram of example timing assumptions for UE reporting according to embodiments of the present disclosure;

FIG. 12 illustrates a diagram of example timing assumptions for UE reporting according to embodiments of the present disclosure; and

FIG. 13 illustrates an example method performed by a UE in a wireless communication system according to embodiments of the present disclosure.

### DETAILED DESCRIPTION

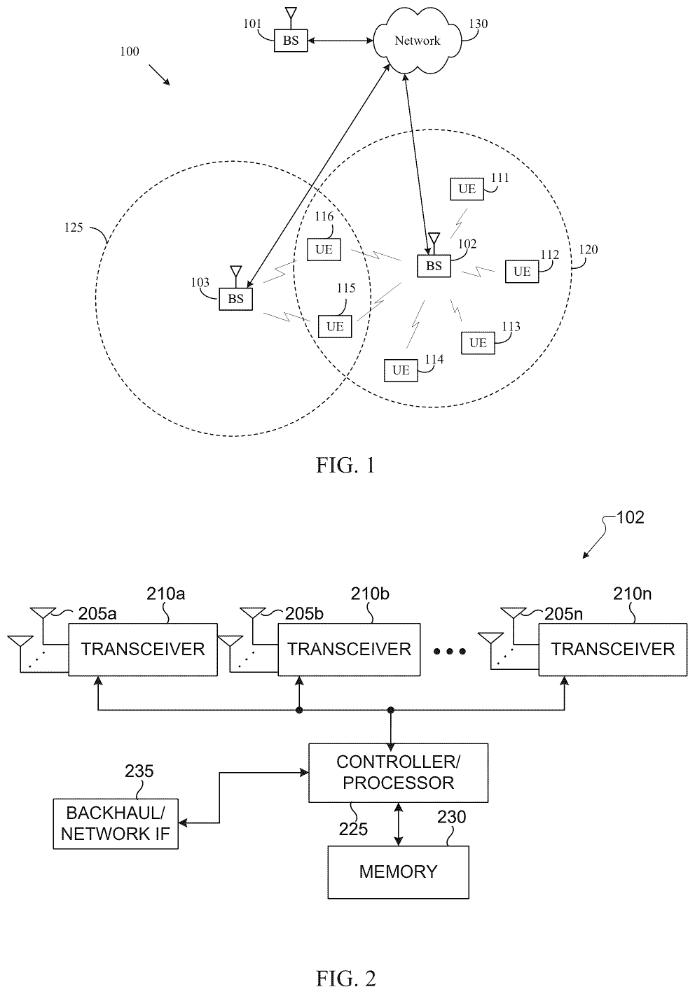

FIGS. 1-13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1]3GPP TS 38.211 v16.1.0, “NR; Physical channels and modulation;” [REF2]3GPP TS 38.212 v16.1.0, “NR; Multiplexing and Channel coding;” [REF3]3GPP TS 38.213 v16.1.0, “NR; Physical Layer Procedures for Control;” [REF4]3GPP TS 38.214 v16.1.0, “NR; Physical Layer Procedures for Data;” [REF5]3GPP TS 38.321 v16.1.0, “NR; Medium Access Control (MAC) protocol specification;” and [REF6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing UE-initiated reporting procedure(s). In certain embodiments, one or more of the gNBs 101-103 include circuitry, programing, or a combination thereof to support UE-initiated reporting procedure(s).

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting UE-initiated reporting procedure(s). The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to perform UE-initiated report procedure(s) as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

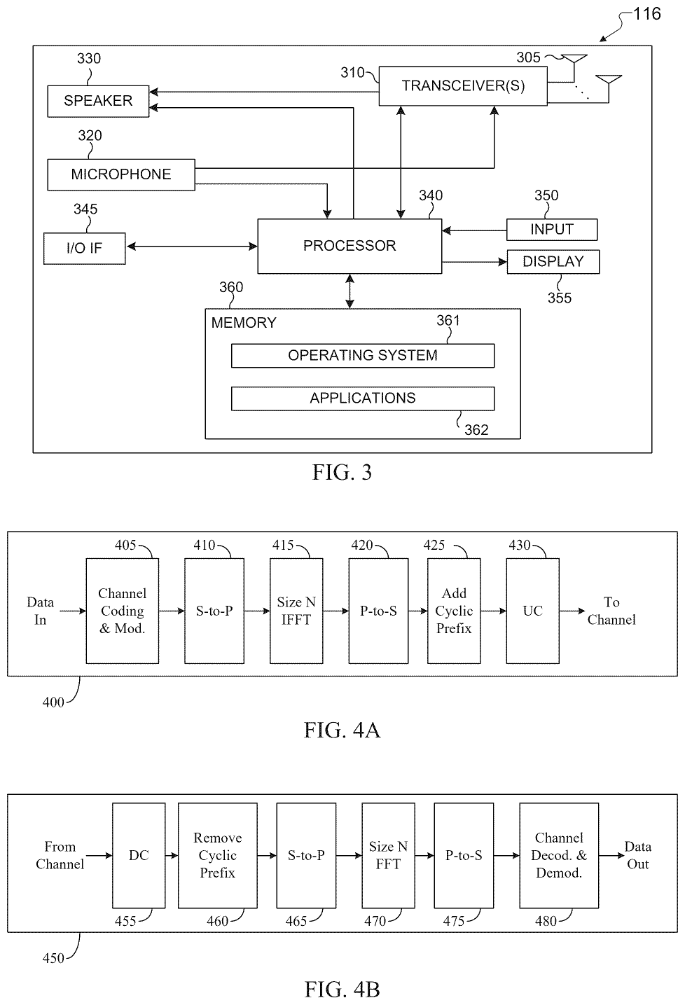

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 performs UE-initiated reporting procedure(s) as described in embodiments of the disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the DL to UEs 111-116 and may implement a receive path 450 that is analogous to receiving in the UL from UEs 111-116. Similarly, each of UEs 111-116 may implement a transmit path 400 for transmitting in the UL to gNBs 101-103 and may implement a receive path 450 for DL reception from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

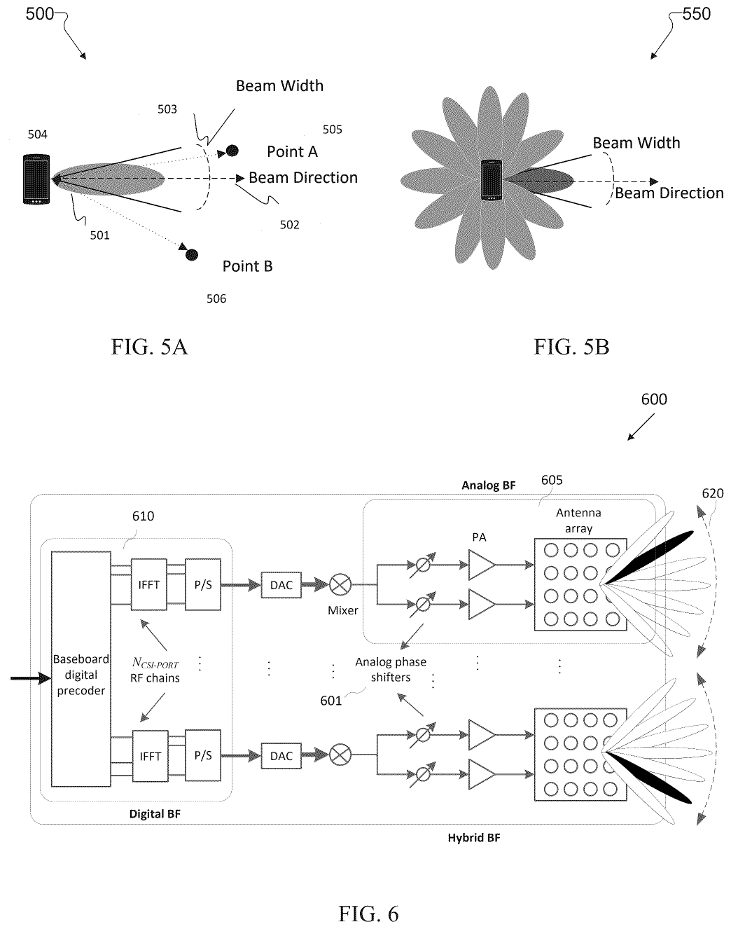

As illustrated in FIG. 5A, in a wireless system 500, a beam 501 for a device 504 can be characterized by abeam direction 502 and abeam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art, that a beam can be 3D, where a beam can be transmitted to or received from any direction in space.

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI}. PORT. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while the figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of;
A transmission configuration indication (TCI) state, that establishes a quasi-colocation (QCL) relationship between a source reference signal (e.g. synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference signal (RS) can determine a spatial RX filter for reception of DL channels at the UE, or a spatial TX filter for transmission of UL channels from the UE.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB (e.g., the BS 102) lacks knowledge on the DL channel condition—or, in other words, the UE (e.g., the UE 116) knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB (e.g., the BS 102). Such UE-initiated reporting and/or beam switching for a content can be enabled for other types of report quantities (different from common beam or CSI reports) and application scenarios.

Although UE-initiated reporting and/or beam switching and/or beam activation/deactivation can be beneficial, efficient designs are needed to ensure that the latency is reduced and, at the same time, error events can be minimized. Therefore, embodiments of the present disclosure recognizes that there is a need for efficient designs for UE-initiated reporting and/or beam switching and/or beam activation/deactivation for a content that can offer good trade-off between latency and reliability, in particular, when the UE-initiated beam management framework can include multiple report types (or report quantities), or/and multiple event types when a report types can be associated with an event (e.g. for beam report, the event can be beam failure, and for CSI, the event can be user throughput degradation or increasing retransmission rate).

The present disclosure provides various aspects and detailed design examples on the UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents example embodiments on means and/or procedures of transmitting the UE-initiated report(s) along with its indicator(s) via various UL channels.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network (e.g., the network 130) the UE-initiated (UEI)/UE-triggered report of a (report-)type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic DL control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g. NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g. CRI, synchronization signal block resource indicator (SSBRI)) and Jᵢ is a beam metric (e.g. layer 1 reference signal received power (L1-RSRP), layer 1 signal-to-interference-plus-noise ratio (L1-SINR)).
In one example, the content includes CSI-related quantity/quantities. For example, at least one of (rank indicator (RI), precoding matrix indicator (PMI), channel quality indicator (CQI), CQI report interval (CRI), layer index (LI)).
In one example, the content includes time-domain channel property (TDCP)-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-)correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (TCI state) TCI states (e.g. DL TCI state, UL TCI state, or unified (joint) DL/UL TCI state), or
      panel(s) (e.g. UE panels for DL reception or/and UL transmission), or
      antenna(e) (e.g. UE antennae for DL reception or/and UL transmission), or
      antenna port(s) (e.g. UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g. L1 DL/UL, or L1 SL), i.e. such reporting is to enable fast/reliable DL/UL or SL transmission/reception. In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| | | Trigger/ | |
| Event type | Type | pre-notification message | Content |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related event) | No |
| | (B) | No | Yes |
| | (C) | Yes (e.g. TDCP-related event) | Yes |
| 3: non-CSI/beam/ | (A) | Yes (e.g. non-CSI-related event) | No |
| TDCP | (B) | No | Yes |
| | (C) | Yes (e.g. non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g. beam-related event), | No |
| | content-specific or event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g. beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (cyclic delay diversity (CDD), cycling, space frequency block code (SFBC)), reciprocity (network control block (NCB), or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g. modulation and coding scheme (MCS), or number of carrier waves CWs.
For another example, when there is no pre-notification message/trigger associated with a content, i.e., the report-type is (B), the content can be transmitted using UL resource(s) configured (e.g. configured-grant physical UL shared channel (PUSCH)), or reserved for the UE-initiated report, or via a random access channel (RACH) procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one embodiment, a UE (e.g., the UE 116) could send to the network one or more indicators/triggers or report quantities (e.g., in part of the content(s) in a (report-)type (B) based report or a (report-)type (C) based report) each comprising/including/containing or corresponding to one or more of:
An identity (ID) of the TCI state
An index/ID of a higher layer RRC configured list/set/pool of TCI states that comprises/indicates/provides the TCI state
An index of the TCI state in a list/set/pool of TCI states higher layer RRC configured to the UE
An index of the TCI state in a set of TCI states activated by a (unified) TCI state(s) activation/deactivation MAC CE
An index/ID of a set of TCI states—e.g., among sets of TCI states activated/provided by a (unified) TCI state(s) activation/deactivation MAC CE—that comprises/indicates/provides the TCI state
An index of the TCI state among TCI states mapped to a TCI codepoint activated/provided by a (unified) TCI state(s) activation/deactivation MAC CE
A TCI codepoint activated/provided by a (unified) TCI state(s) activation/deactivation MAC CE that comprises/indicates/provides the TCI state
An index/ID of a TCI codepoint—e.g., among TCI codepoints activated/provided by a (unified) TCI state(s) activation/deactivation MAC CE—that comprises/indicates/provides the TCI state
An index of the TCI state among TCI states indicated by a TCI codepoint of a TCI field in a beam indication DCI (e.g., DCI format 1_1/1_2 with or without DL assignment)
An index/ID of or information related to a (unified) TCI state(s) activation/deactivation MAC CE that activates the TCI state or a TCI codepoint that comprises/indicates/provides the TCI state; the information could include/comprise/contain/indicate when (e.g., reception time in form of slot/slot index/etc.) the (unified) TCI state(s) activation/deactivation MAC CE was received
An index/ID of or information related to a beam indication DCI that provides/indicates the TCI state or a TCI codepoint that comprises/indicates/provides the TCI state; the information could include/comprise/contain/indicate when (e.g., reception time in form of slot/slot index/etc.) the beam indication DCI was received
An index/ID of a CORESET or a coresetPoolIndex/coresetGroupIndex associated to a CORESET, in which a beam indication DCI that provides/indicates the TCI state or a TCI codepoint that comprises/indicates/provides the TCI state was received
RS index(es)/ID(s) such as SSB index(es)/ID(s) and/or CSI-RS resource index(es)/ID(s) provided/indicated in the TCI state along with the corresponding QCL-type(s)
Resource indicator(s) such as SSBRI(s) and/or CRI(s) reported in one or more CSI/beam reports
Beam metric(s) such as L1-RSRP(s) and/or L1-SINR(s) reported in one or more CSI/beam reports
Index(es)/ordering(s) of resource indicator(s) such as SSBRI(s) and/or CRI(s) among resource indicators such as SSBRIs and/or CRIs reported in one or more CSI/beam reports
Index(es)/ordering(s) of resource indicator(s) such as SSBRI(s) and/or CRI(s) among resource indicators such as SSBRIs and/or CRIs reported for TCI state(s)/beam(s) activation/deactivation/sub-selection as specified herein in the present disclosure in one or more CSI/beam reports
Index(es)/ordering(s) of resource indicator(s) such as SSBRI(s) and/or CRI(s) among candidate resource indicators such as SSBRIs and/or CRIs—as specified herein in the present disclosure—reported in one or more CSI/beam reports
Index(es)/ordering(s) of beam metric(s) such as L1-RSRP(s) and/or L1-SINR(s) among beam metrics such as L1-RSRPs and/or L1-SINRs reported in one or more beam/CSI reports
Index(es)/ordering(s) of beam metric(s) such as L1-RSRP(s) and/or L1-SINR(s) among beam metrics such as L1-RSRPs and/or L1-SINRs corresponding to resource indicators such as SSBRIs and/or CRIs reported for TCI state(s)/beam(s) activation/deactivation/sub-selection as specified herein in the present disclosure in one or more CSI/beam reports
Index(es)/ordering(s) of beam metric(s) such as L1-RSRP(s) and/or L1-SINR(s) among beam metrics such as L1-RSRPs and/or L1-SINRs corresponding to candidate resource indicators such as SSBRIs and/or CRIs—as specified herein in the present disclosure—reported in one or more CSI/beam reports
Group(s)/pair(s) of resource indicators such as SSBRIs and/or CRIs reported in one or more CSI/beam reports
Index(es)/ordering(s) of group(s)/pair(s) of resource indicators among groups/pairs of resource indicators such as SSBRIs and/or CRIs reported in one or more CSI/beam reports
Index(es)/ordering(s) of group(s)/pair(s) of resource indicators among groups/pairs of resource indicators such as SSBRIs and/or CRIs reported for TCI state(s)/beam(s) activation/deactivation/sub-selection as specified herein in the present disclosure in one or more CSI/beam reports
Index(es)/ordering(s) of group(s)/pair(s) of resource indicators among groups/pairs of candidate resource indicators such as SSBRIs and/or CRIs—as specified herein in the present disclosure—reported in one or more CSI/beam reports
Group(s)/pair(s) of beam metrics such as L1-RSRPs and/or L1-SINRs reported in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs reported in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of resource indicators such as SSBRIs and/or CRIs reported for TCI state(s)/beam(s) activation/deactivation/sub-selection as specified herein in the present disclosure in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of candidate resource indicators such as SSBRIs and/or CRIs—as specified herein in the present disclosure—reported in one or more CSI/beam reports
A bitmap with each bit position of the bitmap corresponding to a candidate TCI state/TCI state ID/TCI state index/RS index or ID/resource indicator/etc. according to those specified herein in the present disclosure; for this case, when/if a bit position of the bitmap is set to ‘1’ (or ‘0’), the TCI state/TCI state ID/TCI state index/RS index or ID/resource indicator/etc. corresponding to the bit position could be for the UE-initiated beam(s)/TCI state(s) switching/update/change as specified herein in the present disclosure.

Throughout the present disclosure, an index could correspond to the “first”, the “second”, and etc. Furthermore, throughout the present disclosure, “trigger” can also be referred to as “initiate” or “indicate”; i.e., they can be used/applied to various design examples throughout the present disclosure interchangeably. For instance, the UE could send to the network (e.g., the network 130) an indicator to trigger a TCI state change/update/switch for one or more channels or signals. The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report.

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of UL resources including physical UL control channel(s) (PUCCH(s)), PUSCH(s), MAC CE(s), physical random access channel(s) (PRACH(s)) and etc.) or different reports/reporting instances/transmissions/transmission occasions (e.g., via/in different sets of UL resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of UL resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of UL resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of UL resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of UL resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, UL control information (UCI) and etc.

In one embodiment (embodiment-I), the UEI report(s) may only comprise or include or contain or provide the content(s)—e.g., of (report-)type (B) as specified herein in the present disclosure; i.e., the UEI report(s) may not comprise, include, contain or provide the PN message/trigger. For this case/setting,
In one example, the UE could be provided, configured or indicated by the network, e.g., via higher layer RRC signaling(s)/parameter(s) and/or MAC CE command(s) and/or dynamic DCI based L1 signaling(s)—e.g., based on a corresponding UE's capability or capability signaling, one or more UL channels/resources for sending the UEI report(s). For this design example, the one or more UL channels/signals could be configured, provided, activated or indicated in a periodic manner (e.g., with a configured periodicity) or semi-persistent manner (e.g., with a configured periodicity and activated by a DL signaling, e.g., a DCI). Once the UE has decided, determined or identified to send the UEI report(s), the UE could use the one or more UL channels/signals—e.g., that are available the latest/nearest in time—as described/specified herein in the present disclosure to send the UEI report(s). For example, the one or more UL channels/signals here could correspond to periodic/semi-persistent PUCCH resource(s)/PUCCH resource group(s)/PUCCH resource set(s) configured and/or activated for the UEI reporting. For another example, the one or more UL channels/signals could correspond to Type-1 configured grant (CG) PUSCH(s)—provided by ConfiguredGrantConfig with a configured periodicity and/or Type-2 CG PUSCH(s)—provided by ConfiguredGrantConfig with a configured periodicity and activated by a DL signaling, e.g., a DCI, for the UEI reporting. Furthermore, the network could keep monitoring the one or more UL channels/signals configured, provided, activated and/or indicated for the UEI reporting to detect/decode the UEI report(s), if sent over/on the one or more UL channels/signals as specified/described herein in the present disclosure.
In another example, the UE could use dynamic grant (DG) PUSCH(s) and/or Type-1/2 CG PUSCH(s) to send UL data. For this case design, once the UE has decided, determined or identified to send the UEI report(s), the UE could piggyback the UEI report(s) on the DG PUSCH(s) and/or Type-1/2 CG PUSCH(s) for the UL data transmission(s). For this case, the network could keep monitoring the DG PUSCH(s) and/or Type-1/2 CG PUSCH(s) for the UL data transmission(s) to detect or decode the UEI report(s), if piggybacked on/over the DG PUSCH(s) and/or Type-1/2 CG PUSCH(s) as specified/described herein in the present disclosure.
In another example, the UE could send the UEI report(s) in part of or as a power headroom report (PHR), which could be piggybacked on DG PUSCH(s) and/or Type-1/2 CG PUSCH(s) for UL data transmission(s). For this design example, the UE could indicate to the network, e.g., via one or more indicators, whether a PHR corresponds to or comprises or contains or provides or includes UEI report(s). In addition, the network could keep monitoring the DG PUSCH(s) and/or Type-1/2 CG PUSCH(s) for the UL data transmission(s) to detect or decode the UEI report(s), if sent in part of or as a PHR piggybacked on/over the DG PUSCH(s) and/or Type-1/2 CG PUSCH(s) as specified/described herein in the present disclosure. For this case, the PHR could be triggered when/if the UE decides, determines or identifies to send the UEI report(s) according to those specified herein in the present disclosure.

In one embodiment (embodiment-II), the UEI report(s) could contain, provide, include or comprise at least a pre-notification (PN) message/trigger—e.g., of (report-)type (A) or (report-)type (C) as specified herein in the present disclosure, and/or the (corresponding) content—e.g., of (report-)type (B) or (report-)type (C) as specified herein in the present disclosure. For this case/setting,
the UE could send the PN message/trigger, e.g., via one or more PUCCH resources, wherein each of the one or more PUCCH resources (e.g., of format 0/1/2/3/4) could be from one or more PUCCH resource sets, e.g., configured/provided for the UEI reporting(s)—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting.
after the UE has transmitted the PN message/trigger, the UE could expect to receive from the network a DCI to trigger aperiodic (AP) CSI-RS measurement and reporting, and/or activate semi-persistent (SP) CSI-RS measurement and reporting, within a time window starting from the first or last symbol/slot/etc. of the transmission of the PN message/trigger; otherwise, i.e., when/if the UE does not receive from the network a DCI to trigger aperiodic (AP) CSI-RS measurement and reporting, and/or activate semi-persistent (SP) CSI-RS measurement and reporting, within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, value(s) of the time window and/or the maximum number of re-transmissions of the PN message/trigger—or the corresponding UEI report(s). For instance, if the DCI is to trigger the AP CSI-RS measurement and reporting, the DCI could be of DCI format 0_1 with the CSI request field indicated/provided therein set to valid value(s)/index(es), e.g., pointing to the index(es) of the entries in CSI-AperiodicTriggerStateList or the index(es) of the codepoint(s) in the aperiodic CSI trigger state subselection MAC CE. Furthermore, the reception of the DCI trigger or activation for the AP or SP CSI-RS measurement and reporting could be an acknowledgement (ACK) for the transmission of the PN message/trigger.
the UE could measure one or more CSI-RSs according to the CSI-RS resource(s) and/or CSI resource setting(s) triggered, activated or associated to the DCI that triggers or activates the AP or SP CSI-RS measurement and reporting; for instance, for AP CSI-RS measurement and reporting, the UE could measure one or more CSI-RSs according to the CSI-RS resource(s) and/or CSI resource setting(s) associated to/with the trigger state provided/indicated by the CSI request field in the corresponding DCI format 0_1.
once the UE has determined, decided or identified to send the UEI report(s), the UE could send the UEI report(s) over/on the UL channels/resources—e.g., SP-PUCCH(s), e.g., in form/terms of PUCCH resource(s), slot(s)/slot offset(s) for transmission(s), and/or etc., SP-PUSCH(s), e.g., in form/terms of PUSCH resource(s), slot(s)/slot offset(s) for transmission(s), p0/alpha for the PUSCH(s) and/or etc., and/or AP resource(s) in form/terms of slot(s)/slot offset(s) for transmission(s)—according to the CSI reporting setting(s) triggered, activated or associated to the DCI that triggers or activates the AP or SP CSI-RS measurement and reporting; for instance, for AP CSI-RS measurement and reporting, the UE could send the UEI report(s) over/on the UL channels/signals as described/herein in the present disclosure according to the CSI reporting setting(s) associated to/with the trigger state provided/indicated by the CSI request field in the corresponding DCI format 0_1.

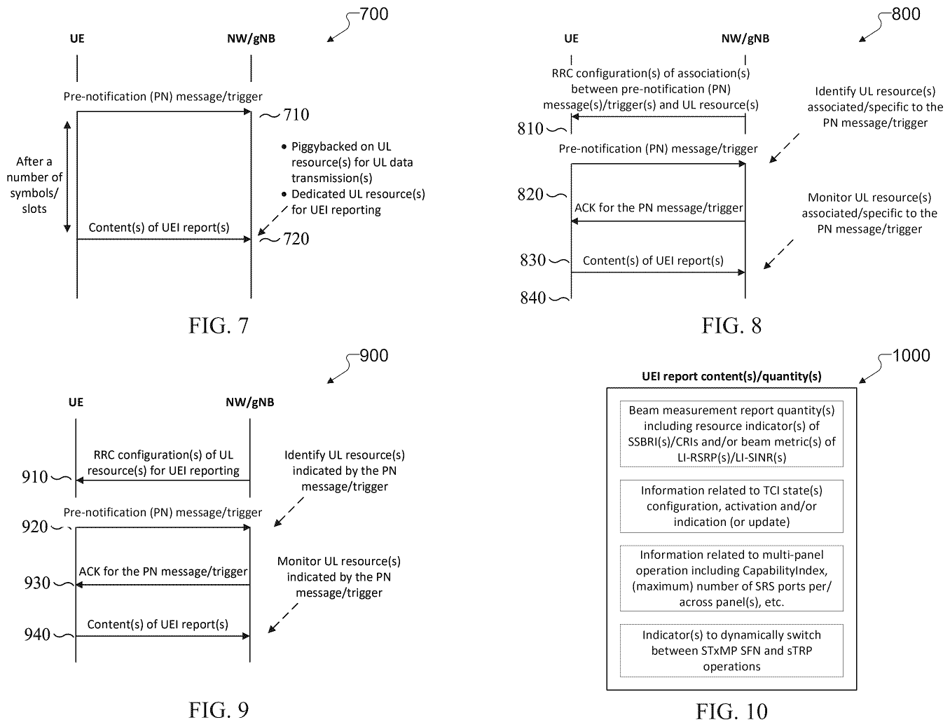

FIG. 7 illustrates a flowchart of an example procedure 700 for UE reporting according to embodiments of the present disclosure. For example, procedure 700 can be performed by the UE 116 and the gNB 102 and/or network 130 in the wireless network 100 of FIG. 1. This example is for illustration only and other embodiments can be used without departing from the scope of the present disclosure.

The procedure begins in 710, a UE transmits a pre-notification (PN) message/trigger to a network (NW)/gNB. In 720, the UE transmits content(s) of UEI report(s) to the NW/gNB.

FIG. 8 illustrates a flowchart of an example procedure 800 for UE reporting according to embodiments of the present disclosure. For example, procedure 800 can be performed by the UE 116 and the gNB 103 and/or network 130 in the wireless network 100 of FIG. 1. This example is for illustration only and other embodiments can be used without departing from the scope of the present disclosure.

The procedure begins in 810, a NW/gNB transmits RRC configurations of association(s) between PN message(s)/trigger(s) and UL resource(s) to a UE. In 820, the UE transmits PN message/triggerto the NW/gNB. In 830, the NW/gNB transmits an ACK for the PN message/trigger to the UE. In 840, the UE transmits content(s) of UEI report(s) to the NW/gNB.

FIG. 9 illustrates a flowchart of an example procedure 900 for UE reporting according to embodiments of the present disclosure. For example, procedure 900 can be performed by the UE 111 and the gNB 102 and/or network 130 in the wireless network 100 of FIG. 1. This example is for illustration only and other embodiments can be used without departing from the scope of the present disclosure.

The procedure begins in 910, a NW/gNB transmits a RRC configuration(s) of UL resource(s) for UEI reporting to a UE. In 920, the UE transmits a PN message/trigger to the NW/gNB. In 930, the NW/gNB transmits an ACK for the PN message/trigger to the UE. In 940, the UE transmits content(s) of UEI report(s) to the NW/gNB.

In one embodiment (embodiment-III), the UEI report(s) could contain, provide, include or comprise at least a pre-notification (PN) message/trigger—e.g., of (report-)type (A) or (report-)type (C) as specified herein in the present disclosure, and/or the (corresponding) content—e.g., of (report-)type (B) or (report-)type (C) as specified herein in the present disclosure. For this case/setting,
the UE could send the PN message/trigger, e.g., via one or more PUCCH resources, wherein each of the one or more PUCCH resources (e.g., of format 0/1/2/3/4) could be from one or more PUCCH resource sets, e.g., configured/provided for the UEI reporting(s)—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting.
after the UE has transmitted the PN message/trigger, the UE could expect to receive from the network a DCI to trigger aperiodic (AP) CSI-RS measurement—or to trigger transmission(s) of CSI-RS(s) on the corresponding CSI-RS resource(s) for measurement, and/or activate semi-persistent (SP) CSI-RS measurement—or to activate transmission(s) of CSI-RS(s) on the corresponding CSI-RS resource(s) for measurement, within a time window starting from the first or last symbol/slot/etc. of the transmission of the PN message/trigger; otherwise, i.e., when/if the UE does not receive from the network a DCI to trigger aperiodic (AP) CSI-RS measurement, and/or activate semi-persistent (SP) CSI-RS measurement, within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting. The UE (e.g., the UE 116) could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, value(s) of the time window and/or the maximum number of re-transmissions of the PN message/trigger—or the corresponding UEI report(s). For instance, if the DCI is to trigger the AP CSI-RS measurement as defined/specified herein in the present disclosure, the DCI could be of DCI format 0_1 with the CSI request field indicated/provided therein set to valid value(s)/index(es), e.g., pointing to the index(es) of the entries in CSI-AperiodicTriggerStateList or the index(es) of the codepoint(s) in the aperiodic CSI trigger state subselection MAC CE. Furthermore, the reception of the DCI trigger or activation for the AP or SP CSI-RS measurement as specified or defined herein in the present disclosure could be an ACK for the transmission of the PN message/trigger.
the UE could measure one or more CSI-RSs according to the CSI-RS resource(s) and/or CSI resource setting(s) triggered, activated or associated to the DCI that triggers or activates the AP or SP CSI-RS measurement as specified/defined herein in the present disclosure; for instance, for AP CSI-RS measurement—i.e., the DCI is to trigger transmission(s) of CSI-RS(s) on the corresponding CSI-RS resource(s) for measurement, the UE could measure one or more CSI-RSs according to the CSI-RS resource(s) and/or CSI resource setting(s) associated to/with the trigger state provided/indicated by the CSI request field in the corresponding DCI format 0_1.
once the UE has determined, decided or identified to send the UEI report(s), the UE could send the UEI report(s) over/on one or more UL channels/resources determined according to:
   Alt-1: the UE could be provided, configured or indicated by the network, e.g., via higher layer RRC signaling(s)/parameter(s) and/or MAC CE command(s) and/or dynamic DCI based L1 signaling(s)—e.g., based on a corresponding UE's capability or capability signaling, one or more UL channels/resources for sending the UEI report(s). For this design example, the one or more UL channels/signals could be configured, provided, activated or indicated in a periodic manner (e.g., with a configured periodicity) or semi-persistent manner (e.g., with a configured periodicity and activated by a DL signaling, e.g., a DCI, or with a configured periodicity and activated by the PN message/trigger). Once the UE has decided, determined or identified to send the UEI report(s), the UE could use the one or more UL channels/signals—e.g., that are available the latest/nearest in time—as described/specified herein in the present disclosure to send the UEI report(s). For example, the one or more UL channels/signals here could correspond to periodic/semi-persistent PUCCH resource(s)/PUCCH resource group(s)/PUCCH resource set(s) configured and/or activated for the UEI reporting. For another example, the one or more UL channels/signals could correspond to Type-1 CG PUSCH(s)—provided by ConfiguredGrantConfig with a configured periodicity and/or Type-2 CG PUSCH(s)—provided by ConfiguredGrantConfig with a configured periodicity and activated by a DL signaling, e.g., a DCI, for the UEI reporting. For these settings/design examples, the network could keep monitoring the one or more UL channels/signals configured, provided, activated and/or indicated for the UEI reporting to detect/decode the UEI report(s), if sent over/on the one or more UL channels/signals as specified/described herein in the present disclosure. For another example, the UE could be first configured or provided by the network one or more PUCCH resources/PUCCH resource groups/PUCCH resource sets for the UEI reporting—e.g., with a configured periodicity; when/if the UE has sent to the network the PN message/trigger, the UE could start using/applying the one or more PUCCH resources/PUCCH resource groups/PUCCH resource sets configured for the UEI reporting to send the UEI report(s), X1 symbols/slots/etc. after the first or last symbol/slot/etc. of the transmission of the PN message/trigger, and/or X2 symbols/slots/etc. after the first or last symbol/slot/etc. of an ACK reception for the transmission of the PN message/trigger. For another example, the UE could be first configured or provided by the network one or more PUSCH resources for the UEI reporting—e.g., CG PUSCH(s) provided by ConfiguredGrantConfig with a configured periodicity; when/if the UE has sent to the network the PN message/trigger, the UE could start using/applying the one or more PUSCH resources configured for the UEI reporting—e.g., provided by ConfiguredGrantConfig with a configured periodicity and indicator(s) indicating that the CG PUSCH(s) is for sending the UEI report(s)—to send the UEI report(s), Y1 symbols/slots/etc. after the first or last symbol/slot/etc. of the transmission of the PN message/trigger, and/or Y2 symbols/slots/etc. after the first or last symbol/slot/etc. of an ACK reception for the transmission of the PN message/trigger. That is, for these design examples, the PN message/trigger is to activate the network configured (e.g., with a periodicity) one or more UL channels/resources for the UEI reporting to transmit the UEI report(s), or equivalently, the PN message/trigger is to indicate to the network that the one or more UL channels/resources (periodically) configured for the UEI reporting are activated to transmit the UEI report(s). Furthermore, when/if the UE is expected to receive an ACK for the PN message/trigger, (1) the UE could expect to receive the ACK for the PN message/trigger within a time window starting from the first or last symbol/slot/etc. of the transmission of the PN message/trigger, wherein the ACK could be in various forms and/or received in/via/by MAC CE/DCI; (2) otherwise, i.e., when/if the UE does not receive from the network an ACK for the PN message/trigger, within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting, e.g., on/over the corresponding network configured (periodic) UL channels/resources, and/or Z symbols/slots/etc. after the first or last symbol/slot/etc. of the time window, the UE could send the UEI report(s) on/over the corresponding network configured (periodic) UL channels/resources as specified or described herein in the present disclosure. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, value(s) of X1, X2, Y1, Y2, Z, the time window and/or the maximum number of re-transmissions of the PN message/trigger—or the corresponding UEI report(s).
   Alt-2: the UE could send the PN message/trigger in form of a scheduling request (SR) provided by or associated with a SR configuration; the UE could expect to receive an UL grant that dynamically schedules one or more PUSCH resources in response to the PN message/trigger (and therefore, the corresponding SR), within a time window starting from the first or last symbol/slot/etc. of the transmission of the PN message/trigger, wherein the UL grant could be provided or indicated in a UL scheduling DCI (e.g., of DCI format(s) 0_0, 0_1, 0_2 and/or etc.); otherwise, i.e., when/if the UE does not receive from the network a UL grant in response to the PN message/trigger (and therefore, the corresponding SR), within a time window starting from the first or last symbol/slot/etc. of the transmission of the PN message/trigger, the UE could re-transmit or re-send the PN message/trigger (i.e., in form of the SR), and after a maximum number of re-transmissions of the PN message/trigger—or the corresponding UEI report(s), the UE could terminate or abandon the UEI reporting. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, value(s) of the time window and/or the maximum number of re-transmissions of the PN message/trigger—or the corresponding UEI report(s). Upon receiving the UL grant in response to the PN message/trigger, the UE could transmit the UEI report(s) on/over the dynamically granted or scheduled PUSCH resource(s), and/or the network could keep monitoring the dynamically granted or scheduled PUSCH resource(s) to detect/decode the UEI report(s).
   Alt-3: the UE could use dynamic grant (DG) PUSCH(s) and/or Type-1/2 CG PUSCH(s) to send UL data. For this case, X1 symbols/slots/etc. after the first or last symbol/slot/etc. of the transmission of the PN message/trigger, and/or X2 symbols/slots/etc. after the first or last symbol/slot/etc. of an ACK reception for the transmission of the PN message/trigger, the UE could piggyback the UEI report(s) on the DG PUSCH(s) and/or Type-1/2 CG PUSCH(s) for the UL data transmission(s). The network (e.g., the network 130) could keep monitoring the DG PUSCH(s) and/or Type-1/2 CG PUSCH(s) for the UL data transmission(s), e.g., according to the reception/detection of the PN message/trigger and/or value(s) of X1 and/or X2, to detect or decode the UEI report(s), if piggybacked on/over the DG PUSCH(s) and/or Type-1/2 CG PUSCH(s) as specified/described herein in the present disclosure. Furthermore, when/if the UE is expected to receive an ACK for the PN message/trigger, (1) the UE could expect to receive the ACK for the PN message/trigger within a time window starting from the first or last symbol/slot/etc. of the transmission of the PN message/trigger, wherein the ACK could be in various forms and/or received in/via/by MAC CE/DCI; (2) otherwise, i.e., when/if the UE does not receive from the network an ACK for the PN message/trigger, within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting, e.g., piggybacked on the DG PUSCH(s) and/or Type-1/2 CG PUSCH(s) for the UL data transmission(s), and/or Z symbols/slots/etc. after the first or last symbol/slot/etc. of the time window, the UE could piggyback the UEI report(s) on/over the DG PUSCH(s) and/or Type-1/2 CG PUSCH(s) for the UL data transmission(s) as specified or described herein in the present disclosure. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, value(s) of X1, X2, Z, the time window and/or the maximum number of re-transmissions of the PN message/trigger—or the corresponding UEI report(s). One conceptual example characterizing the described design procedure is provided in FIG. 7.
   Alt-4: the UE could be provided, configured or indicated by the network, e.g., via higher layer RRC signaling(s)/parameter(s) and/or MAC CE command(s) and/or dynamic DCI based L1 signaling(s)—e.g., based on a corresponding UE's capability or capability signaling, one or more UL channels/resources for sending the UEI report(s). For this design example, the one or more UL channels/signals could be configured, provided, activated or indicated in a periodic manner (e.g., with a configured periodicity) or semi-persistent manner (e.g., with a configured periodicity and activated by a DL signaling, e.g., a DCI, or with a configured periodicity and activated by the PN message/trigger). In one example, K1 symbols/slots/etc. after the first or last symbol/slot/etc. of the transmission of the PN message/trigger, and/or K2 symbols/slots/etc. after the first or last symbol/slot/etc. of an ACK reception for the transmission of the PN message/trigger, the UE could use the one or more UL channels/signals—e.g., that are available the latest/nearest in time—as described/specified herein in the present disclosure to send the UEI report(s). For example, the one or more UL channels/signals here could correspond to periodic/semi-persistent PUCCH resource(s)/PUCCH resource group(s)/PUCCH resource set(s) configured and/or activated for the UEI reporting. For another example, the one or more UL channels/signals could correspond to Type-1 CG PUSCH(s)—provided by ConfguredGrantConfig with a configured periodicity and/or Type-2 CG PUSCH(s)—provided by ConfiguredGrantConfig with a configured periodicity and activated by a DL signaling, e.g., a DCI, for the UEI reporting. For these settings/design examples, the network could keep monitoring the one or more UL channels/signals configured, provided, activated and/or indicated for the UEI reporting, e.g., according to the reception/detection of the PN message/trigger and/or value(s) of K1 and/or K2, to detect/decode the UEI report(s), if sent over/on the one or more UL channels/signals as specified/described herein in the present disclosure. In another example, the UE could be first configured or provided by the network one or more PUCCH resources/PUCCH resource groups/PUCCH resource sets for the UEI reporting—e.g., with a configured periodicity; when/if the UE has sent to the network the PN message/trigger, the UE could start using/applying the one or more PUCCH resources/PUCCH resource groups/PUCCH resource sets configured for the UEI reporting to send the UEI report(s), X1 symbols/slots/etc. after the first or last symbol/slot/etc. of the transmission of the PN message/trigger, and/or X2 symbols/slots/etc. after the first or last symbol/slot/etc. of an ACK reception for the transmission of the PN message/trigger; for this design example, the network could keep monitoring the one or more PUCCH resources/PUCCH resource groups/PUCCH resource sets provided and/or configured for the UEI reporting, e.g., according to the reception/detection of the PN message/trigger and/or value(s) of X1 and/or X2, to detect/decode the UEI report(s), if sent over/on the one or more PUCCH resources/PUCCH resource groups/PUCCH resource sets as specified/described herein in the present disclosure. In another example, the UE could be first configured or provided by the network one or more PUSCH resources for the UEI reporting—e.g., CG PUSCH(s) provided by ConfiguredGrantConfg with a configured periodicity; when/if the UE has sent to the network the PN message/trigger, the UE could start using/applying the one or more PUSCH resources configured for the UEI reporting—e.g., provided by ConfiguredGrantConfig with a configured periodicity and indicator(s) indicating that the CG PUSCH(s) is for sending the UEI report(s)—to send the UEI report(s), Y1 symbols/slots/etc. after the first or last symbol/slot/etc. of the transmission of the PN message/trigger, and/or Y2 symbols/slots/etc. after the first or last symbol/slot/etc. of an ACK reception for the transmission of the PN message/trigger; for this design example, the network could keep monitoring the one or more PUSCH resources provided and/or configured for the UEI reporting, e.g., according to the reception/detection of the PN message/trigger and/or value(s) of Y1 and/or Y2, to detect/decode the UEI report(s), if sent over/on the one or more PUSCH resources as specified/described herein in the present disclosure. That is, for these design examples, the PN message/trigger is to activate the network configured (e.g., with a periodicity) one or more UL channels/resources for the UEI reporting to transmit the UEI report(s), or equivalently, the PN message/trigger is to indicate to the network that the one or more UL channels/resources (periodically) configured for the UEI reporting are activated to transmit the UEI report(s). Furthermore, when/if the UE is expected to receive an ACK for the PN message/trigger, (1) the UE could expect to receive the ACK for the PN message/trigger within a time window starting from the first or last symbol/slot/etc. of the transmission of the PN message/trigger, wherein the ACK could be in various forms and/or received in/via/by MAC CE/DCI; (2) otherwise, i.e., when/if the UE does not receive from the network an ACK for the PN message/trigger, within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting, e.g., on/over the corresponding network configured (periodic) UL channels/resources, and/or Z symbols/slots/etc. after the first or last symbol/slot/etc. of the time window, the UE could send the UEI report(s) on/over the corresponding network configured (periodic) UL channels/signals according to those described or specified herein in the present disclosure. For this case, the network could keep monitoring the one or more UL channels/signals configured, provided, activated and/or indicated for the UEI reporting, e.g., according to the reception/detection of the PN message/trigger, value(s) of Z, the time window and/or the maximum number of re-transmissions of the PN message/trigger—or the corresponding UEI report(s), to detect/decode the UEI report(s), if sent over/on the one or more UL channels/signals as specified/described herein in the present disclosure. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, value(s) of K1, K2, X1, X2, Y1, Y2, Z, the time window and/or the maximum number of re-transmissions of the PN message/trigger—or the corresponding UEI report(s).
   Alt-5: the UE could send the PN message/trigger, e.g., in form of a scheduling request (SR) provided by or associated with a SR configuration; K1 symbols/slots/etc. after the first or last symbol/slot/etc. of the transmission of the PN message/trigger, and/or K2 symbols/slots/etc. after the first or last symbol/slot/etc. of an ACK reception for the transmission of the PN message/trigger, the UE could use one or more UL channels/signals associated/specific to the PN message/trigger to send the UEI report(s). For example, the one or more UL channels/signals here could correspond to periodic/semi-persistent PUCCH resource(s)/PUCCH resource group(s)/PUCCH resource set(s) configured and/or activated for the UEI reporting and/or UL data, and associated/specific to the PN trigger/message. For another example, the one or more UL channels/signals here could correspond to DG PUSCH(s) dynamically scheduled for the UEI reporting and/or UL data transmission(s), Type-1 CG PUSCH(s)—provided by ConfguredGrantConfg with a configured periodicity and/or Type-2 CG PUSCH(s)—provided by ConfiguredGrantConfig with a configured periodicity and activated by a DL signaling, e.g., a DCI, for the UEI reporting and/or UL data transmission(s), and associated/specific to the PN message/trigger. Furthermore, when/if the UE is expected to receive an ACK for the PN message/trigger, (1) the UE could expect to receive the ACK for the PN message/trigger within a time window starting from the first or last symbol/slot/etc. of the transmission of the PN message/trigger, wherein the ACK could be in various forms (e.g., as a DCI trigger indicated/provided by a CSI request field in the corresponding DCI format(s), e.g., 01, and/or a UL grant indicated/provided in DCI format(s) 00, 0_1 and/or 0_2) and/or received in/via/by MAC CE/DCI; (2) otherwise, i.e., when/if the UE does not receive from the network an ACK for the PN message/trigger, within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting, e.g., on/over the corresponding UL channels/resources associated/specific to the PN message/trigger, and/or Z symbols/slots/etc. after the first or last symbol/slot/etc. of the time window, the UE could send the UEI report(s) on/over the corresponding UL channels/signals associated/specific to the PN message/trigger according to those described or specified herein in the present disclosure. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, value(s) of K1, K2, Z, the time window and/or the maximum number of re-transmissions of the PN message/trigger—or the corresponding UEI report(s). For this case, the network could keep monitoring the one or more UL channels/signals associated/specific to the PN message/trigger, e.g., according to the reception/detection of the PN message/trigger, value(s) of K1, K2, Z, the time window and/or the maximum number of re-transmissions of the PN message/trigger—or the corresponding UEI report(s), to detect/decode the UEI report(s), if sent over/on the one or more UL channels/signals associated/specific to the PN message/trigger as specified/described herein in the present disclosure. The UE could determine or identify the association(s)/mapping(s) between one or more PN messages/triggers and one or more UL channels/signals (e.g., PUCCH resource(s)/resource group(s)/resource set(s), DG/Type-1 CG/Type-2 CG PUSCH(s), and/or etc.) according to:
      fixed rule(s)/value(s) in system specification(s) or per RRC configuration: for instance, each candidate PN message/trigger (e.g., in terms of or in form of their configuration(s) with corresponding ID(s)/index(es)) could be associated/specific to a predefined or predetermined set of one or more UL channels/resources—including e.g. one or more PUCCH resources, PUCCH resource groups, PUCCH resource sets and/or DG, Type-1/2 CG PUSCHs, wherein the UL channels/resources in the set could be continuous in time and/or frequency, the number of the UL channels/signals in the set could be fixed value(s) in system specification(s), and/or the IDs/index(es) of the UL channels/signals in the set could be fixed value(s) in system specification(s).
      network's configuration(s)/indication(s), e.g., via higher layer RRC signaling(s)/parameter(s) and/or MAC CE command(s) and/or dynamic DCI based L1 signaling(s)—e.g., according to or based on a corresponding UE's capability or capability signaling: for example, the (higher layer) configuration(s)/parameter(s)/signaling(s) that configures or provides a PN message/trigger (e.g., a SR configuration that configures or provides a SR when/if the PN message/trigger is in form of a SR) could provide, configure or indicate a set of one or more UL channels/signals (e.g., including one or more PUCCH resources, PUCCH resource groups, PUCCH resource sets and/or DG, Type-1/2 CG PUSCHs), e.g., in form of their time and/or frequency resource allocation(s), number of the UL channel(s)/signal(s) in the set, their indexes/IDs (e.g., in the set), and/or etc.; for another example, the (higher layer) configuration(s)/parameter(s)/signaling(s) that configures or provides the one or more UL channels/resources (e.g., PUCCH-Config, PUCCH-ResourceSet and/or PUCCH-Resource that configures or provides one or more PUCCH resources, PUCCH resource groups, PUCCH resource sets, and/or ConfiguredGrantConfig that configures or provides one or more PUSCHs) could provide, configure or indicate information related to the PN message/trigger (e.g., in form of their configuration(s) and/or ID(s)/index(es)); for another example, the PN message/trigger (one or multi-bit, or one or multi-level) could also indicate or inform to the network which one or more PUCCH resources (e.g., from one or more PUCCH resource sets/groups, e.g., configured/provided/activated for the UEI reporting) and/or PUCCH resource groups and/or PUCCH resource sets to use for sending the UEI report(s), and/or one or more PUSCH resources in one or more ConfiguredGrantConfig's and/or one or more ConfiguredGrantConfig's (and therefore, the PUSCHs configured/provided therein) to use for sending the UEI report(s).

Conceptual examples characterizing the described/specified design procedures are provided in FIG. 8 and FIG. 9. Optionally, the UE may expect to be configured, provided, activated or indicated by the network, e.g., within the time window starting from the first or last symbol/slot/etc. of the transmission of the PN message/trigger, via higher layer RRC signaling(s)/parameter(s) and/or MAC CE command(s) and/or dynamic DCI based L1 signaling(s), one or more UL resources for sending the UEI report(s)—for this case, e.g., the UE may not receive an ACK for the PN message/trigger, e.g., within the time window starting from the first or last symbol/slot/etc. of the transmission of the PN message/trigger, and/or instead of sending an ACK for the PN message/trigger, the network indicates to the UE which one or more UL resources to use for sending the UEI report(s); the UE could determine or identify, based on/according to the network's configuration(s)/activation(s)/indication(s), the one or more UL resources to use for sending the UEI report(s) following those specified herein in the present disclosure (e.g., via CSI request field in a triggering DCI, PUCCH resource indicator (PRI), DG and/or CG Type-1/2 PUSCH(s), periodic/semi-persistent PUCCH resource(s)/PUCCH resource group(s)/PUCCH resource set(s) and/or etc.).
Alt-6: the UE could use dynamic grant (DG) PUSCH(s) and/or Type-1/2 CG PUSCH(s) to send UL data. For this case design, once the UE has decided, determined or identified to send the UEI report(s), the UE could piggyback the UEI report(s) on the DG PUSCH(s) and/or Type-1/2 CG PUSCH(s) for the UL data transmission(s). For this case, the network could keep monitoring the DG PUSCH(s) and/or Type-1/2 CG PUSCH(s) for the UL data transmission(s) to detect or decode the UEI report(s), if piggybacked on/over the DG PUSCH(s) and/or Type-1/2 CG PUSCH(s) as specified/described herein in the present disclosure.
Alt-7: the UE could send the UEI report(s) in part of or as a power headroom report (PHR), which could be piggybacked on DG PUSCH(s) and/or Type-1/2 CG PUSCH(s) for UL data transmission(s). For this design example, the UE could indicate to the network, e.g., via one or more indicators, whether a PHR corresponds to or comprises or contains or provides or includes UEI report(s). In addition, the network could keep monitoring the DG PUSCH(s) and/or Type-1/2 CG PUSCH(s) for the UL data transmission(s) to detect or decode the UEI report(s), if sent in part of or as a PHR piggybacked on/over the DG PUSCH(s) and/or Type-1/2 CG PUSCH(s) as specified/described herein in the present disclosure. For this case/design example, the PHR could be triggered when/if the UE decides, determines or identifies to send the UEI report(s) according to those specified herein in the present disclosure.

In one embodiment (embodiment-IV), the UEI report(s) could contain, provide, include or comprise at least a pre-notification (PN) message/trigger—e.g., of (report-)type (A) or (report-)type (C) as specified herein in the present disclosure, and/or the (corresponding) content—e.g., of (report-)type (B) or (report-)type (C) as specified herein in the present disclosure. For this case/setting,
the UE could send the PN message/trigger, e.g., via one or more PUCCH resources, wherein each of the one or more PUCCH resources (e.g., of format 0/1/2/3/4) could be from one or more PUCCH resource sets, e.g., configured/provided for the UEI reporting(s)—in one example, the UE (e.g., the UE 116) could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting.
after the UE has transmitted the PN message/trigger, the UE could expect to receive from the network a DCI to trigger aperiodic (AP) CSI-RS reporting, and/or activate semi-persistent (SP) CSI-RS reporting, within a time window starting from the first or last symbol/slot/etc. of the transmission of the PN message/trigger; otherwise, i.e., when/if the UE does not receive from the network a DCI to trigger aperiodic (AP) CSI-RS reporting, and/or activate semi-persistent (SP) CSI-RS reporting, within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, value(s) of the time window and/or the maximum number of re-transmissions of the PN message/trigger—or the corresponding UEI report(s). For instance, if the DCI is to trigger the AP CSI-RS reporting, the DCI could be of DCI format 0_1 with the CSI request field indicated/provided therein set to valid value(s)/index(es), e.g., pointing to the index(es) of the entries in CSI-AperiodicTriggerStateList or the index(es) of the codepoint(s) in the aperiodic CSI trigger state subselection MAC CE. Furthermore, the reception of the DCI trigger or activation for the AP or SP CSI-RS reporting could be an ACK for the transmission of the PN message/trigger.
once the UE has determined, decided or identified to send the UEI report(s), the UE could send the UEI report(s) over/on the UL channels/resources—e.g., SP-PUCCH(s), e.g., in form/terms of PUCCH resource(s), slot(s)/slot offset(s) for transmission(s), and/or etc., SP-PUSCH(s), e.g., in form/terms of PUSCH resource(s), slot(s)/slot offset(s) for transmission(s), p0/alpha for the PUSCH(s) and/or etc., and/or AP resource(s) in form/terms of slot(s)/slot offset(s) for transmission(s)—according to the CSI reporting setting(s) triggered, activated or associated to the DCI that triggers or activates the AP or SP CSI-RS reporting; for instance, for AP CSI-RS reporting, the UE could send the UEI report(s) over/on the UL channels/signals as described/herein in the present disclosure according to the CSI reporting setting(s) associated to/with the trigger state provided/indicated by the CSI request field in the corresponding DCI format 0_1.
the UE could determine or identify the CSI-RS(s), therefore, the corresponding CSI-RS resource(s), for measurement according to:
   periodic CSI-RS resource(s), periodically transmitted CSI-RS(s)—and therefore, the corresponding CSI-RS resource(s), provided/configured in one or more CSI resource settings, CSI resource sets, CSI resource groups and/or CSI resource pairs, and/or
   semi-persistent CSI-RS resource(s), semi-persistently transmitted CSI-RS(s)—and therefore, the corresponding CSI-RS resource(s), provided/configured in one or more CSI resource settings, CSI resource sets, CSI resource groups and/or CSI resource pairs associated to the DCI that activates the SP CSI-RS measurement, and/or
   CSI-RS resource(s) associated/specific to the PN message/trigger, or CSI-RS(s) transmitted by/from the network upon reception/detection of the PN message/trigger wherein the CSI-RS resource(s) corresponding to the transmitted CSI-RS(s) could be associated/specific to the PN message/trigger; for this case, the UE could expect to receive/measure the CSI-RS(s) associated/specific to the PN message/trigger T1 symbols/slots/etc. after the first or last symbol/slot/etc. of the transmission of the PN message/trigger, and/or T2 symbols/slots/etc. after the first or last symbol/slot/etc. of an ACK reception for the transmission of the PN message/trigger, wherein the ACK could be transmission(s) of the CSI-RS(s)/CSI-RS resource(s) associated/specific to the PN message/trigger; when/if the UE does not receive/measure the CSI-RS(s) associated/specific to the PN message/trigger T1 symbols/slots/etc. after the first or last symbol/slot/etc. of the transmission of the PN message/trigger, and/or T2 symbols/slots/etc. after the first or last symbol/slot/etc. of an ACK reception for the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting; optionally, the UE could expect to receive an ACK in response to the PN message/trigger; for this case, i.e., when/if the UE is expected to receive an ACK for the PN message/trigger, (1) the UE could expect to receive the ACK for the PN message/trigger within a time window starting from the first or last symbol/slot/etc. of the transmission of the PN message/trigger, wherein the ACK could be in various forms (e.g., as a DCI trigger indicated/provided by a CSI request field in the corresponding DCI format(s), e.g., 0_1, and/or a UL grant indicated/provided in DCI format(s) 0_0, 0_1 and/or 0_2, and/or transmission(s) of the CSI-RS(s)/CSI-RS resource(s) associated/specific to the PN message/trigger as specified/described herein in the present disclosure) and/or received in/via/by MAC CE/DCI; (2) otherwise, i.e., when/if the UE does not receive from the network an ACK for the PN message/trigger, within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting. The UE could determine or identify the association(s)/mapping(s) between one or more PN messages/triggers and one or more RSs/RS resources for measurement (e.g., CSI-RS resource(s)/CSI resource group(s)/CSI resource set(s)/CSI resource setting(s), and/or etc.) according to:
      fixed rule(s)/value(s) in system specification(s) or per RRC configuration: for instance, each candidate PN message/trigger (e.g., in terms of or in form of their configuration(s) with corresponding ID(s)/index(es)) could be associated/specific to one or more predefined or predetermined RSs/RS resources for measurement (e.g., in terms of or in form of their RS/RS resource ID(s)/index(es)—including e.g. one or more CSI-RS resources (e.g., in terms of or in form of their resource ID(s)/index(es)), one or more CSI resource groups (e.g., in terms of or in form of their resource group ID(s)/index(es)), one or more CSI resource sets (e.g., in terms of or in form of their resource set ID(s)/index(es)) and/or one or more CSI resource settings (e.g., in terms of or in form of their resource setting/configuration ID(s)/index(es))
      network's configuration(s)/indication(s), e.g., via higher layer RRC signaling(s)/parameter(s) and/or MAC CE command(s) and/or dynamic DCI based L1 signaling(s)—e.g., according to or based on a corresponding UE's capability or capability signaling: for example, the (higher layer) configuration(s)/parameter(s)/signaling(s) that configures or provides a PN message/trigger (e.g., a SR configuration that configures or provides a SR when/if the PN message/trigger is in form of a SR) could provide, configure or indicate one or more RSs/RS resources for measurement (e.g., in terms of or in form of their RS/RS resource ID(s)/index(es)—including e.g. one or more CSI-RS resources (e.g., in terms of or in form of their resource ID(s)/index(es)), one or more CSI resource groups (e.g., in terms of or in form of their resource group ID(s)/index(es)), one or more CSI resource sets (e.g., in terms of or in form of their resource set ID(s)/index(es)) and/or one or more CSI resource settings (e.g., in terms of or in form of their resource setting/configuration ID(s)/index(es)); for another example, the (higher layer) configuration(s)/parameter(s)/signaling(s) that configures or provides the one or more RSs/RS resources for measurement—including e.g. the (higher layer) configuration(s)/parameter(s)/signaling(s) NZP-CSI-RS-Resource that configures or provides the one or more CSI-RS resources, the (higher layer) configuration(s)/parameter(s)/signaling(s) NZP-CSI-RS-ResourceGroup that configures or provides one or more CSI resource groups, the (higher layer) configuration(s)/parameter(s)/signaling(s) NZP-CSI-RS-ResourceSet that provides or configures one or more CSI resource sets and/or the (higher layer) configuration(s)/parameter(s)/signaling(s) CSI-ResourceConfig that provides or configures one or more CSI resource settings could provide, configure or indicate information related to the PN message/trigger (e.g., in form of their configuration(s) and/or ID(s)/index(es)); for another example, the PN message/trigger (one or multi-bit, or one or multi-level) could also indicate or inform to the network (e.g., the network 130) which one or more CSI-RS resources (e.g., from one or more CSI resource groups, CSI resource sets and/or CSI resource settings, e.g., configured/provided/activated for the UEI reporting) and/or one or more CSI resource groups (e.g., from one or more CSI resource sets and/or CSI resource settings, e.g., configured/provided/activated for the UEI reporting) and/or one or more CSI resource sets (e.g., from one or more CSI resource settings, e.g., configured/provided/activated for the UEI reporting) and/or one or more CSI resource settings to use for measurement.

Optionally, the UE may expect to be configured, provided, activated or indicated by the network, e.g., within the time window starting from the first or last symbol/slot/etc. of the transmission of the PN message/trigger, via higher layer RRC signaling(s)/parameter(s) and/or MAC CE command(s) and/or dynamic DCI based L1 signaling(s), one or more (periodic/semi-persistent/aperiodic) CSI-RS resources, CSI resource groups, CSI resource sets and/or CSI resource settings for measurement—for this case, e.g., the UE may not receive an ACK for the PN message/trigger, e.g., within the time window starting from the first or last symbol/slot/etc. of the transmission of the PN message/trigger, and/or instead of sending an ACK for the PN message/trigger, the network indicates to the UE which one or more (periodic/semi-persistent/aperiodic) CSI-RS resources, CSI resource groups, CSI resource sets and/or CSI resource settings to use for measurement following those specified herein in the present disclosure (e.g., via CSI request field in a triggering DCI, via an activation DCI for semi-persistent CSI-RS measurement/reporting, higher layer configuration(s)/parameter(s) NZP-CSI-RS-ResourceSet, NZP-CSI-RS-Resource, CSI-ResourceConfig that provides or configures the corresponding CSI-RS resource(s), CSI resource group(s), CSI resource set(s) and/or CSI resource setting(s)/configuration(s)).

In one embodiment (embodiment-V), the UEI report(s) could contain, provide, include or comprise at least a pre-notification (PN) message/trigger—e.g., of (report-)type (A) or (report-)type (C) as specified herein in the present disclosure, and/or the (corresponding) content—e.g., of (report-)type (B) or (report-)type (C) as specified herein in the present disclosure. For this case/setting,
the UE could send the PN message/trigger, e.g., via one or more PUCCH resources, wherein each of the one or more PUCCH resources (e.g., of format 0/1/2/3/4) could be from one or more PUCCH resource sets, e.g., configured/provided for the UEI reporting(s)—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting.
the UE could determine or identify the CSI-RS(s), therefore, the corresponding CSI-RS resource(s), for measurement according to:
   periodic CSI-RS resource(s), periodically transmitted CSI-RS(s)—and therefore, the corresponding CSI-RS resource(s), provided/configured in one or more CSI resource settings, CSI resource sets, CSI resource groups and/or CSI resource pairs, and/or
   semi-persistent CSI-RS resource(s), semi-persistently transmitted CSI-RS(s)—and therefore, the corresponding CSI-RS resource(s), provided/configured in one or more CSI resource settings, CSI resource sets, CSI resource groups and/or CSI resource pairs associated to the DCI that activates the SP CSI-RS measurement, and/or
   CSI-RS resource(s) associated/specific to the PN message/trigger, or CSI-RS(s) transmitted by/from the network upon reception/detection of the PN message/trigger wherein the CSI-RS resource(s) corresponding to the transmitted CSI-RS(s) could be associated/specific to the PN message/trigger; for this case, the UE could expect to receive/measure the CSI-RS(s) associated/specific to the PN message/trigger T1 symbols/slots/etc. after the first or last symbol/slot/etc. of the transmission of the PN message/trigger, and/or T2 symbols/slots/etc. after the first or last symbol/slot/etc. of an ACK reception for the transmission of the PN message/trigger, wherein the ACK could be transmission(s) of the CSI-RS(s)/CSI-RS resource(s) associated/specific to the PN message/trigger; when/if the UE does not receive/measure the CSI-RS(s) associated/specific to the PN message/trigger T1 symbols/slots/etc. after the first or last symbol/slot/etc. of the transmission of the PN message/trigger, and/or T2 symbols/slots/etc. after the first or last symbol/slot/etc. of an ACK reception for the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting; optionally, the UE could expect to receive an ACK in response to the PN message/trigger; for this case, i.e., when/if the UE is expected to receive an ACK for the PN message/trigger, (1) the UE could expect to receive the ACK for the PN message/trigger within a time window starting from the first or last symbol/slot/etc. of the transmission of the PN message/trigger, wherein the ACK could be in various forms (e.g., as a DCI trigger indicated/provided by a CSI request field in the corresponding DCI format(s), e.g., 0_1, and/or a UL grant indicated/provided in DCI format(s) 0_0, 0_1 and/or 0_2, and/or transmission(s) of the CSI-RS(s)/CSI-RS resource(s) associated/specific to the PN message/trigger as specified/described herein in the present disclosure) and/or received in/via/by MAC CE/DCI; (2) otherwise, i.e., when/if the UE does not receive from the network an ACK for the PN message/trigger, within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting. The UE could determine or identify the association(s)/mapping(s) between one or more PN messages/triggers and one or more RSs/RS resources for measurement (e.g., CSI-RS resource(s)/CSI resource group(s)/CSI resource set(s)/CSI resource setting(s), and/or etc.) according to:
      fixed rule(s)/value(s) in system specification(s) or per RRC configuration: for instance, each candidate PN message/trigger (e.g., in terms of or in form of their configuration(s) with corresponding ID(s)/index(es)) could be associated/specific to one or more predefined or predetermined RSs/RS resources for measurement (e.g., in terms of or in form of their RS/RS resource ID(s)/index(es)—including e.g. one or more CSI-RS resources (e.g., in terms of or in form of their resource ID(s)/index(es)), one or more CSI resource groups (e.g., in terms of or in form of their resource group ID(s)/index(es)), one or more CSI resource sets (e.g., in terms of or in form of their resource set ID(s)/index(es)) and/or one or more CSI resource settings (e.g., in terms of or in form of their resource setting/configuration ID(s)/index(es))
      network's configuration(s)/indication(s), e.g., via higher layer RRC signaling(s)/parameter(s) and/or MAC CE command(s) and/or dynamic DCI based L1 signaling(s)—e.g., according to or based on a corresponding UE's capability or capability signaling: for example, the (higher layer) configuration(s)/parameter(s)/signaling(s) that configures or provides a PN message/trigger (e.g., a SR configuration that configures or provides a SR when/if the PN message/trigger is in form of a SR) could provide, configure or indicate one or more RSs/RS resources for measurement (e.g., in terms of or in form of their RS/RS resource ID(s)/index(es)—including e.g. one or more CSI-RS resources (e.g., in terms of or in form of their resource ID(s)/index(es)), one or more CSI resource groups (e.g., in terms of or in form of their resource group ID(s)/index(es)), one or more CSI resource sets (e.g., in terms of or in form of their resource set ID(s)/index(es)) and/or one or more CSI resource settings (e.g., in terms of or in form of their resource setting/configuration ID(s)/index(es)); for another example, the (higher layer) configuration(s)/parameter(s)/signaling(s) that configures or provides the one or more RSs/RS resources for measurement—including e.g. the (higher layer) configuration(s)/parameter(s)/signaling(s) NZP-CSI-RS-Resource that configures or provides the one or more CSI-RS resources, the (higher layer) configuration(s)/parameter(s)/signaling(s) NZP-CSI-RS-ResourceGroup that configures or provides one or more CSI resource groups, the (higher layer) configuration(s)/parameter(s)/signaling(s) NZP-CSI-RS-ResourceSet that provides or configures one or more CSI resource sets and/or the (higher layer) configuration(s)/parameter(s)/signaling(s) CSI-ResourceConfig that provides or configures one or more CSI resource settings could provide, configure or indicate information related to the PN message/trigger (e.g., in form of their configuration(s) and/or ID(s)/index(es)); for another example, the PN message/trigger (one or multi-bit, or one or multi-level) could also indicate or inform to the network which one or more CSI-RS resources (e.g., from one or more CSI resource groups, CSI resource sets and/or CSI resource settings, e.g., configured/provided/activated for the UEI reporting) and/or one or more CSI resource groups (e.g., from one or more CSI resource sets and/or CSI resource settings, e.g., configured/provided/activated for the UEI reporting) and/or one or more CSI resource sets (e.g., from one or more CSI resource settings, e.g., configured/provided/activated for the UEI reporting) and/or one or more CSI resource settings to use for measurement.

Optionally, the UE may expect to be configured, provided, activated or indicated by the network, e.g., within the time window starting from the first or last symbol/slot/etc. of the transmission of the PN message/trigger, via higher layer RRC signaling(s)/parameter(s) and/or MAC CE command(s) and/or dynamic DCI based L1 signaling(s), one or more (periodic/semi-persistent/aperiodic) CSI-RS resources, CSI resource groups, CSI resource sets and/or CSI resource settings for measurement—for this case, e.g., the UE may not receive an ACK for the PN message/trigger, e.g., within the time window starting from the first or last symbol/slot/etc. of the transmission of the PN message/trigger, and/or instead of sending an ACK for the PN message/trigger, the network indicates to the UE which one or more (periodic/semi-persistent/aperiodic) CSI-RS resources, CSI resource groups, CSI resource sets and/or CSI resource settings to use for measurement following those specified herein in the present disclosure (e.g., via CSI request field in a triggering DCI, via an activation DCI for semi-persistent CSI-RS measurement/reporting, higher layer configuration(s)/parameter(s) NZP-CSI-RS-ResourceSet, NZP-CSI-RS-Resource, CSI-ResourceConfig that provides or configures the corresponding CSI-RS resource(s), CSI resource group(s), CSI resource set(s) and/or CSI resource setting(s)/configuration(s)).

Once the UE has determined, decided or identified to send the UEI report(s), the UE could send the UEI report(s) over/on one or more UL channels/resources determined according to those specified/described in Alt-1, Alt-2, Alt-3, Alt-4, Alt-5, Alt-6 and Alt-7 in the present disclosure.

The UE could determine or identify to follow the design procedures specified or described in embodiment-I, embodiment-II, embodiment-III, embodiment-IV and/or embodiment-V according to or based on one or more of:
Network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling
Content(s) of the UEI report(s) and/or the associated performance metric(s) including latency requirement(s), resource allocation/utilization rate(s), system throughput(s) and etc.
Report/payload size(s) of the UEI report(s)—e.g., whether the report/payload size(s) of the UEI report(s) is greater than, less than or equal to a threshold, therein the threshold could be determined according to: (i) fixed value(s) in system specification(s) or per RRC configuration, and/or (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling.

Throughout the present disclosure, an UL channel/resource is used for the UEI reporting when/if higher layer RRC signaling(s)/parameter(s) and/or MAC CE command(s) and/or dynamic DCI based L1 signaling(s) that is associated/specific to the UL channel/resource configures, provides, activates or indicates, e.g., in form of one or more RRC parameters/MAC CE fields or indicators/DCI fields or indicators, that the UL channel/resource could be used for the UEI reporting as specified or defined herein in the present disclosure. For instance, the one or more RRC parameters could include or correspond to or comprise PUCCH-Resource, PUCCH-ResourceSet and/or PUCCH-Config for configuring/activating PUCCH resource(s)/PUCCH resource group(s)/PUCCH resource set(s), and/or PUSCH-Config and/or ConfiguredGrantConfig for configuring/activating PUSCH resource(s), and the UL channel/resource could be a PUCCH resource, a PUSCH resource, a PRACH preamble and etc. Furthermore, throughout the present disclosure, the UE could expect to receive an ACK in response to the UEI report(s) that carries/comprises/contains/includes the content(s) as defined/specified herein in the present disclosure; for this case, i.e., when/if the UE is expected to receive an ACK for the UEI report(s)/content(s), (1) the UE could expect to receive the ACK for the UEI report(s)/content(s) within a time window starting from the first or last symbol/slot/etc. of the transmission of the UEI report(s)/content(s), wherein the ACK could be in various forms (e.g., as a DCI trigger indicated/provided by a CSI request field in the corresponding DCI format(s), e.g., 0_1, and/or a UL grant indicated/provided in DCI format(s) 0_0, 0_1 and/or 0_2, and/or transmission(s) of the CSI-RS(s)/CSI-RS resource(s) associated/specific to the PN message/trigger as specified/described herein in the present disclosure, and/or a TCI state update/switch, and/or response(s) in response to link recovery request and/or beam failure recovery (BFR) MAC CE and/or PRACH transmission(s)) and/or received in/via/by MAC CE/DCI; (2) otherwise, i.e., when/if the UE does not receive from the network an ACK for the UEI report(s)/content(s), within a time window starting from the first or last symbol/slot/etc. of the transmission of the UEI report(s)/content(s), the UE could re-transmit or re-send the UEI report(s)/content(s), and after a maximum number of re-transmissions of the UEI report(s)/content(s), the UE could terminate or abandon the UEI reporting. The value(s) of the time window could be determined according to: (i) fixed value(s) in system specification(s) and/or (ii) network's configuration(s)/indication(s), e.g., via higher layer RRC signaling(s)/parameter(s) and/or MAC CE command(s) and/or dynamic DCI based L1 signaling(s)—e.g., based on a corresponding UE's capability or capability signaling.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB (e.g., the BS 102) lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from common beam or CSI reports) and application scenarios.

Although UE-initiated reporting and/or beam switching and/or beam activation/deactivation can be beneficial, efficient designs are needed to ensure that the latency is reduced and, at the same time, error events can be minimized. Therefore, there is a need for efficient designs for UE-initiated reporting and/or beam switching and/or beam activation/deactivation for a content that can offer good trade-off between latency and reliability, in particular, when the UE-initiated beam management framework can include multiple report types (or report quantities), or/and multiple event types when a report types can be associated with an event (e.g. for beam report, the event can be beam failure, and for CSI, the event can be user throughput degradation or increasing retransmission rate).

The present disclosure provides various aspects and detailed design examples on the UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents example embodiments on means and/or procedures of transmitting the UE-initiated report(s) along with its indicator(s) via various UL channels.

In one embodiment, a UE (e.g., the UE 116) could send to the network one or more indicators/triggers or report quantities (e.g., in part of the content(s) in a (report-)type (B) based report or a (report-)type (C) based report) each comprising/including/containing or corresponding to one or more of the report quantities (RQs):
RQ-1: An identity (ID) of the TCI state
RQ-2: An index/ID of a higher layer RRC configured list/set/pool of TCI states that comprises/indicates/provides the TCI state
RQ-3: An index of the TCI state in a list/set/pool of TCI states higher layer RRC configured to the UE
RQ-4: An index of the TCI state in a set of TCI states activated by a (unified) TCI state(s) activation/deactivation MAC CE
RQ-5: An index/ID of a set of TCI states—e.g., among sets of TCI states activated/provided by a (unified) TCI state(s) activation/deactivation MAC CE—that comprises/indicates/provides the TCI state
RQ-6: An index of the TCI state among TCI states mapped to a TCI codepoint activated/provided by a (unified) TCI state(s) activation/deactivation MAC CE
RQ-7: A TCI codepoint activated/provided by a (unified) TCI state(s) activation/deactivation MAC CE that comprises/indicates/provides the TCI state
RQ-8: An index/ID of a TCI codepoint—e.g., among TCI codepoints activated/provided by a (unified) TCI state(s) activation/deactivation MAC CE—that comprises/indicates/provides the TCI state
RQ-9: An index of the TCI state among TCI states indicated by a TCI codepoint of a TCI field in a beam indication DCI (e.g., DCI format 1_1/1_2 with or without DL assignment)
RQ-10: An index/ID of or information related to a (unified) TCI state(s) activation/deactivation MAC CE that activates the TCI state or a TCI codepoint that comprises/indicates/provides the TCI state; the information could include/comprise/contain/indicate when (e.g., reception time in form of slot/slot index/etc.) the (unified) TCI state(s) activation/deactivation MAC CE was received
RQ-11: An index/ID of or information related to a beam indication DCI that provides/indicates the TCI state or a TCI codepoint that comprises/indicates/provides the TCI state; the information could include/comprise/contain/indicate when (e.g., reception time in form of slot/slot index/etc.) the beam indication DCI was received
RQ-12: An index/ID of a CORESET or a coresetPoolIndex/coresetGroupIndex associated to a CORESET, in which a beam indication DCI that provides/indicates the TCI state or a TCI codepoint that comprises/indicates/provides the TCI state was received
RQ-13: RS index(es)/ID(s) such as SSB index(es)/ID(s) and/or CSI-RS resource index(es)/ID(s) provided/indicated in the TCI state along with the corresponding QCL-type(s)
RQ-14: Resource indicator(s) such as SSBRI(s) and/or CRI(s) reported in one or more CSI/beam reports
RQ-15: Beam metric(s) such as L1-RSRP(s) and/or L1-SINR(s) reported in one or more CSI/beam reports
RQ-16: Index(es)/ordering(s) of resource indicator(s) such as SSBRI(s) and/or CRI(s) among resource indicators such as SSBRIs and/or CRIs reported in one or more CSI/beam reports
RQ-17: Index(es)/ordering(s) of resource indicator(s) such as SSBRI(s) and/or CRI(s) among resource indicators such as SSBRIs and/or CRIs reported for TCI state(s)/beam(s) activation/deactivation/sub-selection as specified herein in the present disclosure in one or more CSI/beam reports
RQ-18: Index(es)/ordering(s) of resource indicator(s) such as SSBRI(s) and/or CRI(s) among candidate resource indicators such as SSBRIs and/or CRIs—as specified herein in the present disclosure—reported in one or more CSI/beam reports
RQ-19: Index(es)/ordering(s) of beam metric(s) such as L1-RSRP(s) and/or L1-SINR(s) among beam metrics such as L1-RSRPs and/or L1-SINRs reported in one or more beam/CSI reports
RQ-20: Index(es)/ordering(s) of beam metric(s) such as L1-RSRP(s) and/or L1-SINR(s) among beam metrics such as L1-RSRPs and/or L1-SINRs corresponding to resource indicators such as SSBRIs and/or CRIs reported for TCI state(s)/beam(s) activation/deactivation/sub-selection as specified herein in the present disclosure in one or more CSI/beam reports
RQ-21: Index(es)/ordering(s) of beam metric(s) such as L1-RSRP(s) and/or L1-SINR(s) among beam metrics such as L1-RSRPs and/or L1-SINRs corresponding to candidate resource indicators such as SSBRIs and/or CRIs—as specified herein in the present disclosure—reported in one or more CSI/beam reports
RQ-22: Group(s)/pair(s) of resource indicators such as SSBRIs and/or CRIs reported in one or more CSI/beam reports
RQ-23: Index(es)/ordering(s) of group(s)/pair(s) of resource indicators among groups/pairs of resource indicators such as SSBRIs and/or CRIs reported in one or more CSI/beam reports
RQ-24: Index(es)/ordering(s) of group(s)/pair(s) of resource indicators among groups/pairs of resource indicators such as SSBRIs and/or CRIs reported for TCI state(s)/beam(s) activation/deactivation/sub-selection as specified herein in the present disclosure in one or more CSI/beam reports
RQ-25: Index(es)/ordering(s) of group(s)/pair(s) of resource indicators among groups/pairs of candidate resource indicators such as SSBRIs and/or CRIs—as specified herein in the present disclosure—reported in one or more CSI/beam reports
RQ-26: Group(s)/pair(s) of beam metrics such as L1-RSRPs and/or L1-SINRs reported in one or more CSI/beam reports
RQ-27: Index(es)/ordering(s) of group(s)/pair(s) of beam metrics such as L1-RSRPs and/or L1-SINRs among groups/pairs of beam metrics such as L1-RSRPs and/or L1-SINRs reported in one or more CSI/beam reports
RQ-28: Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of resource indicators such as SSBRIs and/or CRIs reported for TCI state(s)/beam(s) activation/deactivation/sub-selection as specified herein in the present disclosure in one or more CSI/beam reports
RQ-29: Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of candidate resource indicators such as SSBRIs and/or CRIs—as specified herein in the present disclosure—reported in one or more CSI/beam reports
RQ-30: A bitmap with each bit position of the bitmap corresponding to a candidate TCI state/TCI state ID/TCI state index/RS index or ID/resource indicator/etc. according to those specified herein in the present disclosure; for this case, when/if a bit position of the bitmap is set to ‘1’ (or ‘0’), the TCI state/TCI state ID/TCI state index/RS index or ID/resource indicator/etc. corresponding to the bit position could be for the UE-initiated beam(s)/TCI state(s) switching/update/change as specified herein in the present disclosure.

Throughout the present disclosure, an index could correspond to the “first”, the “second”, and etc. Furthermore, throughout the present disclosure, “trigger” can also be referred to as “initiate” or “indicate”; i.e., they can be used/applied to various design examples throughout the present disclosure interchangeably. For instance, the UE could send to the network an indicator to trigger a TCI state change/update/switch for one or more channels or signals. The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report.

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network (e.g., the network 130) a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of UL resources including PUCCH(s), PUSCH(s), MAC CE(s), PRACH(s) and etc.) or different reports/reporting instances/transmissions/transmission occasions (e.g., via/in different sets of UL resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of UL resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of UL resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of UL resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of UL resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, UCI and etc.

In one embodiment, the UEI report(s)—e.g., in part of the content(s) in a (report-)type (B) based report or a (report-)type (C) based report as specified herein in the present disclosure—could comprise, include, contain one or more of the report quantities (RQs) specified/provided herein (e.g., when/if the UE that would send the UEI report(s) is configured, provided or indicated by the network, e.g., via higher layer RRC signaling(s)/parameter(s) and/or MAC CE command(s) and/or dynamic DCI based L1 signaling(s), that the multi-panel operation/scheme is enabled—for instance, the higher layer parameter multipanelScheme is set to ‘SDMscheme’ or ‘SFNscheme’, or the simultaneous (multi-panel) transmission scheme is enabled—for instance, the higher layer parameter enableSTxMP is configured/provided):
RQ-31: One or more (e.g., N≥1) groups of resource indicators including SSBRIs and/or CRIs with each group comprising one or more (e.g., M≥1) resource indicators including SSBRIs and/or CRIs, wherein N≤Nₘₐₓ and/or M≤Mₘₐₓ.
RQ-32: One or more (e.g., N≥1) groups of beam metrics including L1-RSRPs and/or L1-SINRs with each group comprising one or more (e.g., M≥1) beam metrics including L1-RSRPs and/or L1-SINRs, wherein N≤Nₘₐₓ and/or M≤Mₘₐₓ.

For the described or specified UEI report content(s)/quantity(s), the UE could indicate to the network, at least in part of or by the PN message/trigger—e.g., of (report-)type (A) or (report-)type (C) as specified herein in the present disclosure, and/or the (corresponding) content(s)—e.g., of (report-)type (B) or (report-)type (C) as specified herein in the present disclosure, one or more of (each of which can also be referred to as a report quantity (RQ) throughout the present disclosure):
RQ-33: Type(s) of the reported resource indicator(s)—e.g., whether a reported resource indicator is a SSBRI or a CRI, or whether a reported group of resource indicators are SSBRIs, CRIs or a mixture of SSBRIs and CRIs.
   For example, the PN message/trigger could indicate to network whether the resource indicator(s) reported in the corresponding UEI report(s)—e.g., in part of the content(s) as specified herein in the present disclosure—could comprise only SSBRIs, only CRIs or a mixture of SSBRI(s) and CRI(s); for instance, the PN message/trigger could correspond to or comprise a one-bit indicator; when/if the one-bit indicator is set to ‘0’ (or ‘1’), the resource indicator(s) reported in the corresponding UEI report(s) could be SSBRI(s), and when/if the one-bit indicator is set to ‘1’ (or ‘0’), the resource indicator(s) reported in the corresponding UEI report(s) could be CRI(s); optionally, the PN message/trigger could correspond to or comprise a two-bit indicator; when/if the two-bit indicator is set to ‘00’ (or ‘01’, ‘10’ or ‘11’), the resource indicator(s) reported in the corresponding UEI report(s) could be SSBRI(s), when/if the two-bit indicator is set to ‘01’ (or ‘00’, ‘10’ or ‘11’), the resource indicator(s) reported in the corresponding UEI report(s) could be CRI(s), and when/if the two-bit indicator is set to ‘10’ or ‘11’ (or ‘00’ or ‘01’), the resource indicator(s) reported in the corresponding UEI report(s) could be a mixture of SSBRI(s) and CRI(s).
   For another example, the UEI report(s)—e.g., the content(s) of (report-)type (B) or (report-)type (C) as specified herein in the present disclosure—could comprise or include or contain or provide one or more indicators with each indicator corresponding/associated to one or more resource indicators or one or more groups of resource indicators in the UEI report(s) according to those specified herein in the present disclosure. For instance, the indicator(s) could be or could correspond to one-bit indicator(s); when/if a one-bit indicator is set to ‘0’ (or ‘1’), the resource indicator(s)/group(s) of resource indicators—associated/corresponding to the one-bit indicator—in the corresponding UEI report(s) could be SSBRI(s), and when/if a one-bit indicator is set to ‘1’ (or ‘0’), the resource indicator(s)/group(s) of resource indicators—associated/corresponding to the one-bit indicator—in the corresponding UEI report(s) could be CRI(s); optionally, the indicator(s) could be or could correspond to two-bit indicator(s); when/if a two-bit indicator is set to ‘00’ (or ‘01’, ‘10’ or ‘11’), the resource indicator(s)/group(s) of resource indicators—associated/corresponding to the two-bit indicator—in the corresponding UEI report(s) could be SSBRI(s), when/if a two-bit indicator is set to ‘01’ (or ‘00’, ‘10’ or ‘11’), the resource indicator(s)/group(s) of resource indicators—associated/corresponding to the two-bit indicator—in the corresponding UEI report(s) could be CRI(s), and when/if a two-bit indicator is set to ‘10’ or ‘11’ (or ‘00’ or ‘01’), the resource indicator(s)/group(s) of resource indicators—associated/corresponding to the two-bit indicator—in the corresponding UEI report(s) could be a mixture of SSBRI(s) and CRI(s).
RQ-34: Type(s) of the reported beam metric(s)—e.g., whether a reported beam metric is a L1-RSRP or a L1-SINR, or whether a reported group of beam metrics are L1-RSRPs, L1-SINRs or a mixture of L1-RSRPs and L1-SINRs.
   For example, the PN message/trigger could indicate to network whether the beam metric(s) reported in the corresponding UEI report(s)—e.g., in part of the content(s) as specified herein in the present disclosure—could comprise only L1-RSRPs, only L1-SINRs or a mixture of L1-RSRP(s) and L1-SINR(s); for instance, the PN message/trigger could correspond to or comprise a one-bit indicator; when/if the one-bit indicator is set to ‘0’ (or ‘1’), the beam metric(s) reported in the corresponding UEI report(s) could be L1-RSRP(s), and when/if the one-bit indicator is set to ‘1’ (or ‘0’), the beam metric(s) reported in the corresponding UEI report(s) could be L1-SINR(s); optionally, the PN message/trigger could correspond to or comprise a two-bit indicator; when/if the two-bit indicator is set to ‘00’ (or ‘01’, ‘10’ or ‘11’), the beam metric(s) reported in the corresponding UEI report(s) could be L1-RSRP(s), when/if the two-bit indicator is set to ‘01’ (or ‘00’, ‘10’ or ‘11’), the beam metric(s) reported in the corresponding UEI report(s) could be L1-SINR(s), and when/if the two-bit indicator is set to ‘10’ or ‘11’ (or ‘00’ or ‘01’), the beam metric(s) reported in the corresponding UEI report(s) could be a mixture of L1-RSRP(s) and L1-SINR(s).
   For another example, the UEI report(s)—e.g., the content(s) of (report-)type (B) or (report-)type (C) as specified herein in the present disclosure—could comprise or include or contain or provide one or more indicators with each indicator corresponding/associated to one or more beam metrics or one or more groups of beam metrics in the UEI report(s) according to those specified herein in the present disclosure. For instance, the indicator(s) could be or could correspond to one-bit indicator(s); when/if a one-bit indicator is set to ‘0’ (or ‘1’), the beam metric(s)/group(s) of beam metrics—associated/corresponding to the one-bit indicator—in the corresponding UEI report(s) could be L1-RSRP(s), and when/if a one-bit indicator is set to ‘1’ (or ‘0’), the beam metric(s)/group(s) of beam metrics—associated/corresponding to the one-bit indicator—in the corresponding UEI report(s) could be L1-SINR(s); optionally, the indicator(s) could be or could correspond to two-bit indicator(s); when/if a two-bit indicator is set to ‘00’ (or ‘01’, ‘10’ or ‘11’), the beam metric(s)/group(s) of beam metrics—associated/corresponding to the two-bit indicator—in the corresponding UEI report(s) could be L1-RSRP(s), when/if a two-bit indicator is set to ‘01’ (or ‘00’, ‘10’ or ‘11’), the beam metric(s)/group(s) of beam metrics—associated/corresponding to the two-bit indicator—in the corresponding UEI report(s) could be L1-SINR(s), and when/if a two-bit indicator is set to ‘10’ or ‘11’ (or ‘00’ or ‘01’), the beam metric(s)/group(s) of beam metrics—associated/corresponding to the two-bit indicator—in the corresponding UEI report(s) could be a mixture of L1-RSRP(s) and L1-SINR(s).
RQ-35: Value(s) of N, M, Nₘₐₓ and/or Mₘₐₓ as specified/defined herein in the present disclosure: for instance, the PN message/trigger—e.g., of (report-)type (A) or (report-)type (C) as specified herein in the present disclosure—could indicate value(s) of N, M, Nₘₐₓ and/or Mₘₐₓ; in one example, the PN message/trigger could indicate, provide, comprise, include or contain an index pointing to an entry of a list/set/pool of candidate values of N that are higher layer configured to the UE as the value of N; in another example, the PN message/trigger could indicate, provide, comprise, include or contain an index pointing to an entry of a list/set/pool of candidate values of M that are higher layer configured to the UE as the value of M.
RQ-36: Information related to whether a reported group of resource indicators are for simultaneous reception and/or simultaneous transmission—for simultaneous reception, the CSI-RS and/or SSB resources of each reported group could be received simultaneously by the UE (e.g., with a single spatial domain receive filter, or with multiple simultaneous spatial domain receive filters); for simultaneous transmission, the CSI-RS and/or SSB resources of each reported group could be applied for simultaneous transmission by the UE (e.g., with a single spatial domain transmit filter, or with multiple simultaneous spatial domain transmit filters).
   For example, the PN message/trigger could indicate to network whether the reported group(s) of resource indicators in the corresponding UEI report(s)—e.g., in part of the content(s) as specified herein in the present disclosure—could for simultaneous reception and/or simultaneous transmission (RQ-36a); for instance, the PN message/trigger could correspond to or comprise a one-bit indicator; when/if the one-bit indicator is set to ‘0’ (or ‘1’), the CSI-RS and/or SSB resources of each reported group in the corresponding UEI report(s) could be for simultaneous reception, and when/if the one-bit indicator is set to ‘1’ (or ‘0’), the CSI-RS and/or SSB resources of each reported group in the corresponding UEI report(s) could be for simultaneous transmission; optionally, the PN message/trigger could correspond to or comprise a two-bit indicator; when/if the two-bit indicator is set to ‘00’ (or ‘01’, ‘10’ or ‘11’), the CSI-RS and/or SSB resources of each reported group in the corresponding UEI report(s) could be for simultaneous reception, when/if the two-bit indicator is set to ‘01’ (or ‘00’, ‘10’ or ‘11’), the CSI-RS and/or SSB resources of each reported group in the corresponding UEI report(s) could be for simultaneous transmission, and when/if the two-bit indicator is set to ‘10’ or ‘11’ (or ‘00’ or ‘01’), the CSI-RS and/or SSB resources of each reported group in the corresponding UEI report(s) could be for both simultaneous reception and simultaneous transmission.
   For another example, the UEI report(s)—e.g., the content(s) of (report-)type (B) or (report-)type (C) as specified herein in the present disclosure—could comprise or include or contain or provide one or more indicators with each indicator corresponding/associated to one or more reported groups of resource indicators/beam metrics in the UEI report(s) according to those specified herein in the present disclosure (RQ-36b). For instance, the indicator(s) could be or could correspond to one-bit indicator(s); when/if a one-bit indicator is set to ‘0’ (or ‘1’), the CSI-RS and/or SSB resources of the reported group that is associated/corresponding to the one-bit indicator in the corresponding UEI report(s) could be for simultaneous reception, and when/if a one-bit indicator is set to ‘1’ (or ‘0’), the CSI-RS and/or SSB resources of the reported group that is associated/corresponding to the one-bit indicator in the corresponding UEI report(s) could be for simultaneous transmission; optionally, the indicator(s) could be or could correspond to two-bit indicator(s); when/if a two-bit indicator is set to ‘00’ (or ‘01’, ‘10’ or ‘11’), the CSI-RS and/or SSB resources of the reported group that is associated/corresponding to the two-bit indicator in the corresponding UEI report(s) could be for simultaneous reception, when/if a two-bit indicator is set to ‘01’ (or ‘00’, ‘10’ or ‘11’), the CSI-RS and/or SSB resources of the reported group that is associated/corresponding to the two-bit indicator in the corresponding UEI report(s) could be for simultaneous transmission, and when/if a two-bit indicator is set to ‘10’ or ‘11’ (or ‘00’ or ‘01’), the CSI-RS and/or SSB resources of the reported group that is associated/corresponding to the two-bit indicator in the corresponding UEI report(s) could be for both simultaneous transmission and simultaneous reception.
RQ-37: Index(es)/ID(s) of CSI resource set(s) and/or CSI resource group(s) and/or CSI resource sub-set(s) associated/specific to one or more resource indicators (and therefore, the corresponding beam metric(s)) and/or one or more groups of resource indicators (and therefore, the corresponding beam metric(s)) in the UEI report(s)
RQ-38: Information of or related to whether or not differential L1-RSRP/L1-SINR reporting is applied to the reported (group(s) of) beam metrics in the UEI report(s); if differential L1-RSRP/L1-SINR reporting is applied, step-size value(s) used for computing differential L1-RSRP/L1-SINR value(s)

Furthermore, the UEI report(s) as specified herein in the present disclosure—for instance, including the PN message/trigger—e.g., of (report-)type (A) or (report-)type (C) as specified herein in the present disclosure, and/or the (corresponding) content(s)—e.g., of (report-)type (B) or (report-)type (C) as specified herein in the present disclosure—could also comprise information related to panel status at the UE, e.g., when the UE (e.g., the UE 116) is equipped with multiple panels—also known as multi-panel UE or MPUE—and uses or activates one or more of them at a time; in particular, the information related to panel status could comprise, include, contain or provide one or more of (each of which can also be referred to as a report quantity throughout the present disclosure):
RQ-39: One or more values of CapabilityIndex (e.g., 1, 2, 3 or 4), or one or more maximum numbers of SRS ports, each associated/corresponding to one or more resource indicators/beam metrics in each reported group of resource indicators/beam metrics, and/or associated/corresponding to one or more reported groups of resource indicators/beam metrics specified/defined herein in the present disclosure
RQ-40: One or more panel IDs/indexes—e.g., {panel ID #1}, {panel ID #2}, {panel ID #1, panel ID #2}-indicating, informing or providing to the network that the corresponding panel(s) at the UE could be activated/deactivated
RQ-41: A bitmap (e.g., of length two) with each entry/bit position of the bitmap indicating ‘on’/‘off’ condition or status of a corresponding panel at the UE; when/if an entry/bit position of the bitmap is set to ‘0’ (or ‘1’), the UE could indicate, inform or provide to the network that the panel (or panel ID/index) corresponding or associated to the entry/bit position is turned off or deactivated at the UE, and/or when/if an entry/bit position of the bitmap is set to ‘1’ (or ‘0’), the UE could indicate, inform or provide to the network that the panel (or panel ID/index) corresponding or associated to the entry/bit position is turned on or activated at the UE.
RQ-42: Number of SRS ports (of a SRS resource) associated/specific to one or more of the panels (or panel IDs/indexes), and/or associated/corresponding to one or more resource indicators/beam metrics in each reported group of resource indicators/beam metrics, and/or associated/corresponding to one or more reported groups of resource indicators/beam metrics specified/defined herein in the present disclosure; for instance, for a UE equipped with a first and a second panels, the UEI report(s) could comprise a set of two values {P1, P2}, respectively indicating the numbers of SRS ports (of a SRS resource) associated/specific to the first and second panels, wherein P1+P2=P, and P could represent the corresponding maximum number of SRS ports, which could be reported as a value of CapabilityIndex as defined/specified herein in the present disclosure.
RQ-43: Number of SRS resources (e.g., 1, 2, etc.) associated/specific to one or more of the panels (or panel IDs/indexes), and/or associated/corresponding to one or more resource indicators/beam metrics in each reported group of resource indicators/beam metrics, and/or associated/corresponding to one or more reported groups of resource indicators/beam metrics specified/defined herein in the present disclosure
RQ-44: Number of SRS resource sets (e.g., 1, 2, etc.) associated/specific to one or more of the panels (or panel IDs/indexes), and/or associated/corresponding to one or more resource indicators/beam metrics in each reported group of resource indicators/beam metrics, and/or associated/corresponding to one or more reported groups of resource indicators/beam metrics specified/defined herein in the present disclosure
RQ-45: SRS resource index(es)/ID(s)—e.g., from a configured set of SRS resource index(es)/ID(s)—associated/specific to one or more of the panels (or panel IDs/indexes), and/or associated/corresponding to one or more resource indicators/beam metrics in each reported group of resource indicators/beam metrics, and/or associated/corresponding to one or more reported groups of resource indicators/beam metrics specified/defined herein in the present disclosure; for example, the UEI report(s) could comprise a single SRS resource index/ID indicating, providing or informing to the network (e.g., the network 130) that the SRS resource associated/corresponding to the reported SRS resource index/ID could be used for panels at the UE; for another example, for a UE equipped with a first and a second panels, the UEI report(s) could comprise one or more first SRS resource indexes/IDs associated/specific to the first panel (and therefore, the one or more resource indicators/beam metrics in each reported group of resource indicators/beam metrics and/or the one or more reported groups of resource indicators/beam metrics associated/specific to the first panel), and/or one or more second SRS resource indexes/IDs associated/specific to the second panel (and therefore, the one or more resource indicators/beam metrics in each reported group of resource indicators/beam metrics and/or the one or more reported groups of resource indicators/beam metrics associated/specific to the second panel)
RQ-46: SRS resource set index(es)/ID(s) associated/specific to one or more of the panels (or panel IDs/indexes), and/or associated/corresponding to one or more resource indicators/beam metrics in each reported group of resource indicators/beam metrics, and/or associated/corresponding to one or more reported groups of resource indicators/beam metrics specified/defined herein in the present disclosure; for instance, when two SRS resource sets—referred to as a first SRS resource set and a second SRS resource set—are configured in srs-ResourceSetToAddModList or srs-ResourceSetToAddModListDCI-0-2 with higher layer parameter usage in SRS-ResourceSet set to ‘codebook’ or ‘nonCodebook’, the UEI report(s) could comprise a first SRS resource set index/ID for the first SRS resource set associated/specific to the first panel (and therefore, the one or more resource indicators/beam metrics in each reported group of resource indicators/beam metrics and/or the one or more reported groups of resource indicators/beam metrics associated/specific to the first panel) and/or a second SRS resource set index/ID for the second SRS resource set associated/specific to the second panel (and therefore, the one or more resource indicators/beam metrics in each reported group of resource indicators/beam metrics and/or the one or more reported groups of resource indicators/beam metrics associated/specific to the second panel)
Information related to UL power control and/or UL data volume at the UE, including
   RQ-47: One or more buffer sizes and/or one or more buffer size reports
   RQ-48: Information indicating whether or not maximum permissible exposure (MPE) reporting—e.g., via the UEI reporting—is enabled
   RQ-49: Information indicating whether or not the applied power management maximum power reduction (P-MPR) value, to meet MPE requirements, is less than P-MPR_00; for instance, the information could be a one-bit indicator—when/if the one-bit indicator is set to ‘0’ (or ‘1’), the information could indicate that the applied P-MPR value, to meet MPE requirements, is less than P-MPR_00, and/or when/if the one-bit indicator is set to ‘1’ (or ‘0’), the information could indicate that the applied P-MPR value, to meet MPE requirements, is greater than (and/or equal to) P-MPR_00
   RQ-50: Applied power back-off to meet MPE requirements: when/if the MPE reporting is enabled (e.g., via network's configuration(s)/indication(s)—e.g., via higher layer RRC signaling(s)/parameter(s), and/or via UEI reporting as specified herein in the present disclosure), and/or when/if the applied P-MPR value is greater than (and/or equal to) P-MPR 00 (e.g., via network's configuration(s)/indication(s)—e.g., when/if the Pi field in a single-entry/multi-entry PHR MAC CE is set to 1, and/or via the one-bit indicator in the UEI report(s)—e.g., set to ‘1’—as specified herein in the present disclosure), the UEI report(s) could comprise the applied power back-off indicating an index to Table 6.1.3.8-3 in the 3GPP TS 38.321 [REF5] and the corresponding measured values of P-MPR levels in dB are specified/provided in the 3GPP TS 38.133; furthermore, the applied power back-off could be a 2-bit value.
   RQ-51: Information indicating whether or not a power headroom (PH) value/level is reported, e.g., in the UEI report(s), for a physical cell ID (PCI) or PCI index (e.g., a serving cell PCI or PCI index, or a PCI/PCI index other than the serving cell PCI/PCI index)
   RQ-52: Information indicating whether or not the PH value/level—e.g., reported in a UEI report according to those specified herein in the present disclosure—is based on a real transmission or a reference format. The information could be a one-bit indicator; for Type 1 PH, the one-bit indicator set to 0 could indicate real transmission on PUSCH and the one-bit indicator set to 1 could indicate that a PUSCH reference format is used; for Type 2 PH, the one-bit indicator set to 0 could indicate real transmission on PUCCH and the one-bit indicator set to 1 could indicate that a PUCCH reference format is used; for Type 3 PH, the one-bit indicator set to 0 could indicate real transmission on SRS and the one-bit indicators set to 1 could indicate that an SRS reference format is used; in addition, for Type 1, Type 2, and Type 3 PH, the one-bit indicator set to 0 could indicate the presence of Pcmax and MPE reporting in the corresponding PHR MAC CE and/or UEI report(s) as specified herein in the present disclosure, and the one-bit indicator set to 1 could indicate that Pcmax and MPE reporting could be omitted in the corresponding PHR MAC CE and/or UEI report(s) as specified herein in the present disclosure.
   RQ-53: PH: the UEI report(s) could comprise or indicate the PH level, which could correspond to a 6-bit indicator; the reported PH and the corresponding power headroom levels are provided in Table 6.1.3.8-1 in the 3GPP TS 38.321 [REF5](the corresponding measured values in dB are specified in the 3GPP TS 38.133)
   RQ-54: Pcmax: the UEI report(s) could comprise or indicate the Pcmax used for calculating the preceding PH value/level; the reported Pcmax and the corresponding nominal UE transmit power levels are shown in Table 6.1.3.8-2 in the 3GPP TS 38.321 [REF5](the corresponding measured values in dBm are specified in the 3GPP TS 38.133).

Throughout the present disclosure, a SSBRI or a CRI reported in a UEI report(s) as specified herein in the present disclosure could indicate or identify a candidate beam, and the SSBRI or the CRI could be signaled by the number (index) of entries in the corresponding CSI-SSB or NZP-CSI-RS ResourceSets identified or provided by a higher layer parameter/signaling, e.g., denoted by uei-ResourcePool, that provides or configures RS resources including SSB and/or CSI-RS resources for the UEI reporting. For instance, the higher layer parameter/signaling uei-ResourcePool could provide, comprise, contain, include, configure or indicate a list of SSB/CSI-RS resources for UEI reporting; each resource is configured with a PCI (e.g., a serving cell PCI or a serving cell index or a PCI/PCI index other than the serving cell PCF/PCI index/index) where the resource is configured for the UE. Furthermore, the higher layer parameter/signaling uei-ResourcePool could also indicate, provide or configure to the UE the maximum number of RS resources including SSB and/or CSI-RS resources configured for the UEI reporting, time and/or frequency domain resource allocation(s)/behaviors of the RS resources including SSB and/or CSI-RS resources configured for the UEI reporting, corresponding SSB and/or CSI-RS resource set(s)—e.g., in terms of their resource set ID(s)/index(es)—configured for the UEI reporting. Examples of the corresponding/related higher layer parameters for configuring UEI measurement and/or reporting are provided in Table 6.

TABLE 6
UEI-Config information element

-- ASN1START
-- TAG-UEI-CONFIG-START

| | |
|---|---|
| UEI-Config ::= | SEQUENCE { |

...

| | | |
|---|---|---|
| uei-Reporting | SetupRelease { UEI-Resource-Report-Config } | OPTIONAL, -- Need M |

...
}
...

| | |
|---|---|
| UEI-Resource-Report-Config ::= | SEQUENCE { |

...,

| | |
|---|---|
| uei-ResourcePool | SEQUENCE (SIZE(1..maxUEI-Resources)) OF UEI-Resource, |

...
}

| UEI-Resource ::= | SEQUENCE { | |
|---|---|---|
| uei-ResourceId | INTEGER (1..maxUEI-Resources), | |
| cell | ServCellIndex | OPTIONAL, -- Need R |

| | |
|---|---|
| uei-ReferenceSignal | CHOICE { |
| uei-csi-RS-Resource | NZP-CSI-RS-ResourceId, |
| uei-ssb-Resource | SSB-Index |

}
}

In one embodiment, when/if a UE is configured with one or two SRS resource sets in srs-ResourceSetToAddModList or srs-ResourceSetToAddModListDCI-0-2 with higher layer parameter usage in SRS-ResourceSet set to ‘codebook’ and/or ‘noncodebook’, and/or when/if the UE provides or indicates to the network, e.g., via/in a UEI report as specified herein in the present disclosure, one or two SRS resource sets—e.g., in terms/form of their resource set ID(s)/index(es) selected by the UE—with their corresponding usage(s) provided/indicated, e.g., via/in the same UEI report(s), set to or as ‘codebook’ and/or ‘noncodebook’—i.e., a UEI report could comprise, include, contain, provide or indicate the one or two SRS resource sets—e.g., in terms/form of their resource set ID(s)/index(es) selected by the UE—with their corresponding usage(s) provided/indicated, e.g., via/in the same UEI report(s), set to or as ‘codebook’ and/or ‘noncodebook’, (1) one or two SRIs (e.g., a first and a second SRIs), and/or one or two transmit precoding matrix indicators (TPMIs) (e.g., a first and a second TPMIs) could be indicated/given by the DCI field(s) of one or two SRS resource indicator, and/or one or two Precoding information and number of layers for DCI format 0_1 and 0_2, and/or (2) one or two SRIs (e.g., a first and a second SRIs)—e.g., selected by the UE, and/or one or two TPMIs (e.g., a first and a second TPMIs)—e.g., selected by the UE, could be provided, indicated, comprised, included or contained via/in a UEI report as specified herein in the present disclosure—or equivalently, the UE could transmit or send to the network a UEI report comprising, including, containing, providing or indicating the one or two SRIs (e.g., a first and a second SRIs)—e.g., selected by the UE, and the one or two TPMIs (e.g., a first and a second TPMIs)—e.g., selected by the UE. For this case/setting, the UEI report(s) as defined/specified herein in the present disclosure could also comprise, include, contain, provide or indicate information related to or indicating dynamic switching between STxMP single frequency network (SFN) scheme and sTRP transmission—or equivalently, the UE could also send or transmit, in a UEI report, information related to or indicating the dynamic switching between STxMP SFN scheme and sTRP transmission, wherein the information could be or could correspond to a two-bit indicator (RQ-55).
In one example, when/if the UEI report(s) that comprises, provides, includes, contains or indicates the two-bit indicator has become applicable—i.e., the content(s) in the UEI report(s) as specified/defined herein in the present disclosure has become applicable (or the two-bit indicator in the UEI report(s) has become applicable) according to those specified herein in the present disclosure, and/or when/if the higher layer parameter multipanelScheme is set to ‘SDMScheme’:
   When/if the two-bit indicator is set to ‘00’ or ‘01’, the second indicated/selected SRI and the second indicated/selected TPMI as defined/specified herein in the present disclosure could be reserved, and the first indicated/selected TPMI could be used to indicate the precoder to be applied over layers {0 . . . v−1} where v≤maxRank, where maxRank is defining the maximum number of layers.
   When/if the two-bit indicator is set to ‘10’, the first indicated/selected TPMI as defined/specified herein in the present disclosure could be used to indicate the precoder to be applied over layers {0 . . . v₁−1}, where v₁ is the number of layers indicated by the first indicated/selected TPMI, that corresponds to the SRS resource selected by the corresponding SRI when multiple SRS resources are configured for the applicable SRS resource set or if single SRS resource is configured for the applicable SRS resource set, and the second indicated/selected TPMI is used to indicate the precoder to be applied over layers {v₁ . . . v₂+v₁−1}, where v₂ is the number of layers indicated by the second indicated/selected TPMI, that corresponds to the SRS resource selected by the corresponding SRI when multiple SRS resources are configured for the applicable SRS resource set or if single SRS resource is configured for the applicable SRS resource set, v₁≤maxRankSdm and v₂≤maxRankSdm or maxRankSdmDCI-0-2 and maxRankSdm or maxRankSdmDCI-0-2 are defining the maximum number of layers applied over the first and the second SRS resource sets, separately.
   The two-bit indicator set to ‘11’ could be reserved.
   For one or two indicated/selected TPMIs as defined/specified herein in the present disclosure, the transmission precoder is selected from the UL codebook that has a number of antenna ports equal to the higher layer parameter nrofSRS-Ports in SRS-Config for the indicated SRI(s). When two TPMIs are indicated/selected, the UE could expect that the precoder indicated/selected by the first indicated/selected TPMI and the precoder indicated/selected by the second indicated/selected TPMI are mapped to different PUSCH antenna ports.
   When two SRIs are indicated/selected as specified/defined herein in the present disclosure, the UE could expect that the number of SRS antenna ports associated with two indicated/selected SRIs would be the same. When the UE is configured with the higher layer parameter txConfig set to ‘codebook’, the UE is configured with at least one SRS resource. Each of the indicated/selected one or two SRIs in slot n is associated with the most recent transmission of SRS resource of associated SRS resource set identified by the SRI, where the SRS resource is prior to the physical DL control channel (PDCCH) carrying the SRI. When two SRS resource sets are used/applied, e.g., configured in srs-ResourceSetToAddModList or srs-ResourceSetToAddModListDCI-0-2 with higher layer parameter usage in SRS-ResourceSet set to ‘codebook’, the UE is not expected to be configured with different number of SRS resources in the two SRS resource sets.
In another example, when/if the UEI report(s) that comprises, provides, includes, contains or indicates the two-bit indicator has become applicable—i.e., the content(s) in the UEI report(s) as specified/defined herein in the present disclosure has become applicable (or the two-bit indicator in the UEI report(s) has become applicable) according to those specified herein in the present disclosure, and/or when/if the higher layer parameter multipanelScheme is set to ‘SFNScheme’:
   When/if the two-bit indicator is set to ‘00’ or ‘01’, the second indicated/selected SRI and the second indicated/selected TPMI as defined/specified herein in the present disclosure are reserved, the first indicated/selected TPMI is used to indicate precoder to be applied over layers {0 . . . v−1}, where v≤maxRank and where maxRank is defining the maximum number of layers applied over the first SRS resource set or the second SRS resource set.
   For one or two indicated/selected TPMIs, the transmission precoder is selected from the UL codebook that has a number of antenna ports equal to nrofSRS-Ports in SRS-Config for the indicated SRI(s), as defined in Clause 6.3.1.5 of the 3GPP TS 38.211 [REF1]. When two TPMIs are indicated/selected, the UE could expect that the precoder indicated/selected by the first indicated/selected TPMI and the precoder indicated/selected by the second indicated/selected TPMI are mapped to different PUSCH antenna ports.
      When/if the two-bit indicator is set to ‘10’, the first indicated/selected TPMI is used to indicate precoder to be applied over layers {0 . . . v−1} and the second indicated/selected TPMI is used to indicate the precoder to be applied over layers {0 . . . v−1}, where v≤maxRankSfn or maxRankSfnDCI-0-2 and maxRankSfn or maxRankSfnDCI-0-2 defining the maximum number of layers applied over the first SRS resource set and over the second SRS resource set separately.
   The two-bit indicator set to ‘11’ could be reserved.
   When two TPMIs are indicated/selected, the UE could expect that the number of SRS antenna ports associated with two indicated/selected SRIs to be the same. When the UE is configured with the higher layer parameter txConfig set to ‘codebook’, the UE is configured with at least one SRS resource. Each of the indicated/selected one or two SRIs in slot n is associated with the most recent transmission of SRS resource of associated SRS resource set identified by the SRI, where the SRS resource is prior to the PDCCH carrying the SRI. When two SRS resource sets are used/applied, e.g., configured in srs-ResourceSetToAddModList or srs-ResourceSetToAddModListDCI-0-2 with higher layer parameter usage in SRS-ResourceSet set to ‘codebook’, the UE is not expected to be configured with different number of SRS resources in the two SRS resource sets.

In one embodiment, when/if a UE is configured with one or two SRS resource sets in srs-ResourceSetToAddModList or srs-ResourceSetToAddModListDCI-0-2 with higher layer parameter usage in SRS-ResourceSet set to ‘codebook’ and/or ‘noncodebook’, and/or when/if the UE provides or indicates to the network, e.g., via/in a UEI report as specified herein in the present disclosure, one or two SRS resource sets—e.g., in terms/form of their resource set ID(s)/index(es) selected by the UE—with their corresponding usage(s) provided/indicated, e.g., via/in the same UEI report(s), set to or as ‘codebook’ and/or ‘noncodebook’—i.e., a UEI report could comprise, include, contain, provide or indicate the one or two SRS resource sets—e.g., in terms/form of their resource set ID(s)/index(es) selected by the UE—with their corresponding usage(s) provided/indicated, e.g., via/in the same UEI report(s), set to or as ‘codebook’ and/or ‘noncodebook’, (1) one or two SRIs (e.g., a first and a second SRIs) could be indicated/given by the DCI field(s) of one or two SRS resource indicator for DCI format 0_1 and 0_2, and/or (2) one or two SRIs (e.g., a first and a second SRIs)—e.g., selected by the UE—could be provided, indicated, comprised, included or contained via/in a UEI report as specified herein in the present disclosure—or equivalently, the UE could transmit or send to the network a UEI report comprising, including, containing, providing or indicating the one or two SRIs (e.g., a first and a second SRIs)—e.g., selected by the UE. For this case/setting, the UEI report(s) as defined/specified herein in the present disclosure could also comprise, include, contain, provide or indicate information related to or indicating dynamic switching between STxMP SFN scheme and sTRP transmission—or equivalently, the UE could also send or transmit, in a UEI report, information related to or indicating the dynamic switching between STxMP SFN scheme and sTRP transmission, wherein the information could be or could correspond to a two-bit indicator (RQ-56).
In one example, when/if the UEI report(s) that comprises, provides, includes, contains or indicates the two-bit indicator has become applicable—i.e., the content(s) in the UEI report(s) as specified/defined herein in the present disclosure has become applicable (or the two-bit indicator in the UEI report(s) has become applicable) according to those specified herein in the present disclosure, and/or when/if the higher layer parameter multipanelScheme is set to ‘SDMScheme’:
   When/if the two-bit indicator is set to ‘00’ or ‘01’, the second indicated/selected SRI is reserved, the first indicated/selected SRI is used to indicate resource(s) to be associated with layers {0 . . . v−1}, v≤Lₘₐₓ.
   When/if the two-bit indicator is set to ‘10’, the first indicated/selected SRI is used to indicate resource(s) to be associated with layer(s) {0 . . . v₁−1}, where v₁ being the number of layers indicated by the first indicated/selected SRI, and the second indicated/selected SRI is used to indicate resource(s) to be associated with layer(s) {v₁ . . . v₂+v₁−1}, v₁≤Lₘₐₓ and v₂≤Lₘₐₓ where Lₘₐₓ is defined in clauses 7.3.1.1.2 and 7.3.1.1.3 of the 3GPP TS 38.212 [REF2]. The UE could expect that SRS resource(s) indicated/selected by the first indicated/selected SRI and SRS resource(s) indicated/selected by the second indicated/selected SRI are corresponding to different PUSCH antenna ports.
In another example, when/if the UEI report(s) that comprises, provides, includes, contains or indicates the two-bit indicator has become applicable—i.e., the content(s) in the UEI report(s) as specified/defined herein in the present disclosure has become applicable (or the two-bit indicator in the UEI report(s) has become applicable) according to those specified herein in the present disclosure, and/or when/if the higher layer parameter multipanelScheme is set to ‘SFNScheme’:
   When/if the two-bit indicator is set to ‘10’, the first indicated/selected SRI is used to indicate resource(s) to be associated with layer(s) {0 . . . v−1} and the second indicated/selected SRI is used to indicate resource(s) to be associated with layer(s) {0 . . . v−1}, where v≤Lₘₐₓ and where Lₘₐₓ is defined in clauses 7.3.1.1.2 and 7.3.1.1.3 of the 3GPP TS 38.212 [REF2]. The UE (e.g., the UE 116) could expect that SRS resource(s) indicated/selected by the first indicated/selected SRI and SRS resource(s) indicated/selected by the second indicated/selected SRI are corresponding to different PUSCH antenna ports.
   When/if the two-bit indicator is set to ‘00’ or ‘01’, the second indicated/selected SRI is reserved, the first indicated/selected SRI is used to indicate resources(s) to be associated with layers {0 . . . v−1}, where v≤Lₘₐₓ. When two SRIs are indicated/selected, the UE could expect that the number of SRS antenna ports associated with two indicated/selected SRIs to be the same.
   The two-bit indicator set to ‘11’ could be reserved.
   When the UE is configured with the higher layer parameter txConfig set to ‘Noncodebook’, the UE is configured with at least one SRS resource. Each of the indicated/selected one or two SRI(s) in slot n is associated with the most recent transmission of SRS resource of associated SRS resource set identified by the SRI, where the SRS resource is prior to the PDCCH carrying the SRI. When two SRS resource sets are used/applied, e.g., configured in srs-ResourceSetToAddModList or srs-ResourceSetToAddModListDCI-0-2 with higher layer parameter usage in SRS-ResourceSet set to ‘Noncodebook’, the UE is not expected to be configured with different number of SRS resources in the two SRS resource sets.

FIG. 10 illustrates a diagram of example report quantities 1000 according to embodiments of the present disclosure. For example, report quantities 1000 can be reported by any of the UEs 111-116 of FIG. 1. This example is for illustration only and other embodiments can be used without departing from the scope of the present disclosure.

In one embodiment, when/if a UE is configured or provided or indicated by the network (e.g., the network 130), e.g., via higher layer RRC signaling(s)/parameter(s) and/or MAC CE command(s) and/or dynamic DCI based L1 signaling(s), a list/set/pool of one or more cell IDs/indexes and/or a list/set/pool of component carrier (CC) IDs/indexes and/or a list/set/pool of SCell(s) IDs/indexes for carrier aggregation (CA) settings or other multi-carrier, multi-frequency or inter-frequency deployment scenarios, and/or when/if the UE-initiated beam reporting is enabled according to those specified herein in the present disclosure, the UEI report content(s)/quantity(s) as defined/specified herein in the present disclosure could also comprise one of more of:
RQ-57: one or more cell IDs/indexes, e.g., from the list/set/pool of cell IDs/indexes configured/provided/indicated to the UE; for example, a cell ID could correspond to a physical or absolute ID value; for another example, a cell index could point/correspond to an entry in the list/set/pool of cell IDs/indexes—in this case, when/if the number of cell IDs/indexes in the list/set/pool is Ncell, the bitwidth for determining the cell index is └log₂(Ncell)┘ or ┌log₂(Ncell)┐.
RQ-58: one or more CC IDs/indexes, e.g., from the list/set/pool of CC IDs/indexes configured/provided/indicated to the UE; for example, a CC ID could correspond to a physical or absolute ID value; for another example, a CC index could point/correspond to an entry in the list/set/pool of CC IDs/indexes—in this case, when/if the number of CC IDs/indexes in the list/set/pool is Ncc, the bitwidth for determining the CC index is └log₂(Ncc)┘ or ┌log₂(Ncc)┐.
RQ-59: one or more IDs/indexes for SCell(s), e.g., from the list/set/pool of IDs/indexes for SCell(s) configured/provided/indicated to the UE; for example, a SCell ID could correspond to a physical or absolute ID value; for another example, a SCell index could point/correspond to an entry in the list/set/pool of IDs/indexes for SCell(s)—in this case, when/if the number of SCell IDs/indexes in the list/set/pool is Nscell, the bitwidth for determining the SCell index is └log₂(Nscell)┘ or ┌log₂(Nscell)┐.
RQ-60: a bitmap with each entry/bit position of the bitmap corresponding/associated to a cell ID/index in the list/set/pool of cell IDs/indexes; when/if an entry/bit position of the bitmap is set to ‘1’ (or ‘0’), the corresponding UEI beam report(s)—e.g., including the PN message/trigger and/or the actual UEI beam report content(s)/quantity(s) as specified/defined herein in the present disclosure—could be applicable or applied or used for the cell that has the cell ID/index corresponding/associated to the entry/bit position.
RQ-61: a bitmap with each entry/bit position of the bitmap corresponding/associated to a CC ID/index in the list/set/pool of CC IDs/indexes; when/if an entry/bit position of the bitmap is set to ‘1’ (or ‘0’), the corresponding UEI beam report(s)—e.g., including the PN message/trigger and/or the actual UEI beam report content(s)/quantity(s) as specified/defined herein in the present disclosure—could be applicable or applied or used for the CC that has the CC ID/index corresponding/associated to the entry/bit position.
RQ-62: a bitmap with each entry/bit position of the bitmap corresponding/associated to a ID/index for a SCell in the list/set/pool of IDs/indexes for SCell(s); when/if an entry/bit position of the bitmap is set to ‘1’ (or ‘0’), the corresponding UEI beam report(s)—e.g., including the PN message/trigger and/or the actual UEI beam report content(s)/quantity(s) as specified/defined herein in the present disclosure—could be applicable or applied or used for the SCell that has the ID/index corresponding/associated to the entry/bit position.

When/if the cell ID(s)/index(es)—e.g., RQ-57, CC ID(s)/index(es)—e.g., RQ-58, and/or ID(s)/index(es) for SCell(s)—e.g., RQ-59 is/are provided, comprised, included, contained or indicated in the beam report, the corresponding UEI beam report(s)—e.g., including the PN message/trigger and/or the actual UEI beam report content(s)/quantity(s) as specified/defined herein in the present disclosure—could be applicable or applied or used for the cell(s) that has the cell ID(s)/index(es) indicated or provided in the beam report, the CC(s) that has the CC ID(s)/index(es) indicated or provided in the beam report, and/or the SCell(s) that has the SCell ID(s)/index(es) indicated or provided in the beam report.

In one embodiment, when/if a UE is configured or provided or indicated by the network, e.g., via higher layer RRC signaling(s)/parameter(s) and/or MAC CE command(s) and/or dynamic DCI based L1 signaling(s), a list/set/pool of one or more cell IDs/indexes and/or a list/set/pool of component carrier (CC) IDs/indexes and/or a list/set/pool of SCell(s) IDs/indexes for carrier aggregation (CA) settings or other multi-carrier, multi-frequency or inter-frequency deployment scenarios, and/or when/if the UE-initiated beam reporting is enabled according to those specified herein in the present disclosure,
In one example, when/if the UE transmits or sends the UEI beam report(s) as specified/defined herein in present disclosure on or in or for a cell having a cell ID/index in the list/set/pool of cell ID(s)/index(es), the UEI beam report(s)—e.g., including the PN message/trigger and/or the actual UEI beam report content(s)/quantity(s) as specified/defined herein in the present disclosure—could be applicable or applied or used for the cells that have their cell IDs/indexes in the same list/set/pool of cell ID(s)/index(es).
In another example, when/if the UE transmits or sends the UEI beam report(s) as specified/defined herein in present disclosure on or in or for a CC having a CC ID/index in the list/set/pool of CC ID(s)/index(es), the UEI beam report(s)—e.g., including the PN message/trigger and/or the actual UEI beam report content(s)/quantity(s) as specified/defined herein in the present disclosure—could be applicable or applied or used for the CCs that have their CC IDs/indexes in the same list/set/pool of CC ID(s)/index(es).
In another example, when/if the UE transmits or sends the UEI beam report(s) as specified/defined herein in present disclosure on or in or for a SCell having a SCell ID/index in the list/set/pool of SCell ID(s)/index(es), the UEI beam report(s)—e.g., including the PN message/trigger and/or the actual UEI beam report content(s)/quantity(s) as specified/defined herein in the present disclosure—could be applicable or applied or used for the SCells that have their SCell IDs/indexes in the same list/set/pool of SCell ID(s)/index(es).

In one embodiment, when/if a UE is configured with one or two SRS resource sets in srs-ResourceSetToAddModList or srs-ResourceSetToAddModListDCI-0-2 with higher layer parameter usage in SRS-ResourceSet set to ‘codebook’ and/or ‘noncodebook’, and/or when/if the UE provides or indicates to the network, e.g., via/in a UEI report as specified herein in the present disclosure, one or two SRS resource sets—e.g., in terms/form of their resource set ID(s)/index(es) selected by the UE—with their corresponding usage(s) provided/indicated, e.g., via/in the same UEI report(s), set to or as ‘codebook’ and/or ‘noncodebook’—i.e., a UEI report could comprise, include, contain, provide or indicate the one or two SRS resource sets—e.g., in terms/form of their resource set ID(s)/index(es) selected by the UE—with their corresponding usage(s) provided/indicated, e.g., via/in the same UEI report(s), set to or as ‘codebook’ and/or ‘noncodebook’, the UEI report(s) as defined/specified herein in the present disclosure could also comprise, include, contain, provide or indicate information related to or indicating dynamic switching between STxMP SFN scheme and sTRP transmission—or equivalently, the UE could also send or transmit, in a UEI report, information related to or indicating the dynamic switching between STxMP SFN scheme and sTRP transmission, wherein the information could be or could correspond to a two-bit indicator. In one example, when/if the UEI report(s) that comprises, provides, includes, contains or indicates the two-bit indicator has become applicable—i.e., the content(s) in the UEI report(s) as specified/defined herein in the present disclosure has become applicable (or the two-bit indicator in the UEI report(s) has become applicable) according to those specified herein in the present disclosure, and/or when/if the higher layer parameter multipanelScheme is set to ‘SDMScheme’, and/or when/if the UE is scheduled with Qₚ{1,2} phase tracking reference signal (PT-RS) port(s) in UL and the number of scheduled layers is n_{layer}^{PUSCH}, and/or when/if two SRS resource sets are used/applied, e.g., configured in srs-ResourceSetToAddModList or srs-ResourceSetToAddModListDCI-0-2 with higher layer parameter usage in SRS-ResourceSet set to ‘codebook’/‘nonCodebook’, and/or when/if the two-bit indicator in the UEI report(s) is set to ‘10’, α_{PTRS}^{PUSCH} for each PT-RS port is based on Table 6.2.3.1-3B in the 3GPP TS 38.214 [REF4], where Qₚ is the total number of PT-RS ports for the PUSCH.

A UE could be configured, indicated or provided by the network, e.g., via higher layer RRC signaling(s)/parameter(s) and/or MAC CE command(s) and/or dynamic DCI based L1 signaling(s)—e.g., based on or according to a corresponding UE's capability or capability signaling, to report, in a UEI report, one or more of candidate report quantities, e.g., {RQ-1, RQ-2, . . . , RQ-62}, as specified or defined herein in the present disclosure (or a full-set, e.g., {RQ-1, RQ-2, . . . , RQ-62}, or one or more sub-sets, e.g., a subset {RQ-39, . . . RQ-54}, of the candidate report quantities as specified or defined herein in the present disclosure). For instance, the UE could be provided by the network reportQuantity or ueiReportQuantity in CSI-ReportConfig set to one or more of the report quantities as specified herein in the present disclosure. In FIG. 10, examples of the UEI report content(s)/quantity(s) are provided.

Optionally, the UE could autonomously determine which one or more of candidate report quantities, e.g., {RQ-1, RQ-2, . . . , RQ-62}, as specified or defined herein in the present disclosure (or a full-set, e.g., {RQ-1, RQ-2, . . . , RQ-62}, or one or more sub-sets, e.g., a subset {RQ-39, . . . , RQ-54}, of the candidate report quantities as specified or defined herein in the present disclosure) to report as content(s) of one or more UEI reports according to those specified herein in the present disclosure—e.g., of (report-)type (B) or (report-)type (C) as specified herein in the present disclosure. Furthermore, the UE could indicate or inform or provide to the network, e.g., via a PN message/trigger or an indicator or a UCI (including hybrid automatic repeat request acknowledgement (HARQ-ACK), scheduling request (SR), CSI and etc.), their autonomously determined report quantity(s) such as a full-set or one or more sub-sets of the candidate report quantities as defined or specified herein in the present disclosure.
In one example, the PN message/trigger could be or could correspond to/comprise a one-bit/multi-bit indicator or a multi-level indicator or a multi-state indicator, e.g., a L-bit indicator (L≥1) having 2^{L} states, with each bit/level/state of the PN message/trigger or the indicator associated/specific to one or more candidate report quantities (or a separate/different sub-set of the candidate report quantities) according to those specified or defined herein in the present disclosure. In particular, the association(s)/mapping(s) between each of the bits/levels/states of the PN message/trigger or the indicator(s) and the candidate RQs could be determined or identified according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. When/if the PN message/trigger or the one-bit/multi-bit indicator or the multi-level indicator or the multi-state indicator is set to a particular bit/level/state value, the UE could indicate or inform or provide to the network that the one or more candidate report quantities associated/specific to the bit/level/state value of the PN message/trigger or the one-bit/multi-bit indicator or the multi-level indicator or the multi-state indicator could be in/as the content(s) of the UEI report(s).
   For example, the PN message/trigger could be or could correspond to/comprise a one-bit indicator (i.e., L=1). When/if the one-bit indicator is set to ‘0’ (or ‘1’), the UEI report content(s) could comprise a full-set of the candidate report quantities, e.g., {RQ-1, RQ-2, . . . , RQ-62}, according to those defined/specified herein in the present disclosure; and/or when/if the one-bit indicator is set to ‘1’ (or ‘0’), the UEI report content(s) could comprise a sub-set of the candidate report quantities, e.g., {RQ-39, . . . , RQ-54}, according to those defined/specified herein in the present disclosure.
   For another example, the PN message/trigger could be or could correspond to/comprise a one-bit indicator (i.e., L=1). When/if the one-bit indicator is set to ‘0’ (or ‘1’), the UEI report content(s) could comprise a first sub-set of the candidate report quantities, e.g., {RQ-31, . . . , RQ-38}, according to those defined/specified herein in the present disclosure; and/or when/if the one-bit indicator is set to ‘1’ (or ‘0’), the UEI report content(s) could comprise a second sub-set of the candidate report quantities, e.g., {RQ-39, . . . , RQ-54}, according to those defined/specified herein in the present disclosure. The UE could determine or identify the first and/or the second subset(s) of the candidate report quantities according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   For another example, the PN message/trigger could be or could correspond to/comprise a two-bit indicator (i.e., L=2). When/if the two-bit indicator is set to ‘00’ (or ‘01’ or ‘10’ or ‘11’), the UEI report content(s) could comprise a first sub-set of the candidate report quantities, e.g., {RQ-1, . . . , RQ-30}, according to those defined/specified herein in the present disclosure; when/if the two-bit indicator is set to ‘01’ (or ‘00’ or ‘10’ or ‘11’), the UEI report content(s) could comprise a second sub-set of the candidate report quantities, e.g., {RQ-31, . . . , RQ-38}, according to those defined/specified herein in the present disclosure; when/if the two-bit indicator is set to ‘10’ (or ‘00’ or ‘01’ or ‘11’), the UEI report content(s) could comprise a third sub-set of the candidate report quantities, e.g., {RQ-39, . . . , RQ-54}, according to those defined/specified herein in the present disclosure; and/or when/if the two-bit indicator is set to ‘11’ (or ‘00’ or ‘01’ or ‘10’), the UEI report content(s) could comprise a fourth sub-set of the candidate report quantities, e.g., {RQ-55, . . . , RQ-62}, according to those defined/specified herein in the present disclosure. The UE could determine or identify the first and/or the second and/or the third and/or the fourth subset(s) of the candidate report quantities according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   For another example, the PN message/trigger could be or could correspond to/comprise a multi-bit indicator (i.e., L≥1) having 2^{L} states with each state of the multi-bit indicator corresponding/associated to one or more candidate RQs, e.g., belonging to {RQ-1, . . . , RQ-62}, following those specified or defined herein in the present disclosure. When/if the multi-bit indicator is set to a particular state, the UEI report content(s) could comprise the one or more candidate RQs associated/specific to the state of the multi-bit indicator. The UE could determine or identify the association(s)/mapping(s) between the states of the multi-bit indicator and the candidate RQs according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

Optionally, the PN message/trigger could provide, indicate, contain, include or comprise one or more (R≥1) or more than one (R≥1) the one-bit/multi-bit indicators or multi-level indicators or multi-state indicators as defined/specified herein in the present disclosure to indicate, inform or provide to the network which one or more of the candidate report quantities, e.g., {RQ-1, RQ-2, . . . , RQ-62}, as specified or defined herein in the present disclosure (or a full-set, e.g., {RQ-1, RQ-2, . . . , RQ-6222}, or one or more sub-sets, e.g., a sub-set {RQ-39, . . . , RQ-54}, of the candidate report quantities as specified or defined herein in the present disclosure) could be in/of the UEI report(s)/report content(s)—e.g., configured/provided/indicated by the network (e.g., via RRC and/or MAC CE and/or DCI) subject to a UE's capability or capability signaling. Here, the value(s) of L and/or R could be determined or identified according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
In another example, the PN message/trigger could be or could correspond to/comprise a bitmap, e.g., of length L (L≥1), with each entry/bit position of the PN message/trigger or the bitmap associated/specific to one or more candidate report quantities (or a separate/different sub-set of the candidate report quantities) according to those specified or defined herein in the present disclosure. In particular, the association(s)/mapping(s) between each of entries/bit positions of the PN message/trigger or the bitmap and the candidate RQs could be determined or identified according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. When/if an entry/bit position of the PN message/trigger or the bitmap is set to ‘1’ (or ‘0’), the UE could indicate or inform or provide to the network that the one or more candidate report quantities associated/specific to the entry/bit position of the PN message/trigger or the bitmap could be in/as the content(s) of the UEI report(s).
   For example, the PN message/trigger could be or could correspond to/comprise a bitmap of length 2 (i.e., L=2). When/if the first entry/bit position of the bitmap is set to ‘1’ (or ‘0’), the UEI report content(s) could comprise a full-set of the candidate report quantities, e.g., {RQ-1, RQ-2, . . . , RQ-62}, according to those defined/specified herein in the present disclosure; and/or when/if the second entry/bit position of the bitmap is set to ‘1’ (or ‘0’), the UEI report content(s) could comprise a sub-set of the candidate report quantities, e.g., {RQ-39, . . . , RQ-54}, according to those defined/specified herein in the present disclosure.
   For another example, the PN message/trigger could be or could correspond to/comprise a bitmap of length 2 (i.e., L=2). When/if the first entry/bit position of the bitmap is set to ‘1’ (or ‘0’), the UEI report content(s) could comprise a first sub-set of the candidate report quantities, e.g., {RQ-31, . . . , RQ-38}, according to those defined/specified herein in the present disclosure; and/or when/if the second entry/bit position of the bitmap is set to ‘1’ (or ‘0’), the UEI report content(s) could comprise a second sub-set of the candidate report quantities, e.g., {RQ-39, . . . , RQ-54}, according to those defined/specified herein in the present disclosure. The UE could determine or identify the first and/or the second subset(s) of the candidate report quantities according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   For another example, the PN message/trigger could be or could correspond to/comprise a bitmap of length 4 (i.e., L=4). When/if the first entry/bit position of the bitmap is set to ‘1’ (or ‘0’), the UEI report content(s) could comprise a first sub-set of the candidate report quantities, e.g., {RQ-1, . . . , RQ-30}, according to those defined/specified herein in the present disclosure; when/if the second entry/bit position of the bitmap is set to ‘1’ (or ‘0’), the UEI report content(s) could comprise a second sub-set of the candidate report quantities, e.g., {RQ-31, . . . , RQ-38}, according to those defined/specified herein in the present disclosure; when/if the third entry/bit position of the bitmap is set to ‘1’ (or ‘0’), the UEI report content(s) could comprise a third sub-set of the candidate report quantities, e.g., {RQ-39, . . . , RQ-54}, according to those defined/specified herein in the present disclosure; and/or when/if the fourth entry/bit position of the bitmap is set to ‘1’ (or ‘0’), the UEI report content(s) could comprise a fourth sub-set of the candidate report quantities, e.g., {RQ-55, . . . , RQ-62}, according to those defined/specified herein in the present disclosure. The UE could determine or identify the first and/or the second and/or the third and/or the fourth subset(s) of the candidate report quantities according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   For another example, the PN message/trigger could be or could correspond to/comprise a bitmap of length L with L≥1; each entry/bit position of the bitmap could correspond to or could be associated to one or more candidate RQs, e.g., belonging to {RQ-1, . . . , RQ-62}, following those specified or defined herein in the present disclosure. When/if an entry/bit position of the bitmap is set to ‘1’ (or ‘0’), the UEI report content(s) could comprise the one or more candidate RQs associated/specific to the entry/bit position of the bitmap. The UE could determine or identify the association(s)/mapping(s) between the entries/bit positions of the bitmap and the candidate RQs according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

Optionally, the PN message/trigger could provide, indicate, contain, include or comprise one or more (R≥1) or more than one (R≥1) the bitmaps as defined/specified herein in the present disclosure to indicate, inform or provide to the network which one or more of the candidate report quantities, e.g., {RQ-1, RQ-2, . . . RQ-62}, as specified or defined herein in the present disclosure (or a full-set, e.g., {RQ-1, RQ-2, . . . , RQ-62}, or one or more sub-sets, e.g., a subset {RQ-39, . . . , RQ-54}, of the candidate report quantities as specified or defined herein in the present disclosure) could be in/of the UEI report(s)/report content(s)—e.g., configured/provided/indicated by the network (e.g., via RRC and/or MAC CE and/or DCI) subject to a UE's capability or capability signaling. Here, the value(s) of L and/or R could be determined or identified according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
In another example, the UE could be provided/configured/indicated by the network, e.g., via higher layer RRC signaling(s)/parameter(s) and/or MAC CE command(s) and/or dynamic DCI based L1 signaling(s), one or more (e.g., L≥1) PN configurations (e.g., each denoted/provided by a higher layer RRC configuration/parameter PN-Config) for transmitting PN message(s)/trigger(s) and/or the corresponding content(s)/RQ(s). For this case/design example, each of the PN configurations (e.g., the higher layer configuration/parameter PN-Config) could provide one or more of:
   Resource allocation(s)—e.g., of UL channel(s)/signal(s) including PUCCH, PUSCH, PRACH and/or etc.—for transmitting PN message(s)/trigger(s) and/or the corresponding content(s)/RQ(s). For example, when/if PUCCH is used (or configured to be used or indicated to be used) for transmitting/sending the PN message(s)/trigger(s) and/or the corresponding content(s)/RQ(s), the UE (e.g., the UE 116) could be provided/indicated/provided by the network (e.g., the network 130), e.g., via higher layer RRC signaling(s)/parameter(s) and/or MAC CE command(s) and/or dynamic DCI based L1 signaling(s), a list of PUCCH resources to use for reporting the UEI report(s) on PUCCH; for this case/design example, the list of PUCCH resources to use for the UEI reporting could be provided by pucch-UEI-ResourceList in, e.g., PN-Config. For another example, when/if PUSCH is used (or configured to be used or indicated to be used) for transmitting/sending the PN message(s)/trigger(s) and/or the corresponding content(s)/RQ(s), the UE could be provided/indicated/provided by the network, e.g., via higher layer RRC signaling(s)/parameter(s) and/or MAC CE command(s) and/or dynamic DCI based L1 signaling(s), a list of PUSCH resources to use for reporting the UEI report(s) on PUSCH; for this case/design example, the list of PUSCH resources to use for the UEI reporting could be provided by pusch-UEI-ResourceList, ConfiguredGrantConfig, ueiConfiguredGrantConfig and/or etc. in, e.g., PN-Config.
   Time and/or frequency domain behaviors for transmitting PN message(s)/trigger(s) and/or the corresponding content(s)/RQ(s) including “periodic”, “semi-persistent”, “aperiodic” and/or etc. for the corresponding UL channels/signals or signaling mediums including PUCCH, PUSCH and/or etc.
   Measurement RS resources (including SSB resource(s), CSI-RS resource(s) and/or etc.) used for UEI measurements; for instance, the UE could be provided/indicated/provided by the network, e.g., via higher layer RRC signaling(s)/parameter(s) and/or MAC CE command(s) and/or dynamic DCI based L1 signaling(s), a list of channel measurement RS resources to use for the UEI measurements; for this case/design example, the list of channel measurement RS resources and their associated/corresponding resource setting(s) could be provided by UEI-CSI-ResourceConfig in, e.g., PN-Config.
   CSI report setting(s)/configuration(s) used for UEI reporting; for instance, the UE could be provided/indicated/provided by the network, e.g., via higher layer RRC signaling(s)/parameter(s) and/or MAC CE command(s) and/or dynamic DCI based L1 signaling(s), one or more CSI report settings/configurations to use for the UEI reporting; for this case/design example, each of the one or more CSI report settings/configurations could be provided by UEI-CSI-ReportConfig in, e.g., PN-Config.

Each of the L (L≥1) PN configurations could be associated/specific to one or more candidate report quantities (or a separate/different sub-set of the candidate report quantities) according to those specified or defined herein in the present disclosure. In particular, the association(s)/mapping(s) between each of the PN configurations and the candidate RQs could be determined or identified according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. When/if the PN message/trigger of a specific PN configuration is transmitted/sent, the UE could indicate or inform or provide to the network that the one or more candidate report quantities associated/specific to the PN configuration (and therefore, the transmitted/sent PN message/trigger) could be in/as the content(s) of the UEI report(s).
For example, the UE could be provided/configured/indicated by the network, e.g., via higher layer RRC signaling(s)/parameter(s) and/or MAC CE command(s) and/or dynamic DCI based L1 signaling(s), a first and a second PN configurations (e.g., each denoted/provided by a higher layer RRC configuration/parameter PN-Config) for transmitting the PN message(s)/trigger(s) and/or the corresponding content(s)/RQ(s) (i.e., L=2). When/if a PN message/trigger of the first PN configuration is transmitted/sent, the UEI report content(s) could comprise a full-set of the candidate report quantities, e.g., {RQ-1, RQ-2, . . . , RQ-62}, according to those defined/specified herein in the present disclosure; and/or when/if the a PN message/trigger of the second PN configuration is transmitted/sent, the UEI report content(s) could comprise a sub-set of the candidate report quantities, e.g., {RQ-39, . . . , RQ-54}, according to those defined/specified herein in the present disclosure.
For another example, the UE could be provided/configured/indicated by the network, e.g., via higher layer RRC signaling(s)/parameter(s) and/or MAC CE command(s) and/or dynamic DCI based L1 signaling(s), a first and a second PN configurations (e.g., each denoted/provided by a higher layer RRC configuration/parameter PN-Config) for transmitting the PN message(s)/trigger(s) and/or the corresponding content(s)/RQ(s) (i.e., L=2). When/if a PN message/trigger of the first PN configuration is transmitted/sent, the UEI report content(s) could comprise a first sub-set of the candidate report quantities, e.g., {RQ-31, . . . RQ-38}, according to those defined/specified herein in the present disclosure; and/or when/if a PN message/trigger of the second PN configuration is transmitted/sent, the UEI report content(s) could comprise a second sub-set of the candidate report quantities, e.g., {RQ-39, . . . , RQ-54}, according to those defined/specified herein in the present disclosure. The UE could determine or identify the first and/or the second subset(s) of the candidate report quantities according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
For another example, the UE could be provided/configured/indicated by the network, e.g., via higher layer RRC signaling(s)/parameter(s) and/or MAC CE command(s) and/or dynamic DCI based L1 signaling(s), a first, a second, a third, and a fourth PN configurations (e.g., each denoted/provided by a higher layer RRC configuration/parameter PN-Config) for transmitting the PN message(s)/trigger(s) and/or the corresponding content(s)/RQ(s) (i.e., L=4). When/if a PN message/trigger of the first PN configuration is transmitted/sent, the UEI report content(s) could comprise a first sub-set of the candidate report quantities, e.g., {RQ-1, . . . RQ-30}, according to those defined/specified herein in the present disclosure; when/if a PN message/trigger of the second PN configuration is transmitted/sent, the UEI report content(s) could comprise a second sub-set of the candidate report quantities, e.g., {RQ-31, . . . , RQ-38}, according to those defined/specified herein in the present disclosure; when/if a PN message/trigger of the third PN configuration is transmitted/sent, the UEI report content(s) could comprise a third sub-set of the candidate report quantities, e.g., {RQ-39, . . . , RQ-54}, according to those defined/specified herein in the present disclosure; and/or when/if a PN message/trigger of the fourth PN configuration is transmitted/sent, the UEI report content(s) could comprise a fourth sub-set of the candidate report quantities, e.g., {RQ-55, . . . , RQ-62}, according to those defined/specified herein in the present disclosure. The UE could determine or identify the first and/or the second and/or the third and/or the fourth subset(s) of the candidate report quantities according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
For another example, the UE could be provided/configured/indicated by the network, e.g., via higher layer RRC signaling(s)/parameter(s) and/or MAC CE command(s) and/or dynamic DCI based L1 signaling(s), one or more (e.g., L≥1) PN configurations (e.g., each denoted/provided by a higher layer RRC configuration/parameter PN-Config) for transmitting PN message(s)/trigger(s) and/or the corresponding content(s)/RQ(s). When/if a PN message/trigger of a particular PN configuration is transmitted/sent, the UEI report content(s) could comprise the one or more candidate RQs associated/specific to the PN configuration (and therefore, the transmitted/sent PN message/trigger). The UE could determine or identify the association(s)/mapping(s) between the PN configurations and the candidate RQs according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

Optionally, the UE could transmit/send one or more or more than one PN messages/triggers, e.g., in one or more or in a single or separate (UEI) report(s), of one or more (R≥1) or more than one (R≥1) the PN configurations as defined/specified herein in the present disclosure to indicate, inform or provide to the network which one or more of the candidate report quantities, e.g., {RQ-1, RQ-2, . . . , RQ-62}, as specified or defined herein in the present disclosure (or a full-set, e.g., {RQ-1, RQ-2, . . . , RQ-62}, or one or more sub-sets, e.g., a subset {RQ-39, . . . , RQ-54}, of the candidate report quantities as specified or defined herein in the present disclosure) could be in/of the UEI report(s)/report content(s)—e.g., configured/provided/indicated by the network (e.g., via RRC and/or MAC CE and/or DCI) subject to a UE's capability or capability signaling. Here, the value(s) of L and/or R could be determined or identified according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
In another example, the PN message/trigger could be or could correspond to/comprise one or more, e.g., L (L≥1), indexes, e.g., belonging to {0, 1, . . . , L−1} or {1, 2, . . . , L}, each associated/specific to one or more candidate report quantities (or a separate/different sub-set of the candidate report quantities) or pointing/corresponding to one or more entries (and therefore, the corresponding candidate report quantities) of a list/set/pool of candidate report quantities according to those specified or defined herein in the present disclosure. When/if the PN message/trigger indicates, provides or comprises one or more indexes (e.g., an index l∈{0, 1, . . . , L−1} or {1, 2, . . . , L}), the UE could indicate or inform or provide to the network that the one or more entries, and therefore, the corresponding one or more candidate report quantities (e.g., the l-th candidate report quantity or the l-th sub-set of the candidate report quantities) in the lists/set/pool of candidate report quantities associated/specific to the one or more indexes could be in/as the content(s) of the UEI report(s). The UE could determine or identify the L≥1 sub-set(s) of the candidate report quantities (e.g., in/from the list/set/pool of candidate report quantities) and/or their association(s)/mapping(s) to the index(es) indicated/comprised by/in the PN message(s)/trigger(s) according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   For example, when/if the PN message/trigger indicates, provides or comprises an index of value 0 (or 1), the UEI report content(s) could comprise a full-set of the candidate report quantities, e.g., {RQ-1, RQ-2, . . . RQ-62}, according to those defined/specified herein in the present disclosure; and/or when/if the PN message/trigger indicates, provides or comprises an index of value 1 (or 2), the UEI report content(s) could comprise a sub-set of the candidate report quantities, e.g., {RQ-39, . . . , RQ-54}, according to those defined/specified herein in the present disclosure.
   For another example, when/if the PN message/trigger indicates, provides or comprises an index of value 0 (or 1), the UEI report content(s) could comprise the candidate report quantity(s) or the sub-set of the candidate report quantities, e.g., {RQ-31, . . . , RQ-38}, corresponding to the first entry(s) of/in a list/set/pool of candidate report quantities according to those defined/specified herein in the present disclosure; and/or when/if the PN message/trigger indicates, provides or comprises an index of value 1 (or 2), the UEI report content(s) could comprise the candidate report quantity(s) or the sub-set of the candidate report quantities, e.g., {RQ-39, . . . , RQ-54}, corresponding to the second entry(s) of/in the list/set/pool of candidate report quantities according to those defined/specified herein in the present disclosure. The UE could determine or identify the first and/or the second entry(s) of/in the list/set/pool of candidate report quantities (and therefore, the corresponding candidate report quantity(s)/subset(s) of the candidate report quantities) according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   For another example, when/if the PN message/trigger indicates, provides or comprises an index of value 0 (or 1), the UEI report content(s) could comprise the candidate report quantity(s) or the sub-set of the candidate report quantities, e.g., {RQ-1, . . . , RQ-30}, corresponding to the first entry(s) of/in a list/set/pool of candidate report quantities according to those defined/specified herein in the present disclosure; when/if the PN message/trigger indicates, provides or comprises an index of value 1 (or 2), the UEI report content(s) could comprise the candidate report quantity(s) or the sub-set of the candidate report quantities, e.g., {RQ-31, . . . , RQ-38}, corresponding to the second entry(s) of/in the list/set/pool of candidate report quantities according to those defined/specified herein in the present disclosure; when/if the PN message/trigger indicates, provides or comprises an index of value 2 (or 3), the UEI report content(s) could comprise the candidate report quantity(s) or the sub-set of the candidate report quantities, e.g., {RQ-39, . . . , RQ-54}, corresponding to the third entry(s) of/in the list/set/pool of candidate report quantities according to those defined/specified herein in the present disclosure; and/or when/if the PN message/trigger indicates, provides or comprises an index of value 3 (or 4), the UEI report content(s) could comprise the candidate report quantity(s) or the sub-set of the candidate report quantities, e.g., {RQ-55, . . . , RQ-62}, corresponding to the fourth entry(s) of/in the list/set/pool of candidate report quantities according to those defined/specified herein in the present disclosure. The UE could determine or identify the first and/or the second and/or the third and/or the fourth entry(s) of/in the list/set/pool of candidate report quantities (and therefore, the corresponding candidate report quantity(s)/subset(s) of the candidate report quantities) according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   For another example, when/if the PN message/trigger indicates, provides or comprises an index of value 1, wherein l∈{, 1, . . . , L−1} or {1, 2, . . . , L}), the UEI report content(s) could comprise the candidate report quantity(s) or the sub-set of the candidate report quantities, e.g., {RQ-1, . . . , RQ-30}, corresponding to the l-th entry(s) of/in a list/set/pool of candidate report quantities according to those defined/specified herein in the present disclosure. The UE could determine or identify the association(s)/mapping(s) between the index(es) indicated/comprised by/in the PN message(s)/trigger(s) and the entry(s) of/in the list/set/pool of candidate RQs (and therefore, the corresponding RQs or sub-set(s) of RQs) according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

Optionally, the UE could transmit/send one or more (R≥1) or more than one (R≥1) PN messages/triggers, e.g., in one or more or in a single or separate (UEI) report(s), as defined/specified herein in the present disclosure to indicate, inform or provide to the network which one or more of the candidate report quantities, e.g., {RQ-1, RQ-2, . . . , RQ-62}, as specified or defined herein in the present disclosure (or a full-set, e.g., {RQ-1, RQ-2, . . . , RQ-62}, or one or more sub-sets, e.g., a subset {RQ-39, . . . , RQ-54}, of the candidate report quantities as specified or defined herein in the present disclosure) could be in/of the UEI report(s)/report content(s)—e.g., configured/provided/indicated by the network (e.g., via RRC and/or MAC CE and/or DCI) subject to a UE's capability or capability signaling. Here, the value(s) of L and/or R could be determined or identified according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

The (set/list/pool of) candidate report quantities as defined/specified herein in the present disclosure could be determined or identified according to: (1) fixed value(s)/rule(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. For instance, the UE could be configured or provided by the network, e.g., via/in a higher layer RRC configuration/parameter CSI-ReportConfig, one or more (or a set/list/pool of) candidate report quantities (e.g., denoted by candidateReportQuantityList), wherein the one or more (or the set/list/pool of) configured candidate report quantities could be a full-set or a sub-set of the report quantities, e.g., {RQ-1, RQ-2, . . . , RQ-62}, specified/defined herein in the present disclosure for the UEI reporting.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

In one embodiment (embodiment-I), the UEI report(s) may only comprise or include or contain or provide the content(s)—e.g., of (report-)type (B) as specified herein in the present disclosure; i.e., the UEI report(s) may not comprise, include, contain or provide the PN message/trigger. For this case/setting,
In one example, the UE could be provided, configured or indicated by the network, e.g., via higher layer RRC signaling(s)/parameter(s) and/or MAC CE command(s) and/or dynamic DCI based L1 signaling(s)—e.g., based on a corresponding UE's capability or capability signaling, one or more UL channels/resources for sending the UEI report(s). For this design example, the one or more UL channels/signals could be configured, provided, activated or indicated in a periodic manner (e.g., with a configured periodicity) or semi-persistent manner (e.g., with a configured periodicity and activated by a DL signaling, e.g., a DCI). Once the UE has decided, determined or identified to send the UEI report(s), the UE could use the one or more UL channels/signals—e.g., that are available the latest/nearest in time—as described/specified herein in the present disclosure to send the UEI report(s). For example, the one or more UL channels/signals here could correspond to periodic/semi-persistent PUCCH resource(s)/PUCCH resource group(s)/PUCCH resource set(s) configured and/or activated for the UEI reporting. For another example, the one or more UL channels/signals could correspond to Type-1 CG PUSCH(s)—provided by ConfiguredGrantConfig with a configured periodicity and/or Type-2 CG PUSCH(s)—provided by ConfiguredGrantConfig with a configured periodicity and activated by a DL signaling, e.g., a DCI, for the UEI reporting. Furthermore, the network could keep monitoring the one or more UL channels/signals configured, provided, activated and/or indicated for the UEI reporting to detect/decode the UEI report(s), if sent over/on the one or more UL channels/signals as specified/described herein in the present disclosure.
In another example, the UE could use dynamic grant (DG) PUSCH(s) and/or Type-1/2 CG PUSCH(s) to send UL data. For this case design, once the UE has decided, determined or identified to send the UEI report(s), the UE could piggyback the UEI report(s) on the DG PUSCH(s) and/or Type-1/2 CG PUSCH(s) for the UL data transmission(s). For this case, the network could keep monitoring the DG PUSCH(s) and/or Type-1/2 CG PUSCH(s) for the UL data transmission(s) to detect or decode the UEI report(s), if piggybacked on/over the DG PUSCH(s) and/or Type-1/2 CG PUSCH(s) as specified/described herein in the present disclosure.
In another example, the UE could send the UEI report(s) in part of or as a power headroom report (PHR), which could be piggybacked on DG PUSCH(s) and/or Type-1/2 CG PUSCH(s) for UL data transmission(s). For this design example, the UE could indicate to the network, e.g., via one or more indicators, whether a PHR corresponds to or comprises or contains or provides or includes UEI report(s). In addition, the network could keep monitoring the DG PUSCH(s) and/or Type-1/2 CG PUSCH(s) for the UL data transmission(s) to detect or decode the UEI report(s), if sent in part of or as a PHR piggybacked on/over the DG PUSCH(s) and/or Type-1/2 CG PUSCH(s) as specified/described herein in the present disclosure. For this case, the PHR could be triggered when/if the UE decides, determines or identifies to send the UEI report(s) according to those specified herein in the present disclosure.

In one embodiment (embodiment-II), the UEI report(s) could contain, provide, include or comprise at least a pre-notification (PN) message/trigger—e.g., of (report-)type (A) or (report-)type (C) as specified herein in the present disclosure, and/or the (corresponding) content—e.g., of (report-)type (B) or (report-)type (C) as specified herein in the present disclosure. For this case/setting,
the UE could send the PN message/trigger, e.g., via one or more PUCCH resources, wherein each of the one or more PUCCH resources (e.g., of format 0/1/2/3/4) could be from one or more PUCCH resource sets, e.g., configured/provided for the UEI reporting(s)—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting.
after the UE has transmitted the PN message/trigger, the UE could expect to receive from the network (e.g., the network 130) a DCI to trigger aperiodic (AP) CSI-RS measurement and reporting, and/or activate semi-persistent (SP) CSI-RS measurement and reporting, within a time window starting from the first or last symbol/slot/etc. of the transmission of the PN message/trigger; otherwise, i.e., when/if the UE does not receive from the network a DCI to trigger aperiodic (AP) CSI-RS measurement and reporting, and/or activate semi-persistent (SP) CSI-RS measurement and reporting, within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, value(s) of the time window and/or the maximum number of re-transmissions of the PN message/trigger—or the corresponding UEI report(s). For instance, if the DCI is to trigger the AP CSI-RS measurement and reporting, the DCI could be of DCI format 0_1 with the CSI request field indicated/provided therein set to valid value(s)/index(es), e.g., pointing to the index(es) of the entries in CSI-AperiodicTriggerStateList or the index(es) of the codepoint(s) in the aperiodic CSI trigger state subselection MAC CE. Furthermore, the reception of the DCI trigger or activation for the AP or SP CSI-RS measurement and reporting could be an ACK for the transmission of the PN message/trigger.
the UE could measure one or more CSI-RSs according to the CSI-RS resource(s) and/or CSI resource setting(s) triggered, activated or associated to the DCI that triggers or activates the AP or SP CSI-RS measurement and reporting; for instance, for AP CSI-RS measurement and reporting, the UE could measure one or more CSI-RSs according to the CSI-RS resource(s) and/or CSI resource setting(s) associated to/with the trigger state provided/indicated by the CSI request field in the corresponding DCI format 0_1.
once the UE has determined, decided or identified to send the UEI report(s), the UE could send the UEI report(s) over/on the UL channels/resources—e.g., SP-PUCCH(s), e.g., in form/terms of PUCCH resource(s), slot(s)/slot offset(s) for transmission(s), and/or etc., SP-PUSCH(s), e.g., in form/terms of PUSCH resource(s), slot(s)/slot offset(s) for transmission(s), p0/alpha for the PUSCH(s) and/or etc., and/or AP resource(s) in form/terms of slot(s)/slot offset(s) for transmission(s)—according to the CSI reporting setting(s) triggered, activated or associated to the DCI that triggers or activates the AP or SP CSI-RS measurement and reporting; for instance, for AP CSI-RS measurement and reporting, the UE (e.g., the UE 116) could send the UEI report(s) over/on the UL channels/signals as described/herein in the present disclosure according to the CSI reporting setting(s) associated to/with the trigger state provided/indicated by the CSI request field in the corresponding DCI format 0_1.

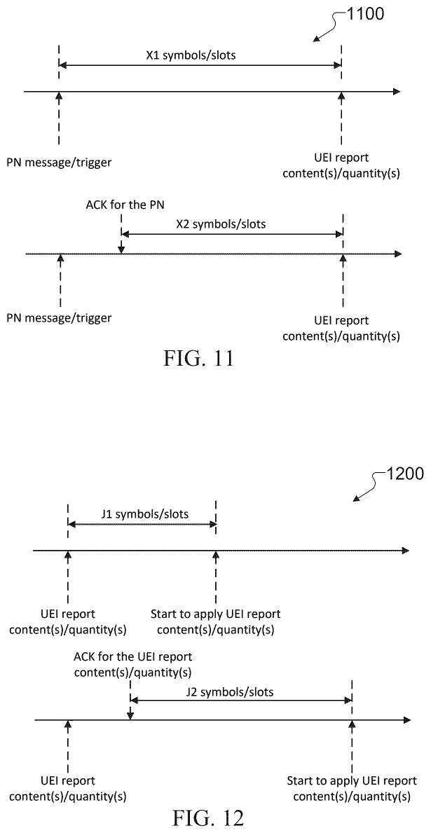

FIG. 11 illustrates a diagram of example timing assumptions 1100 for UE reporting according to embodiments of the present disclosure. For example, timing assumptions 1100 can be adhered to by any of the UEs 111-116 of FIG. 1, such as the UE 111. This example is for illustration only and other embodiments can be used without departing from the scope of the present disclosure.

In one embodiment (embodiment-III), the UEI report(s) could contain, provide, include or comprise at least a pre-notification (PN) message/trigger—e.g., of (report-)type (A) or (report-)type (C) as specified herein in the present disclosure, and/or the (corresponding) content—e.g., of (report-)type (B) or (report-)type (C) as specified herein in the present disclosure. For this case/setting,
the UE could send the PN message/trigger, e.g., via one or more PUCCH resources, wherein each of the one or more PUCCH resources (e.g., of format 0/1/2/3/4) could be from one or more PUCCH resource sets, e.g., configured/provided for the UEI reporting(s)—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting.
after the UE has transmitted the PN message/trigger, the UE could expect to receive from the network a DCI to trigger aperiodic (AP) CSI-RS measurement—or to trigger transmission(s) of CSI-RS(s) on the corresponding CSI-RS resource(s) for measurement, and/or activate semi-persistent (SP) CSI-RS measurement—or to activate transmission(s) of CSI-RS(s) on the corresponding CSI-RS resource(s) for measurement, within a time window starting from the first or last symbol/slot/etc. of the transmission of the PN message/trigger; otherwise, i.e., when/if the UE does not receive from the network a DCI to trigger aperiodic (AP) CSI-RS measurement, and/or activate semi-persistent (SP) CSI-RS measurement, within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, value(s) of the time window and/or the maximum number of re-transmissions of the PN message/trigger—or the corresponding UEI report(s). For instance, if the DCI is to trigger the AP CSI-RS measurement as defined/specified herein in the present disclosure, the DCI could be of DCI format 0_1 with the CSI request field indicated/provided therein set to valid value(s)/index(es), e.g., pointing to the index(es) of the entries in CSI-AperiodicTriggerStateList or the index(es) of the codepoint(s) in the aperiodic CSI trigger state subselection MAC CE. Furthermore, the reception of the DCI trigger or activation for the AP or SP CSI-RS measurement as specified or defined herein in the present disclosure could be an ACK for the transmission of the PN message/trigger.
the UE could measure one or more CSI-RSs according to the CSI-RS resource(s) and/or CSI resource setting(s) triggered, activated or associated to the DCI that triggers or activates the AP or SP CSI-RS measurement as specified/defined herein in the present disclosure; for instance, for AP CSI-RS measurement—i.e., the DCI is to trigger transmission(s) of CSI-RS(s) on the corresponding CSI-RS resource(s) for measurement, the UE could measure one or more CSI-RSs according to the CSI-RS resource(s) and/or CSI resource setting(s) associated to/with the trigger state provided/indicated by the CSI request field in the corresponding DCI format 0_1.
once the UE has determined, decided or identified to send the UEI report(s), the UE could send the UEI report(s) over/on one or more UL channels/resources determined according to:
   Alt-1: the UE could be provided, configured or indicated by the network, e.g., via higher layer RRC signaling(s)/parameter(s) and/or MAC CE command(s) and/or dynamic DCI based L1 signaling(s)—e.g., based on a corresponding UE's capability or capability signaling, one or more UL channels/resources for sending the UEI report(s). For this design example, the one or more UL channels/signals could be configured, provided, activated or indicated in a periodic manner (e.g., with a configured periodicity) or semi-persistent manner (e.g., with a configured periodicity and activated by a DL signaling, e.g., a DCI, or with a configured periodicity and activated by the PN message/trigger). Once the UE has decided, determined or identified to send the UEI report(s), the UE could use the one or more UL channels/signals—e.g., that are available the latest/nearest in time—as described/specified herein in the present disclosure to send the UEI report(s). For example, the one or more UL channels/signals here could correspond to periodic/semi-persistent PUCCH resource(s)/PUCCH resource group(s)/PUCCH resource set(s) configured and/or activated for the UEI reporting. For another example, the one or more UL channels/signals could correspond to Type-1 CG PUSCH(s)—provided by ConfiguredGrantConfig with a configured periodicity and/or Type-2 CG PUSCH(s)—provided by ConfiguredGrantConfig with a configured periodicity and activated by a DL signaling, e.g., a DCI, for the UEI reporting. For these settings/design examples, the network could keep monitoring the one or more UL channels/signals configured, provided, activated and/or indicated for the UEI reporting to detect/decode the UEI report(s), if sent over/on the one or more UL channels/signals as specified/described herein in the present disclosure. For another example, the UE could be first configured or provided by the network one or more PUCCH resources/PUCCH resource groups/PUCCH resource sets for the UEI reporting—e.g., with a configured periodicity; when/if the UE has sent to the network the PN message/trigger, the UE could start using/applying the one or more PUCCH resources/PUCCH resource groups/PUCCH resource sets configured for the UEI reporting to send the UEI report(s), X1 symbols/slots/etc. after the first or last symbol/slot/etc. of the transmission of the PN message/trigger (denoted by non-feedback based UEI reporting, e.g., for the PN message/trigger), and/or X2 symbols/slots/etc. after the first or last symbol/slot/etc. of an ACK reception for the transmission of the PN message/trigger (denoted by feedback based UEI reporting, e.g., for the PN message/trigger). For another example, the UE could be first configured or provided by the network one or more PUSCH resources for the UEI reporting—e.g., CG PUSCH(s) provided by ConfiguredGrantConfig with a configured periodicity; when/if the UE has sent to the network the PN message/trigger, the UE could start using/applying the one or more PUSCH resources configured for the UEI reporting—e.g., provided by ConfiguredGrantConfig with a configured periodicity and indicator(s) indicating that the CG PUSCH(s) is for sending the UEI report(s)—to send the UEI report(s), Y1 symbols/slots/etc. after the first or last symbol/slot/etc. of the transmission of the PN message/trigger (denoted by non-feedback based UEI reporting, e.g., for the PN message/trigger), and/or Y2 symbols/slots/etc. after the first or last symbol/slot/etc. of an ACK reception for the transmission of the PN message/trigger (denoted by feedback based UEI reporting, e.g., for the PN message/trigger). That is, for these design examples, the PN message/trigger is to activate the network configured (e.g., with a periodicity) one or more UL channels/resources for the UEI reporting to transmit the UEI report(s), or equivalently, the PN message/trigger is to indicate to the network that the one or more UL channels/resources (periodically) configured for the UEI reporting are activated to transmit the UEI report(s). Furthermore, when/if the UE is expected to receive an ACK (or negative acknowledgement (NACK)) for the PN message/trigger—i.e., the feedback based UEI reporting (e.g., for the PN message/trigger), (1) the UE could expect to receive the ACK (or NACK) for the PN message/trigger within a time window starting from the first or last symbol/slot/etc. of the transmission of the PN message/trigger, wherein the ACK (or NACK) could be in various forms and/or received in/via/by MAC CE/DCI; (2) otherwise, i.e., when/if the UE does not receive from the network an ACK for the PN message/trigger (or receives from the network a NACK for the PN message/trigger), within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting, e.g., on/over the corresponding network configured (periodic) UL channels/resources, and/or Z symbols/slots/etc. after the first or last symbol/slot/etc. of the time window, the UE could send the UEI report(s) on/over the corresponding network configured (periodic) UL channels/resources as specified or described herein in the present disclosure. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., value(s) of X1, X2, Y1, Y2, Z, the time window and/or the maximum number of re-transmissions of the PN message/trigger—or the corresponding UEI report(s); the value(s) of X1, X2, Y1, Y2, Z, the time window and/or the maximum number of re-transmissions of the PN message/trigger (or the corresponding UEI report(s)) that is provided/indicated/configured by the network could be selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. Optionally, the UE could autonomously determine or select value(s) of X1, X2, Y1, Y2, Z, the time window and/or the maximum number of re-transmissions of the PN message/trigger—or the corresponding UEI report(s), based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or inform or indicate to the network, e.g., via/by/in part of the PN message/trigger, their determined/selected value(s) of X1, X2, Y1, Y2, Z, the time window and/or the maximum number of re-transmissions of the PN message/trigger—or the corresponding UEI report(s); for instance, the PN message/trigger could comprise or correspond to a one-bit indicator or a multi-bit indicator or a one-level indicator or a multi-level indicator to indicate the value(s) of X1, X2, Y1, Y2, Z, the time window and/or the maximum number of re-transmissions of the PN message/trigger (or the corresponding UEI report(s)) selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. One conceptual example charactering the described design procedure is presented in FIG. 11.
   Alt-2: the UE could send the PN message/trigger in form of a scheduling request (SR) provided by or associated with a SR configuration; the UE could expect to receive an UL grant that dynamically schedules one or more PUSCH resources in response to the PN message/trigger (and therefore, the corresponding SR)—could also be referred to as or denoted by a feedback based UEI reporting, within a time window starting from the first or last symbol/slot/etc. of the transmission of the PN message/trigger, wherein the UL grant could be provided or indicated in a UL scheduling DCI (e.g., of DCI format(s) 0_0, 0_1, 0_2 and/or etc.); otherwise, i.e., when/if the UE does not receive from the network a UL grant in response to the PN message/trigger (and therefore, the corresponding SR), within a time window starting from the first or last symbol/slot/etc. of the transmission of the PN message/trigger, the UE could re-transmit or re-send the PN message/trigger (i.e., in form of the SR), and after a maximum number of re-transmissions of the PN message/trigger—or the corresponding UEI report(s), the UE could terminate or abandon the UEI reporting. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., value(s) of the time window and/or the maximum number of re-transmissions of the PN message/trigger—or the corresponding UEI report(s); the value(s) of the time window and/or the maximum number of re-transmissions of the PN message/trigger (or the corresponding UEI report(s)) that is provided/indicated/configured by the network could be selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. Optionally, the UE could autonomously determine or select value(s) of the time window and/or the maximum number of re-transmissions of the PN message/trigger—or the corresponding UEI report(s), based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or inform or indicate to the network, e.g., via/by/in part of the PN message/trigger, their determined/selected value(s) of the time window and/or the maximum number of re-transmissions of the PN message/trigger—or the corresponding UEI report(s); for instance, the PN message/trigger could comprise or correspond to a one-bit indicator or a multi-bit indicator or a one-level indicator or a multi-level indicator to indicate the value(s) of the time window and/or the maximum number of re-transmissions of the PN message/trigger (or the corresponding UEI report(s)) selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. Upon receiving the UL grant in response to the PN message/trigger, the UE could transmit the UEI report(s) on/over the dynamically granted or scheduled PUSCH resource(s), and/or the network could keep monitoring the dynamically granted or scheduled PUSCH resource(s) to detect/decode the UEI report(s).
   Alt-3: the UE could use dynamic grant (DG) PUSCH(s) and/or Type-1/2 CG PUSCH(s) to send UL data. For this case, X1 symbols/slots/etc. after the first or last symbol/slot/etc. of the transmission of the PN message/trigger (denoted by non-feedback based UEI reporting, e.g., for the PN message/trigger), and/or X2 symbols/slots/etc. after the first or last symbol/slot/etc. of an ACK reception for the transmission of the PN message/trigger (denoted by feedback based UEI reporting, e.g., for the PN message/trigger), the UE could piggyback the UEI report(s) on the DG PUSCH(s) and/or Type-1/2 CG PUSCH(s) for the UL data transmission(s). The network could keep monitoring the DG PUSCH(s) and/or Type-1/2 CG PUSCH(s) for the UL data transmission(s), e.g., according to the reception/detection of the PN message/trigger and/or value(s) of X1 and/or X2, to detect or decode the UEI report(s), if piggybacked on/over the DG PUSCH(s) and/or Type-1/2 CG PUSCH(s) as specified/described herein in the present disclosure. Furthermore, when/if the UE is expected to receive an ACK (or NACK) for the PN message/trigger—i.e., the feedback based UEI reporting (e.g., for the PN message/trigger), (1) the UE could expect to receive the ACK (or NACK) for the PN message/trigger within a time window starting from the first or last symbol/slot/etc. of the transmission of the PN message/trigger, wherein the ACK (or NACK) could be in various forms and/or received in/via/by MAC CE/DCI; (2) otherwise, i.e., when/if the UE does not receive from the network an ACK for the PN message/trigger (or receives from the network a NACK for the PN message/trigger), within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting, e.g., piggybacked on the DG PUSCH(s) and/or Type-1/2 CG PUSCH(s) for the UL data transmission(s), and/or Z symbols/slots/etc. after the first or last symbol/slot/etc. of the time window, the UE could piggyback the UEI report(s) on/over the DG PUSCH(s) and/or Type-1/2 CG PUSCH(s) for the UL data transmission(s) as specified or described herein in the present disclosure. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., value(s) of X1, X2, Z, the time window and/or the maximum number of re-transmissions of the PN message/trigger—or the corresponding UEI report(s); the value(s) of X1, X2, Y1, Y2, Z, the time window and/or the maximum number of re-transmissions of the PN message/trigger (or the corresponding UEI report(s)) that is provided/indicated/configured by the network could be selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. Optionally, the UE could autonomously determine or select value(s) of X1, X2, Y1, Y2, Z, the time window and/or the maximum number of re-transmissions of the PN message/trigger—or the corresponding UEI report(s), based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or inform or indicate to the network, e.g., via/by/in part of the PN message/trigger, their determined/selected value(s) of X1, X2, Y1, Y2, Z, the time window and/or the maximum number of re-transmissions of the PN message/trigger—or the corresponding UEI report(s); for instance, the PN message/trigger could comprise or correspond to a one-bit indicator or a multi-bit indicator or a one-level indicator or a multi-level indicator to indicate the value(s) of X1, X2, Y1, Y2, Z, the time window and/or the maximum number of re-transmissions of the PN message/trigger (or the corresponding UEI report(s)) selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. One conceptual example characterizing the described design procedure is provided in FIG. 7.
   Alt-4: the UE could be provided, configured or indicated by the network, e.g., via higher layer RRC signaling(s)/parameter(s) and/or MAC CE command(s) and/or dynamic DCI based L1 signaling(s)—e.g., based on a corresponding UE's capability or capability signaling, one or more UL channels/resources for sending the UEI report(s). For this design example, the one or more UL channels/signals could be configured, provided, activated or indicated in a periodic manner (e.g., with a configured periodicity) or semi-persistent manner (e.g., with a configured periodicity and activated by a DL signaling, e.g., a DCI, or with a configured periodicity and activated by the PN message/trigger). In one example, K1 symbols/slots/etc. after the first or last symbol/slot/etc. of the transmission of the PN message/trigger (denoted by non-feedback based UEI reporting, e.g., for the PN message/trigger), and/or K2 symbols/slots/etc. after the first or last symbol/slot/etc. of an ACK reception for the transmission of the PN message/trigger (denoted by feedback based UEI reporting, e.g., for the PN message/trigger), the UE could use the one or more UL channels/signals—e.g., that are available the latest/nearest in time—as described/specified herein in the present disclosure to send the UEI report(s). For example, the one or more UL channels/signals here could correspond to periodic/semi-persistent PUCCH resource(s)/PUCCH resource group(s)/PUCCH resource set(s) configured and/or activated for the UEI reporting. For another example, the one or more UL channels/signals could correspond to Type-1 CG PUSCH(s)—provided by ConfguredGrantConfig with a configured periodicity and/or Type-2 CG PUSCH(s)—provided by ConfguredGrantConfig with a configured periodicity and activated by a DL signaling, e.g., a DCI, for the UEI reporting. For these settings/design examples, the network (e.g., the network 130) could keep monitoring the one or more UL channels/signals configured, provided, activated and/or indicated for the UEI reporting, e.g., according to the reception/detection of the PN message/trigger and/or value(s) of K1 and/or K2, to detect/decode the UEI report(s), if sent over/on the one or more UL channels/signals as specified/described herein in the present disclosure. In another example, the UE could be first configured or provided by the network one or more PUCCH resources/PUCCH resource groups/PUCCH resource sets for the UEI reporting—e.g., with a configured periodicity; when/if the UE has sent to the network the PN message/trigger, the UE could start using/applying the one or more PUCCH resources/PUCCH resource groups/PUCCH resource sets configured for the UEI reporting to send the UEI report(s), X1 symbols/slots/etc. after the first or last symbol/slot/etc. of the transmission of the PN message/trigger (denoted by non-feedback based UEI reporting, e.g., for the PN message/trigger), and/or X2 symbols/slots/etc. after the first or last symbol/slot/etc. of an ACK reception for the transmission of the PN message/trigger (denoted by feedback based UEI reporting, e.g., for the PN message/trigger); for this design example, the network could keep monitoring the one or more PUCCH resources/PUCCH resource groups/PUCCH resource sets provided and/or configured for the UEI reporting, e.g., according to the reception/detection of the PN message/trigger and/or value(s) of X1 and/or X2, to detect/decode the UEI report(s), if sent over/on the one or more PUCCH resources/PUCCH resource groups/PUCCH resource sets as specified/described herein in the present disclosure. In another example, the UE (e.g., the UE 116) could be first configured or provided by the network one or more PUSCH resources for the UEI reporting—e.g., CG PUSCH(s) provided by ConfguredGrantConfig with a configured periodicity; when/if the UE has sent to the network the PN message/trigger, the UE could start using/applying the one or more PUSCH resources configured for the UEI reporting—e.g., provided by ConfiguredGrantConfig with a configured periodicity and indicator(s) indicating that the CG PUSCH(s) is for sending the UEI report(s)—to send the UEI report(s), Y1 symbols/slots/etc. after the first or last symbol/slot/etc. of the transmission of the PN message/trigger (denoted by non-feedback based UEI reporting, e.g., for the PN message/trigger), and/or Y2 symbols/slots/etc. after the first or last symbol/slot/etc. of an ACK reception for the transmission of the PN message/trigger (denoted by feedback based UEI reporting, e.g., for the PN message/trigger); for this design example, the network could keep monitoring the one or more PUSCH resources provided and/or configured for the UEI reporting, e.g., according to the reception/detection of the PN message/trigger and/or value(s) of Y1 and/or Y2, to detect/decode the UEI report(s), if sent over/on the one or more PUSCH resources as specified/described herein in the present disclosure. That is, for these design examples, the PN message/trigger is to activate the network configured (e.g., with a periodicity) one or more UL channels/resources for the UEI reporting to transmit the UEI report(s), or equivalently, the PN message/trigger is to indicate to the network that the one or more UL channels/resources (periodically) configured for the UEI reporting are activated to transmit the UEI report(s). Furthermore, when/if the UE is expected to receive an ACK (or NACK) for the PN message/trigger—i.e., the feedback based UEI reporting (e.g., for the PN message/trigger), (1) the UE could expect to receive the ACK (or NACK) for the PN message/trigger within a time window starting from the first or last symbol/slot/etc. of the transmission of the PN message/trigger, wherein the ACK (or NACK) could be in various forms and/or received in/via/by MAC CE/DCI; (2) otherwise, i.e., when/if the UE does not receive from the network an ACK for the PN message/trigger (or receives from the network a NACK for the PN message/trigger), within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting, e.g., on/over the corresponding network configured (periodic) UL channels/resources, and/or Z symbols/slots/etc. after the first or last symbol/slot/etc. of the time window, the UE could send the UEI report(s) on/over the corresponding network configured (periodic) UL channels/signals according to those described or specified herein in the present disclosure. For this case, the network could keep monitoring the one or more UL channels/signals configured, provided, activated and/or indicated for the UEI reporting, e.g., according to the reception/detection of the PN message/trigger, value(s) of Z, the time window and/or the maximum number of re-transmissions of the PN message/trigger—or the corresponding UEI report(s), to detect/decode the UEI report(s), if sent over/on the one or more UL channels/signals as specified/described herein in the present disclosure. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., value(s) of K1, K2, X1, X2, Y1, Y2, Z, the time window and/or the maximum number of re-transmissions of the PN message/trigger—or the corresponding UEI report(s); the value(s) of K1, K2, X1, X2, Y1, Y2, Z, the time window and/or the maximum number of re-transmissions of the PN message/trigger (or the corresponding UEI report(s)) that is provided/indicated/configured by the network could be selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. Optionally, the UE could autonomously determine or select value(s) of K1, K2, X1, X2, Y1, Y2, Z, the time window and/or the maximum number of re-transmissions of the PN message/trigger—or the corresponding UEI report(s), based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or inform or indicate to the network, e.g., via/by/in part of the PN message/trigger, their determined/selected value(s) of K1, K2, X1, X2, Y1, Y2, Z, the time window and/or the maximum number of re-transmissions of the PN message/trigger—or the corresponding UEI report(s); for instance, the PN message/trigger could comprise or correspond to a one-bit indicator or a multi-bit indicator or a one-level indicator or a multi-level indicator to indicate the value(s) of K1, K2, X1, X2, Y1, Y2, Z, the time window and/or the maximum number of re-transmissions of the PN message/trigger (or the corresponding UEI report(s)) selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
   Alt-5: the UE could send the PN message/trigger, e.g., in form of a scheduling request (SR) provided by or associated with a SR configuration; K1 symbols/slots/etc. after the first or last symbol/slot/etc. of the transmission of the PN message/trigger (denoted by non-feedback based UEI reporting, e.g., for the PN message/trigger), and/or K2 symbols/slots/etc. after the first or last symbol/slot/etc. of an ACK reception for the transmission of the PN message/trigger (denoted by feedback based UEI reporting, e.g., for the PN message/trigger), the UE could use one or more UL channels/signals associated/specific to the PN message/trigger to send the UEI report(s). For example, the one or more UL channels/signals here could correspond to periodic/semi-persistent PUCCH resource(s)/PUCCH resource group(s)/PUCCH resource set(s) configured and/or activated for the UEI reporting and/or UL data, and associated/specific to the PN trigger/message. For another example, the one or more UL channels/signals here could correspond to DG PUSCH(s) dynamically scheduled for the UEI reporting and/or UL data transmission(s), Type-1 CG PUSCH(s)—provided by ConfguredGrantConfig with a configured periodicity and/or Type-2 CG PUSCH(s)—provided by ConfiguredGrantConfig with a configured periodicity and activated by a DL signaling, e.g., a DCI, for the UEI reporting and/or UL data transmission(s), and associated/specific to the PN message/trigger. Furthermore, when/if the UE is expected to receive an ACK (or NACK) for the PN message/trigger—i.e., the feedback based UEI reporting (e.g., for the PN message/trigger), (1) the UE could expect to receive the ACK (or NACK) for the PN message/trigger within a time window starting from the first or last symbol/slot/etc. of the transmission of the PN message/trigger, wherein the ACK (or NACK) could be in various forms (e.g., as a DCI trigger indicated/provided by a CSI request field in the corresponding DCI format(s), e.g., 0_1, and/or a UL grant indicated/provided in DCI format(s) 0_0, 0_1 and/or 0_2) and/or received in/via/by MAC CE/DCI; (2) otherwise, i.e., when/if the UE does not receive from the network an ACK for the PN message/trigger (or receives from the network a NACK for the PN message/trigger), within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting, e.g., on/over the corresponding UL channels/resources associated/specific to the PN message/trigger, and/or Z symbols/slots/etc. after the first or last symbol/slot/etc. of the time window, the UE could send the UEI report(s) on/over the corresponding UL channels/signals associated/specific to the PN message/trigger according to those described or specified herein in the present disclosure. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., value(s) of K1, K2, Z, the time window and/or the maximum number of re-transmissions of the PN message/trigger—or the corresponding UEI report(s); the value(s) of K1, K2, Z, the time window and/or the maximum number of re-transmissions of the PN message/trigger (or the corresponding UEI report(s)) that is provided/indicated/configured by the network could be selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. Optionally, the UE could autonomously determine or select value(s) of K1, K2, Z, the time window and/or the maximum number of re-transmissions of the PN message/trigger—or the corresponding UEI report(s), based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or inform or indicate to the network, e.g., via/by/in part of the PN message/trigger, their determined/selected value(s) of K1, K2, Z, the time window and/or the maximum number of re-transmissions of the PN message/trigger—or the corresponding UEI report(s); for instance, the PN message/trigger could comprise or correspond to a one-bit indicator or a multi-bit indicator or a one-level indicator or a multi-level indicator to indicate the value(s) of K1, K2, Z, the time window and/or the maximum number of re-transmissions of the PN message/trigger (or the corresponding UEI report(s)) selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. For this case, the network could keep monitoring the one or more UL channels/signals associated/specific to the PN message/trigger, e.g., according to the reception/detection of the PN message/trigger, value(s) of K1, K2, Z, the time window and/or the maximum number of re-transmissions of the PN message/trigger—or the corresponding UEI report(s), to detect/decode the UEI report(s), if sent over/on the one or more UL channels/signals associated/specific to the PN message/trigger as specified/described herein in the present disclosure. The UE could determine or identify the association(s)/mapping(s) between one or more PN messages/triggers and one or more UL channels/signals (e.g., PUCCH resource(s)/resource group(s)/resource set(s), DG/Type-1 CG/Type-2 CG PUSCH(s), and/or etc.) according to:
      fixed rule(s)/value(s) in system specification(s) or per RRC configuration: for instance, each candidate PN message/trigger (e.g., in terms of or in form of their configuration(s) with corresponding ID(s)/index(es)) could be associated/specific to a predefined or predetermined set of one or more UL channels/resources—including e.g. one or more PUCCH resources, PUCCH resource groups, PUCCH resource sets and/or DG, Type-1/2 CG PUSCHs, wherein the UL channels/resources in the set could be continuous in time and/or frequency, the number of the UL channels/signals in the set could be fixed value(s) in system specification(s), and/or the IDs/index(es) of the UL channels/signals in the set could be fixed value(s) in system specification(s).
      network's configuration(s)/indication(s), e.g., via higher layer RRC signaling(s)/parameter(s) and/or MAC CE command(s) and/or dynamic DCI based L1 signaling(s)—e.g., according to or based on a corresponding UE's capability or capability signaling: for example, the (higher layer) configuration(s)/parameter(s)/signaling(s) that configures or provides a PN message/trigger (e.g., a SR configuration that configures or provides a SR when/if the PN message/trigger is in form of a SR) could provide, configure or indicate a set of one or more UL channels/signals (e.g., including one or more PUCCH resources, PUCCH resource groups, PUCCH resource sets and/or DG, Type-1/2 CG PUSCHs), e.g., in form of their time and/or frequency resource allocation(s), number of the UL channel(s)/signal(s) in the set, their indexes/IDs (e.g., in the set), and/or etc.; for another example, the (higher layer) configuration(s)/parameter(s)/signaling(s) that configures or provides the one or more UL channels/resources (e.g., PUCCH-Config, PUCCH-ResourceSet and/or PUCCH-Resource that configures or provides one or more PUCCH resources, PUCCH resource groups, PUCCH resource sets, and/or ConfguredGrantConfig that configures or provides one or more PUSCHs) could provide, configure or indicate information related to the PN message/trigger (e.g., in form of their configuration(s) and/or ID(s)/index(es)); for another example, the PN message/trigger (one or multi-bit, or one or multi-level) could also indicate or inform to the network which one or more PUCCH resources (e.g., from one or more PUCCH resource sets/groups, e.g., configured/provided/activated for the UEI reporting) and/or PUCCH resource groups and/or PUCCH resource sets to use for sending the UEI report(s), and/or one or more PUSCH resources in one or more ConfiguredGrantConfig's and/or one or more ConfiguredGrantConfig's (and therefore, the PUSCHs configured/provided therein) to use for sending the UEI report(s).

Conceptual examples characterizing the described/specified design procedures are provided in FIG. 8 and FIG. 9. Optionally, the UE may expect to be configured, provided, activated or indicated by the network, e.g., within the time window starting from the first or last symbol/slot/etc. of the transmission of the PN message/trigger, via higher layer RRC signaling(s)/parameter(s) and/or MAC CE command(s) and/or dynamic DCI based L1 signaling(s), one or more UL resources for sending the UEI report(s)—for this case, e.g., the UE may not receive an ACK (or NACK) for the PN message/trigger, e.g., within the time window starting from the first or last symbol/slot/etc. of the transmission of the PN message/trigger, and/or instead of sending an ACK (or NACK) for the PN message/trigger, the network indicates to the UE, e.g., within the time window starting from the first or last symbol/slot/etc. of the transmission of the PN message/trigger, which one or more UL resources to use for sending the UEI report(s)—e.g., in form of an UL grant for the UEI reporting; the UE could determine or identify, based on/according to the network's configuration(s)/activation(s)/indication(s)—e.g., the UL grant for the UEI reporting, the one or more UL resources to use for sending the UEI report(s) following those specified herein in the present disclosure (e.g., via CSI request field in a triggering DCI, PUCCH resource indicator (PRI), DG and/or CG Type-1/2 PUSCH(s), periodic/semi-persistent PUCCH resource(s)/PUCCH resource group(s)/PUCCH resource set(s) and/or etc.).
Alt-6: the UE could use dynamic grant (DG) PUSCH(s) and/or Type-1/2 CG PUSCH(s) to send UL data. For this case design, once the UE has decided, determined or identified to send the UEI report(s), the UE could piggyback the UEI report(s) on the DG PUSCH(s) and/or Type-1/2 CG PUSCH(s) for the UL data transmission(s). For this case, the network could keep monitoring the DG PUSCH(s) and/or Type-1/2 CG PUSCH(s) for the UL data transmission(s) to detect or decode the UEI report(s), if piggybacked on/over the DG PUSCH(s) and/or Type-1/2 CG PUSCH(s) as specified/described herein in the present disclosure.
Alt-7: the UE could send the UEI report(s) in part of or as a power headroom report (PHR), which could be piggybacked on DG PUSCH(s) and/or Type-1/2 CG PUSCH(s) for UL data transmission(s). For this design example, the UE could indicate to the network, e.g., via one or more indicators, whether a PHR corresponds to or comprises or contains or provides or includes UEI report(s). In addition, the network could keep monitoring the DG PUSCH(s) and/or Type-1/2 CG PUSCH(s) for the UL data transmission(s) to detect or decode the UEI report(s), if sent in part of or as a PHR piggybacked on/over the DG PUSCH(s) and/or Type-1/2 CG PUSCH(s) as specified/described herein in the present disclosure. For this case/design example, the PHR could be triggered when/if the UE decides, determines or identifies to send the UEI report(s) according to those specified herein in the present disclosure.
Alt-8: the UE could start a timer after the transmission of the PN message/trigger (e.g., after the first or last symbol/slot/etc. of the transmission of the PN message/trigger), wherein the timer duration/length could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or (3) UE's autonomous determination, which could be further sent to the network via various UL channels/signals. For this case, X1 symbols/slots/etc. after the first or last symbol/slot/etc. of the transmission of the PN message/trigger (denoted by non-feedback based UEI reporting, e.g., for the PN message/trigger), and/or X2 symbols/slots/etc. after the first or last symbol/slot/etc. of an ACK reception for the transmission of the PN message/trigger (denoted by feedback based UEI reporting, e.g., for the PN message/trigger), and/or when/if the timer has expired (denoted by non-feedback based UEI reporting, e.g., for the PN message/trigger), the UE could send the UEI report(s) on the UL channel(s)/resource(s) determined according to those specified in Alt-1-Alt-8 in the present disclosure, and/or (re-)set the timer to zero. The network could keep monitoring the corresponding UL channel(s)/resource(s), e.g., according to the reception/detection of the PN message/trigger and/or value(s) of X1 and/or X2 and/or the timer duration/length, to detect or decode the UEI report(s). Furthermore, when/if the UE is expected to receive an ACK (or NACK) for the PN message/trigger—i.e., the feedback based UEI reporting (e.g., for the PN message/trigger), (1) the UE could expect to receive the ACK (or NACK) for the PN message/trigger within a time window starting from the first or last symbol/slot/etc. of the transmission of the PN message/trigger, wherein the ACK (or NACK) could be in various forms and/or received in/via/by MAC CE/DCI; (2) otherwise, i.e., when/if the UE does not receive from the network an ACK for the PN message/trigger (or receives from the network a NACK for the PN message/trigger), within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting on the corresponding UL channel(s)/resource(s) according to those specified herein in the present disclosure, and/or Z symbols/slots/etc. after the first or last symbol/slot/etc. of the time window, the UE could send the UEI report(s) on/over the corresponding UL channel(s)/signal(s) determined according to those specified in Alt-1 to Alt-8 in the present disclosure. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., value(s) of the timer duration/length, X1, X2, Z, the time window and/or the maximum number of re-transmissions of the PN message/trigger—or the corresponding UEI report(s). The value(s) of the timer duration/length, X1, X2, Z, the time window and/or the maximum number of re-transmissions of the PN message/trigger (or the corresponding UEI report(s)) that is provided/indicated/configured by the network could be selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. Optionally, the UE could autonomously determine or select value(s) of the timer duration/length, X1, X2, Z, the time window and/or the maximum number of re-transmissions of the PN message/trigger—or the corresponding UEI report(s), based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or inform or indicate to the network, e.g., via/by/in part of the PN message/trigger, their determined/selected value(s) of the timer duration/length, X1, X2, Z, the time window and/or the maximum number of re-transmissions of the PN message/trigger—or the corresponding UEI report(s); for instance, the PN message/trigger could comprise or correspond to a one-bit indicator or a multi-bit indicator or a one-level indicator or a multi-level indicator to indicate the value(s) of the timer duration/length, X1, X2, Z, the time window and/or the maximum number of re-transmissions of the PN message/trigger (or the corresponding UEI report(s)) selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. For example, the UE could be first provided or configured or indicated by the network, e.g., via higher layer RRC signaling(s)/parameter(s) and/or MAC CE command(s) and/or dynamic DCI based L1 signaling(s)—e.g., based on or according to a UE's capability or capability signaling, a set of L≥1 candidate values for the timer duration/length; for this design example, the PN message/trigger could correspond to or comprise a └log₂ L┘-bit indicator with each state/codepoint of the └log₂ L┘-bit indicator indicating a timer duration/length from the set of L≥1 candidate values; for instance, for L=2, the PN message/trigger could correspond to or comprise a one-bit indicator; when/if the one-bit indicator is set to ‘0’ (or ‘1’), the PN message/trigger could indicate or provide to the network (e.g., the network 130) that the timer duration/length could correspond to the first entry/value in the set of L=2 candidate values, and/or when/if the one-bit indicator is set to ‘1’ (or ‘0’), the PN message/trigger could indicate or provide to the network that the timer duration/length could correspond to the second entry/value in the set of L=2 candidate values. The described procedure for the example of using the PN message/trigger to indicate the timer duration/length can be applied or extended to the design example(s) of using the PN message/trigger to indicate the time duration(s), time window(s) and/or the maximum number of re-transmissions of the PN/message/trigger (or the corresponding UEI report(s)) specified throughout the present disclosure.

In one embodiment (embodiment-IV), the UEI report(s) could contain, provide, include or comprise at least a pre-notification (PN) message/trigger—e.g., of (report-)type (A) or (report-)type (C) as specified herein in the present disclosure, and/or the (corresponding) content—e.g., of (report-)type (B) or (report-)type (C) as specified herein in the present disclosure. For this case/setting,
the UE (e.g., the UE 116) could send the PN message/trigger, e.g., via one or more PUCCH resources, wherein each of the one or more PUCCH resources (e.g., of format 0/1/2/3/4) could be from one or more PUCCH resource sets, e.g., configured/provided for the UEI reporting(s)—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting.
after the UE has transmitted the PN message/trigger, the UE could expect to receive from the network a DCI to trigger aperiodic (AP) CSI-RS reporting, and/or activate semi-persistent (SP) CSI-RS reporting, within a time window starting from the first or last symbol/slot/etc. of the transmission of the PN message/trigger; otherwise, i.e., when/if the UE does not receive from the network a DCI to trigger aperiodic (AP) CSI-RS reporting, and/or activate semi-persistent (SP) CSI-RS reporting, within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, value(s) of the time window and/or the maximum number of re-transmissions of the PN message/trigger—or the corresponding UEI report(s). For instance, if the DCI is to trigger the AP CSI-RS reporting, the DCI could be of DCI format 0_1 with the CSI request field indicated/provided therein set to valid value(s)/index(es), e.g., pointing to the index(es) of the entries in CSI-AperiodicTriggerStateList or the index(es) of the codepoint(s) in the aperiodic CSI trigger state subselection MAC CE. Furthermore, the reception of the DCI trigger or activation for the AP or SP CSI-RS reporting could be an ACK for the transmission of the PN message/trigger.
once the UE has determined, decided or identified to send the UEI report(s), the UE could send the UEI report(s) over/on the UL channels/resources—e.g., SP-PUCCH(s), e.g., in form/terms of PUCCH resource(s), slot(s)/slot offset(s) for transmission(s), and/or etc., SP-PUSCH(s), e.g., in form/terms of PUSCH resource(s), slot(s)/slot offset(s) for transmission(s), p0/alpha for the PUSCH(s) and/or etc., and/or AP resource(s) in form/terms of slot(s)/slot offset(s) for transmission(s)—according to the CSI reporting setting(s) triggered, activated or associated to the DCI that triggers or activates the AP or SP CSI-RS reporting; for instance, for AP CSI-RS reporting, the UE could send the UEI report(s) over/on the UL channels/signals as described/herein in the present disclosure according to the CSI reporting setting(s) associated to/with the trigger state provided/indicated by the CSI request field in the corresponding DCI format 0_1.
the UE could determine or identify the CSI-RS(s), therefore, the corresponding CSI-RS resource(s), for measurement according to:
   periodic CSI-RS resource(s), periodically transmitted CSI-RS(s)—and therefore, the corresponding CSI-RS resource(s), provided/configured in one or more CSI resource settings, CSI resource sets, CSI resource groups and/or CSI resource pairs, and/or
   semi-persistent CSI-RS resource(s), semi-persistently transmitted CSI-RS(s)—and therefore, the corresponding CSI-RS resource(s), provided/configured in one or more CSI resource settings, CSI resource sets, CSI resource groups and/or CSI resource pairs associated to the DCI that activates the SP CSI-RS measurement, and/or
   CSI-RS resource(s) associated/specific to the PN message/trigger, or CSI-RS(s) transmitted by/from the network upon reception/detection of the PN message/trigger wherein the CSI-RS resource(s) corresponding to the transmitted CSI-RS(s) could be associated/specific to the PN message/trigger; for this case, the UE could expect to receive/measure the CSI-RS(s) associated/specific to the PN message/trigger T1 symbols/slots/etc. after the first or last symbol/slot/etc. of the transmission of the PN message/trigger (denoted by non-feedback based UEI reporting, e.g., for the PN message/trigger), and/or T2 symbols/slots/etc. after the first or last symbol/slot/etc. of an ACK reception for the transmission of the PN message/trigger (denoted by feedback based UEI reporting, e.g., for the PN message/trigger), wherein the ACK could be transmission(s) of the CSI-RS(s)/CSI-RS resource(s) associated/specific to the PN message/trigger; when/if the UE does not receive/measure the CSI-RS(s) associated/specific to the PN message/trigger T1 symbols/slots/etc. after the first or last symbol/slot/etc. of the transmission of the PN message/trigger—i.e., for the non-feedback based UEI reporting (e.g., for the PN message/trigger), and/or T2 symbols/slots/etc. after the first or last symbol/slot/etc. of an ACK reception for the transmission of the PN message/trigger—i.e., for the feedback based UEI reporting (e.g., for the PN message/trigger), the UE could re-transmit or re-send the PN message/trigger, and after a maximum number of re-transmissions of the PN message/trigger—or the corresponding UEI report(s), the UE could terminate or abandon the UEI reporting; optionally, the UE could expect to receive an ACK (or NACK) in response to the PN message/trigger—i.e., the feedback based UEI reporting (e.g., for the PN message/trigger); for this case, i.e., when/if the UE is expected to receive an ACK (or NACK) for the PN message/trigger, (1) the UE could expect to receive the ACK (or NACK) for the PN message/trigger within a time window starting from the first or last symbol/slot/etc. of the transmission of the PN message/trigger, wherein the ACK (or NACK) could be in various forms (e.g., as a DCI trigger indicated/provided by a CSI request field in the corresponding DCI format(s), e.g., 01, and/or a UL grant indicated/provided in DCI format(s) 00, 0_1 and/or 0_2, and/or transmission(s) of the CSI-RS(s)/CSI-RS resource(s) associated/specific to the PN message/trigger as specified/described herein in the present disclosure) and/or received in/via/by MAC CE/DCI; (2) otherwise, i.e., when/if the UE does not receive from the network an ACK for the PN message/trigger (or receives from the network a NACK for the PN message/trigger), within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting. The UE could determine or identify the association(s)/mapping(s) between one or more PN messages/triggers and one or more RSs/RS resources for measurement (e.g., CSI-RS resource(s)/CSI resource group(s)/CSI resource set(s)/CSI resource setting(s), and/or etc.) according to:
      fixed rule(s)/value(s) in system specification(s) or per RRC configuration: for instance, each candidate PN message/trigger (e.g., in terms of or in form of their configuration(s) with corresponding ID(s)/index(es)) could be associated/specific to one or more predefined or predetermined RSs/RS resources for measurement (e.g., in terms of or in form of their RS/RS resource ID(s)/index(es)—including e.g. one or more CSI-RS resources (e.g., in terms of or in form of their resource ID(s)/index(es)), one or more CSI resource groups (e.g., in terms of or in form of their resource group ID(s)/index(es)), one or more CSI resource sets (e.g., in terms of or in form of their resource set ID(s)/index(es)) and/or one or more CSI resource settings (e.g., in terms of or in form of their resource setting/configuration ID(s)/index(es))
      network's configuration(s)/indication(s), e.g., via higher layer RRC signaling(s)/parameter(s) and/or MAC CE command(s) and/or dynamic DCI based L1 signaling(s)—e.g., according to or based on a corresponding UE's capability or capability signaling: for example, the (higher layer) configuration(s)/parameter(s)/signaling(s) that configures or provides a PN message/trigger (e.g., a SR configuration that configures or provides a SR when/if the PN message/trigger is in form of a SR) could provide, configure or indicate one or more RSs/RS resources for measurement (e.g., in terms of or in form of their RS/RS resource ID(s)/index(es)—including e.g. one or more CSI-RS resources (e.g., in terms of or in form of their resource ID(s)/index(es)), one or more CSI resource groups (e.g., in terms of or in form of their resource group ID(s)/index(es)), one or more CSI resource sets (e.g., in terms of or in form of their resource set ID(s)/index(es)) and/or one or more CSI resource settings (e.g., in terms of or in form of their resource setting/configuration ID(s)/index(es)); for another example, the (higher layer) configuration(s)/parameter(s)/signaling(s) that configures or provides the one or more RSs/RS resources for measurement—including e.g. the (higher layer) configuration(s)/parameter(s)/signaling(s) NZP-CSI-RS-Resource that configures or provides the one or more CSI-RS resources, the (higher layer) configuration(s)/parameter(s)/signaling(s) NZP-CSI-RS-ResourceGroup that configures or provides one or more CSI resource groups, the (higher layer) configuration(s)/parameter(s)/signaling(s) NZP-CSI-RS-ResourceSet that provides or configures one or more CSI resource sets and/or the (higher layer) configuration(s)/parameter(s)/signaling(s) CSI-ResourceConfig that provides or configures one or more CSI resource settings could provide, configure or indicate information related to the PN message/trigger (e.g., in form of their configuration(s) and/or ID(s)/index(es)); for another example, the PN message/trigger (one or multi-bit, or one or multi-level) could also indicate or inform to the network which one or more CSI-RS resources (e.g., from one or more CSI resource groups, CSI resource sets and/or CSI resource settings, e.g., configured/provided/activated for the UEI reporting) and/or one or more CSI resource groups (e.g., from one or more CSI resource sets and/or CSI resource settings, e.g., configured/provided/activated for the UEI reporting) and/or one or more CSI resource sets (e.g., from one or more CSI resource settings, e.g., configured/provided/activated for the UEI reporting) and/or one or more CSI resource settings to use for measurement.

Optionally, the UE may expect to be configured, provided, activated or indicated by the network, e.g., within the time window starting from the first or last symbol/slot/etc. of the transmission of the PN message/trigger, via higher layer RRC signaling(s)/parameter(s) and/or MAC CE command(s) and/or dynamic DCI based L1 signaling(s), one or more (periodic/semi-persistent/aperiodic) CSI-RS resources, CSI resource groups, CSI resource sets and/or CSI resource settings for measurement—for this case, e.g., the UE may not receive an ACK for the PN message/trigger, e.g., within the time window starting from the first or last symbol/slot/etc. of the transmission of the PN message/trigger, and/or instead of sending an ACK for the PN message/trigger, the network indicates to the UE which one or more (periodic/semi-persistent/aperiodic) CSI-RS resources, CSI resource groups, CSI resource sets and/or CSI resource settings to use for measurement following those specified herein in the present disclosure (e.g., via CSI request field in a triggering DCI, via an activation DCI for semi-persistent CSI-RS measurement/reporting, higher layer configuration(s)/parameter(s) NZP-CSI-RS-ResourceSet, NZP-CSI-RS-Resource, CSI-ResourceConfig that provides or configures the corresponding CSI-RS resource(s), CSI resource group(s), CSI resource set(s) and/or CSI resource setting(s)/configuration(s)).

In one embodiment (embodiment-V), the UEI report(s) could contain, provide, include or comprise at least a pre-notification (PN) message/trigger—e.g., of (report-)type (A) or (report-)type (C) as specified herein in the present disclosure, and/or the (corresponding) content—e.g., of (report-)type (B) or (report-)type (C) as specified herein in the present disclosure. For this case/setting,
the UE could send the PN message/trigger, e.g., via one or more PUCCH resources, wherein each of the one or more PUCCH resources (e.g., of format 0/1/2/3/4) could be from one or more PUCCH resource sets, e.g., configured/provided for the UEI reporting(s)—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting.
the UE could determine or identify the CSI-RS(s), therefore, the corresponding CSI-RS resource(s), for measurement according to:
   periodic CSI-RS resource(s), periodically transmitted CSI-RS(s)—and therefore, the corresponding CSI-RS resource(s), provided/configured in one or more CSI resource settings, CSI resource sets, CSI resource groups and/or CSI resource pairs, and/or
   semi-persistent CSI-RS resource(s), semi-persistently transmitted CSI-RS(s)—and therefore, the corresponding CSI-RS resource(s), provided/configured in one or more CSI resource settings, CSI resource sets, CSI resource groups and/or CSI resource pairs associated to the DCI that activates the SP CSI-RS measurement, and/or
   CSI-RS resource(s) associated/specific to the PN message/trigger, or CSI-RS(s) transmitted by/from the network upon reception/detection of the PN message/trigger wherein the CSI-RS resource(s) corresponding to the transmitted CSI-RS(s) could be associated/specific to the PN message/trigger; for this case, the UE could expect to receive/measure the CSI-RS(s) associated/specific to the PN message/trigger T1 symbols/slots/etc. after the first or last symbol/slot/etc. of the transmission of the PN message/trigger (denoted by non-feedback based UEI reporting, e.g., for the PN message/trigger), and/or T2 symbols/slots/etc. after the first or last symbol/slot/etc. of an ACK reception for the transmission of the PN message/trigger (denoted by feedback based UEI reporting, e.g., for the PN message/trigger), wherein the ACK could be transmission(s) of the CSI-RS(s)/CSI-RS resource(s) associated/specific to the PN message/trigger; when/if the UE does not receive/measure the CSI-RS(s) associated/specific to the PN message/trigger T1 symbols/slots/etc. after the first or last symbol/slot/etc. of the transmission of the PN message/trigger—i.e., for the non-feedback based UEI reporting (e.g., for the PN message/trigger), and/or T2 symbols/slots/etc. after the first or last symbol/slot/etc. of an ACK reception for the transmission of the PN message/trigger—i.e., for the feedback based UEI reporting (e.g., for the PN message/trigger), the UE could re-transmit or re-send the PN message/trigger, and after a maximum number of re-transmissions of the PN message/trigger—or the corresponding UEI report(s), the UE could terminate or abandon the UEI reporting; optionally, the UE could expect to receive an ACK (or NACK) in response to the PN message/trigger—i.e., the feedback based UEI reporting (e.g., for the PN message/trigger); for this case, i.e., when/if the UE is expected to receive an ACK (or NACK) for the PN message/trigger, (1) the UE could expect to receive the ACK (or NACK) for the PN message/trigger within a time window starting from the first or last symbol/slot/etc. of the transmission of the PN message/trigger, wherein the ACK (or NACK) could be in various forms (e.g., as a DCI trigger indicated/provided by a CSI request field in the corresponding DCI format(s), e.g., 0_1, and/or a UL grant indicated/provided in DCI format(s) 0_0, 0_1 and/or 0_2, and/or transmission(s) of the CSI-RS(s)/CSI-RS resource(s) associated/specific to the PN message/trigger as specified/described herein in the present disclosure) and/or received in/via/by MAC CE/DCI; (2) otherwise, i.e., when/if the UE does not receive from the network an ACK for the PN message/trigger (or receives from the network a NACK for the PN message/trigger), within a time window starting from the first or last symbol/slot/etc. of the transmission of the PN message/trigger, the UE could re-transmit or re-send the PN message/trigger, and after a maximum number of re-transmissions of the PN message/trigger—or the corresponding UEI report(s), the UE could terminate or abandon the UEI reporting. The UE could determine or identify the association(s)/mapping(s) between one or more PN messages/triggers and one or more RSs/RS resources for measurement (e.g., CSI-RS resource(s)/CSI resource group(s)/CSI resource set(s)/CSI resource setting(s), and/or etc.) according to:
      fixed rule(s)/value(s) in system specification(s) or per RRC configuration: for instance, each candidate PN message/trigger (e.g., in terms of or in form of their configuration(s) with corresponding ID(s)/index(es)) could be associated/specific to one or more predefined or predetermined RSs/RS resources for measurement (e.g., in terms of or in form of their RS/RS resource ID(s)/index(es)—including e.g. one or more CSI-RS resources (e.g., in terms of or in form of their resource ID(s)/index(es)), one or more CSI resource groups (e.g., in terms of or in form of their resource group ID(s)/index(es)), one or more CSI resource sets (e.g., in terms of or in form of their resource set ID(s)/index(es)) and/or one or more CSI resource settings (e.g., in terms of or in form of their resource setting/configuration ID(s)/index(es))
      network's configuration(s)/indication(s), e.g., via higher layer RRC signaling(s)/parameter(s) and/or MAC CE command(s) and/or dynamic DCI based L1 signaling(s)—e.g., according to or based on a corresponding UE's capability or capability signaling: for example, the (higher layer) configuration(s)/parameter(s)/signaling(s) that configures or provides a PN message/trigger (e.g., a SR configuration that configures or provides a SR when/if the PN message/trigger is in form of a SR) could provide, configure or indicate one or more RSs/RS resources for measurement (e.g., in terms of or in form of their RS/RS resource ID(s)/index(es)—including e.g. one or more CSI-RS resources (e.g., in terms of or in form of their resource ID(s)/index(es)), one or more CSI resource groups (e.g., in terms of or in form of their resource group ID(s)/index(es)), one or more CSI resource sets (e.g., in terms of or in form of their resource set ID(s)/index(es)) and/or one or more CSI resource settings (e.g., in terms of or in form of their resource setting/configuration ID(s)/index(es)); for another example, the (higher layer) configuration(s)/parameter(s)/signaling(s) that configures or provides the one or more RSs/RS resources for measurement—including e.g. the (higher layer) configuration(s)/parameter(s)/signaling(s) NZP-CSI-RS-Resource that configures or provides the one or more CSI-RS resources, the (higher layer) configuration(s)/parameter(s)/signaling(s) NZP-CSI-RS-ResourceGroup that configures or provides one or more CSI resource groups, the (higher layer) configuration(s)/parameter(s)/signaling(s) NZP-CSI-RS-ResourceSet that provides or configures one or more CSI resource sets and/or the (higher layer) configuration(s)/parameter(s)/signaling(s) CSI-ResourceConfig that provides or configures one or more CSI resource settings could provide, configure or indicate information related to the PN message/trigger (e.g., in form of their configuration(s) and/or ID(s)/index(es)); for another example, the PN message/trigger (one or multi-bit, or one or multi-level) could also indicate or inform to the network which one or more CSI-RS resources (e.g., from one or more CSI resource groups, CSI resource sets and/or CSI resource settings, e.g., configured/provided/activated for the UEI reporting) and/or one or more CSI resource groups (e.g., from one or more CSI resource sets and/or CSI resource settings, e.g., configured/provided/activated for the UEI reporting) and/or one or more CSI resource sets (e.g., from one or more CSI resource settings, e.g., configured/provided/activated for the UEI reporting) and/or one or more CSI resource settings to use for measurement.

Optionally, the UE may expect to be configured, provided, activated or indicated by the network, e.g., within the time window starting from the first or last symbol/slot/etc. of the transmission of the PN message/trigger, via higher layer RRC signaling(s)/parameter(s) and/or MAC CE command(s) and/or dynamic DCI based L1 signaling(s), one or more (periodic/semi-persistent/aperiodic) CSI-RS resources, CSI resource groups, CSI resource sets and/or CSI resource settings for measurement—for this case, e.g., the UE may not receive an ACK (or NACK) for the PN message/trigger, e.g., within the time window starting from the first or last symbol/slot/etc. of the transmission of the PN message/trigger, and/or instead of sending an ACK (or NACK) for the PN message/trigger, the network indicates to the UE which one or more (periodic/semi-persistent/aperiodic) CSI-RS resources, CSI resource groups, CSI resource sets and/or CSI resource settings to use for measurement following those specified herein in the present disclosure (e.g., via CSI request field in a triggering DCI, via an activation DCI for semi-persistent CSI-RS measurement/reporting, higher layer configuration(s)/parameter(s) NZP-CSI-RS-ResourceSet, NZP-CSI-RS-Resource, CSI-ResourceConfig that provides or configures the corresponding CSI-RS resource(s), CSI resource group(s), CSI resource set(s) and/or CSI resource setting(s)/configuration(s)).
once the UE has determined, decided or identified to send the UEI report(s), the UE could send the UEI report(s) over/on one or more UL channels/resources determined according to those specified/described in Alt-1, Alt-2, Alt-3, Alt-4, Alt-5, Alt-6, Alt-7 and Alt-8 in the present disclosure.

For the embodiment-IV and embodiment-V in the present disclosure, the UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., value(s) of T1, T2, the time window and/or the maximum number of re-transmissions of the PN message/trigger—or the corresponding UEI report(s). The value(s) of T1, T2, the time window and/or the maximum number of re-transmissions of the PN message/trigger (or the corresponding UEI report(s)) that is provided/indicated/configured by the network could be selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. Optionally, the UE could autonomously determine or select value(s) of T1, T2, the time window and/or the maximum number of re-transmissions of the PN message/trigger—or the corresponding UEI report(s), based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or inform or indicate to the network, e.g., via/by/in part of the PN message/trigger, their determined/selected value(s) of T1, T2, the time window and/or the maximum number of re-transmissions of the PN message/trigger—or the corresponding UEI report(s); for instance, the PN message/trigger could comprise or correspond to a one-bit indicator or a multi-bit indicator or a one-level indicator or a multi-level indicator to indicate the value(s) of T1, T2, the time window and/or the maximum number of re-transmissions of the PN message/trigger (or the corresponding UEI report(s)) selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

Whether to use/apply the non-feedback based UEI reporting scheme(s) and/or the feedback based UEI reporting scheme(s) according to those specified herein in the present disclosure to send or for sending the UEI report(s)—including the PN message/trigger and/or the UEI report content(s)/quantity(s)—could be determined or identified (by the UE) according to: (1) fixed rule(s)/value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network (e.g., the network 130) via various UL channels/signals.
In one example, the UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling and/or one or more conditions or events including exact content(s)/report quantity(s) in the UEI report(s), latency/overhead requirement(s) for the UEI report(s), whether to use/apply the non-feedback based UEI reporting scheme(s) and/or the feedback based UEI reporting scheme(s) according to those specified herein in the present disclosure to send or for sending the UEI report(s). For example, when/if a higher layer parameter ueiReportScheme is set to ‘nonFeedback’, the UE could use/apply the non-feedback based UEI reporting scheme(s) as specified herein in the present disclosure to send the UEI report(s)—e.g., including the PN message/trigger and the corresponding content(s)/report quantity(s), and/or when/if the higher layer parameter ueiReportScheme is set to ‘feedback’, the UE could use/apply the feedback based UEI reporting scheme(s) as specified herein in the present disclosure to send the UEI report(s)—e.g., including the PN message/trigger and the corresponding content(s)/report quantity(s). For another example, when/if a higher layer parameter ueiReportScheme is set to ‘nonFeedbackForPN’, the UE could use/apply the non-feedback based UEI reporting scheme(s) as specified herein in the present disclosure to send the PN message/trigger, when/if the higher layer parameter ueiReportScheme is set to ‘feedbackForPN’, the UE could use/apply the feedback based UEI reporting scheme(s) as specified herein in the present disclosure to send the PN message/trigger, when/if the higher layer parameter ueiReportScheme is set to ‘nonFeedbackForContent’, the UE (e.g., the UE 116) could use/apply the non-feedback based UEI reporting scheme(s) as specified herein in the present disclosure to send the UEI report(s)/report content(s)/quantity(s)—e.g., associated/specific to a/the PN message/trigger, and/or when/if the higher layer parameter ueiReportScheme is set to ‘feedbackForContent’, the UE could use/apply the feedback based UEI reporting scheme(s) as specified herein in the present disclosure to send the UEI report(s)/report content(s)/quantity(s)—e.g., associated/specific to a/the PN message/trigger.
In another example, the UE could autonomously determine or identify whether to use/apply the non-feedback based UEI reporting scheme(s) and/or the feedback based UEI reporting scheme(s) according to those specified herein in the present disclosure to send or for sending the UEI report(s), based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or inform or indicate to the network, e.g., via/by/in part of the PN message/trigger, their determined or identified non-feedback based and/or feedback based UEI reporting scheme(s). For example, the PN message/trigger could comprise or correspond to a one-bit indicator; when/if the one-bit indicator is set to ‘0’ (or ‘1’), the PN message/trigger could indicate to the network that the UE could use/apply the non-feedback based UEI reporting scheme(s) as specified herein in the present disclosure to send the UEI report(s)—e.g., including the PN message/trigger and the corresponding content(s)/report quantity(s), and/or when/if the one-bit indicator is set to ‘1’ (or ‘0’), the PN message/trigger could indicate to the network that the UE could use/apply the feedback based UEI reporting scheme(s) as specified herein in the present disclosure to send the UEI report(s)—e.g., including the PN message/trigger and the corresponding content(s)/report quantity(s). For another example, the PN message/trigger could comprise or correspond to a two-bit indicator; when/if the two-bit indicator is set to ‘00’ (or ‘01’ or ‘10’ or ‘11’), the PN message/trigger could indicate to the network that the UE could use/apply the non-feedback based UEI reporting scheme(s) as specified herein in the present disclosure to send the PN message/trigger, when/if the two-bit indicator is set to ‘01’ (or ‘00’ or ‘10’ or ‘11’), the PN message/trigger could indicate to the network that the UE could use/apply the feedback based UEI reporting scheme(s) as specified herein in the present disclosure to send the PN message/trigger, when/if the two-bit indicator is set to ‘10’ (or ‘00’ or ‘01’ or ‘11’), the PN message/trigger could indicate to the network that the UE could use/apply the non-feedback based UEI reporting scheme(s) as specified herein in the present disclosure to send the UEI report(s)/report content(s)/quantity(s)—e.g., associated/specific to a/the PN message/trigger, and/or when/if the two-bit indicator is set to ‘11’ (or ‘00’ or ‘01’ or ‘10’), the PN message/trigger could indicate to the network that the UE could use/apply the feedback based UEI reporting scheme(s) as specified herein in the present disclosure to send the UEI report(s)/report content(s)/quantity(s)—e.g., associated/specific to a/the PN message/trigger.

The UE could determine or identify to follow the design procedures specified or described in embodiment-I, embodiment-II, embodiment-III, embodiment-IV and/or embodiment-V according to or based on one or more of:
Network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling
Content(s) of the UEI report(s) and/or the associated performance metric(s) including latency requirement(s), resource allocation/utilization rate(s), system throughput(s) and etc.
Report/payload size(s) of the UEI report(s)—e.g., whether the report/payload size(s) of the UEI report(s) is greater than, less than or equal to a threshold, therein the threshold could be determined according to: (i) fixed value(s) in system specification(s) or per RRC configuration, and/or (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling.

Throughout the present disclosure, an UL channel/resource is used for the UEI reporting when/if higher layer RRC signaling(s)/parameter(s) and/or MAC CE command(s) and/or dynamic DCI based L1 signaling(s) that is associated/specific to the UL channel/resource configures, provides, activates or indicates, e.g., in form of one or more RRC parameters/MAC CE fields or indicators/DCI fields or indicators, that the UL channel/resource could be used for the UEI reporting as specified or defined herein in the present disclosure. For instance, the one or more RRC parameters could include or correspond to or comprise PUCCH-Resource, PUCCH-ResourceSet and/or PUCCH-Config for configuring/activating PUCCH resource(s)/PUCCH resource group(s)/PUCCH resource set(s), and/or PUSCH-Config and/or ConfiguredGrantConfig for configuring/activating PUSCH resource(s), and the UL channel/resource could be a PUCCH resource, a PUSCH resource, a PRACH preamble and etc.

Furthermore, a UE could start a timer after the transmission of a UEI report comprising content(s)/report quantity(s), e.g., associated/specific to a PN message/trigger (e.g., after the first or last symbol/slot/etc. of the transmission of the UEI report content(s)/quantity(s)), wherein the timer duration/length could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or (3) UE's autonomous determination, which could be further sent to the network via various UL channels/signals. For this case, J1 symbols/slots/etc. after the first or last symbol/slot/etc. of the transmission of the UEI report content(s)/quantity(s)—e.g., associated/specific to the PN message/trigger (denoted by non-feedback based UEI reporting, e.g., for the UEI report content(s)/quantity(s)), and/or J2 symbols/slots/etc. after the first or last symbol/slot/etc. of an ACK reception for the transmission of the UEI report content(s)/quantity(s)—e.g., associated/specific to the PN message/trigger (denoted by feedback based UEI reporting, e.g., for the UEI report content(s)/quantity(s)), and/or when/if the timer has expired (denoted by non-feedback based UEI reporting, e.g., for the UEI report content(s)/quantity(s)), the UE could start applying the content(s)/report quantity(s) in the UEI report(s)—i.e., the content(s)/report quantity(s) in the UEI report(s) could become applicable, wherein the J1 symbols/slots/etc., J2 symbols/slots/etc., and/or the timer duration/length could also be referred to as or denoted by UEI report application time.
For example, when/if the UEI report content(s)/quantity(s) comprises or corresponds to information related to TCI state(s) switch/change/update according to those specified herein in the present disclosure, J1 symbols/slots/etc. after the first or last symbol/slot/etc. of the transmission of the UEI report content(s)/quantity(s), and/or J2 symbols/slots/etc. after the first or last symbol/slot/etc. of an ACK reception for the transmission of the UEI report content(s)/quantity(s), and/or when/if the timer has expired (denoted by non-feedback based UEI reporting, e.g., for the UEI report content(s)/quantity(s)), the UE could start applying the content(s)/report quantity(s) in the UEI report(s)—for this case, start using/applying spatial domain transmit and/or receive filter(s) determined according to the information related to the TCI state(s) switch/change/update to transmit and/or receive various UL and/or DL channels/signals.
For another example, when/if the UEI report content(s)/quantity(s) comprises or corresponds to information related to MPE according to those specified herein in the present disclosure, J1 symbols/slots/etc. after the first or last symbol/slot/etc. of the transmission of the UEI report content(s)/quantity(s), and/or J2 symbols/slots/etc. after the first or last symbol/slot/etc. of an ACK reception for the transmission of the UEI report content(s)/quantity(s), and/or when/if the timer has expired (denoted by non-feedback based UEI reporting, e.g., for the UEI report content(s)/quantity(s)), the UE could start applying the content(s)/report quantity(s) in the UEI report(s)—for this case, start applying the transmission power back-off or backing off the transmission/transmit power according to the information related to the MPE following those specified herein in the present disclosure.

FIG. 12 a diagram of example timing assumptions 1200 for UE reporting according to embodiments of the present disclosure. For example, time windows 1200 can be adhered to by any of the UEs 111-116 of FIG. 1, such as the UE 112. This example is for illustration only and other embodiments can be used without departing from the scope of the present disclosure.

Under certain setting(s)/condition(s)/event(s), the UE could expect to receive an ACK (or NACK) in response to the UEI report(s) that carries/comprises/contains/includes the content(s)/report quantity(s) as defined/specified herein in the present disclosure—denoted by feedback based UEI reporting (e.g., for the UEI report content(s)/quantity(s)); for this case, i.e., when/if the UE is expected to receive an ACK (or NACK) for the UEI report(s)/content(s)/report quantity(s)—i.e., the feedback based UEI reporting, e.g., for the UEI report content(s)/quantity(s), (1) the UE could expect to receive the ACK (or NACK) for the UEI report(s)/content(s)/report quantity(s) within a time window starting from the first or last symbol/slot/etc. of the transmission of the UEI report(s)/content(s)/report quantity(s), wherein the ACK (or NACK) could be in various forms (e.g., as a DCI trigger indicated/provided by a CSI request field in the corresponding DCI format(s), e.g., 0_1, and/or a UL grant indicated/provided in DCI format(s) 0_0, 0_1 and/or 0_2, and/or transmission(s) of the CSI-RS(s)/CSI-RS resource(s) associated/specific to the PN message/trigger as specified/described herein in the present disclosure, and/or a TCI state update/switch, and/or response(s) in response to link recovery request and/or BFR MAC CE and/or PRACH transmission(s)) and/or received in/via/by MAC CE/DCI; (2) otherwise, i.e., when/if the UE does not receive from the network an ACK for the UEI report(s)/content(s)/report quantity(s) (or receives from the network a NACK for the UEI report(s)/content(s)/report quantity(s)), within a time window starting from the first or last symbol/slot/etc. of the transmission of the UEI report(s)/content(s)/report quantity(s), the UE could re-transmit or re-send the UEI report(s)/content(s)/report quantity(s), and after a maximum number of re-transmissions of the UEI report(s)/content(s)/report quantity(s), the UE could terminate or abandon the UEI reporting. The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., value(s) of the timer duration/length, J1, J2, the time window and/or the maximum number of re-transmissions of the UEI report content(s)/quantity(s). The value(s) of the timer duration/length, J1, J2, the time window and/or the maximum number of re-transmissions of the UEI report content(s)/quantity(s) that is provided/indicated/configured by the network could be selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. Optionally, the UE could autonomously determine or select value(s) of the timer duration/length, J1, J2, the time window and/or the maximum number of re-transmissions of the UEI report content(s)/quantity(s), based on a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or inform or indicate to the network, e.g., via/by/in part of the PN message/trigger, their determined/selected value(s) of the timer duration/length, J1, J2, the time window and/or the maximum number of re-transmissions of the UEI report content(s)/quantity(s); for instance, the PN message/trigger could comprise or correspond to a one-bit indicator or a multi-bit indicator or a one-level indicator or a multi-level indicator to indicate the value(s) of the timer duration/length, J1, J2, the time window and/or the maximum number of re-transmissions of the UEI report content(s)/quantity(s) selected/determined from a corresponding set of candidate values, which could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. For example, the UE could be first provided or configured or indicated by the network, e.g., via higher layer RRC signaling(s)/parameter(s) and/or MAC CE command(s) and/or dynamic DCI based L1 signaling(s)—e.g., based on or according to a UE's capability or capability signaling, a set of L≥1 candidate values for the timer duration/length; for this design example, the PN message/trigger could correspond to or comprise a └log₂ L┘-bit indicator with each state/codepoint of the └log₂ L┘-bit indicator indicating a timer duration/length from the set of L≥1 candidate values; for instance, for L=2, the PN message/trigger could correspond to or comprise a one-bit indicator; when/if the one-bit indicator is set to ‘0’ (or ‘1’), the PN message/trigger could indicate or provide to the network that the timer duration/length could correspond to the first entry/value in the set of L=2 candidate values, and/or when/if the one-bit indicator is set to ‘1’ (or ‘0’), the PN message/trigger could indicate or provide to the network that the timer duration/length could correspond to the second entry/value in the set of L=2 candidate values. The described procedure for the example of using the PN message/trigger to indicate the timer duration/length can be applied or extended to the design example(s) of using the PN message/trigger to indicate the time duration(s), time window(s) and/or the maximum number of re-transmissions of the UEI report content(s)/quantity(s) specified throughout the present disclosure. One conceptual example characterizing the described design procedure is presented in FIG. 12.

Whether or not the UE could use/apply the feedback based UEI reporting for the UEI report content(s)/quantity(s) as specified herein in the present disclosure, and/or whether or not the UE could use/apply the non-feedback based UEI reporting for the UEI report content(s)/quantity(s) as specified herein in the present disclosure could be determined or identified according to: (1) fixed rule(s)/value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or (3) UE's autonomous determination, which could be further sent to the network via various UL channels/signals.
In one example, when/if the UEI report content(s)/quantity(s) comprises or corresponds to only resource indicator(s) including SSBRI(s) and/or CRI(s) along with their corresponding/associated beam metric(s) including L1-RSRP(s)/L1-SINR(s), the UE could use/apply the non-feedback based UEI reporting scheme(s) for the corresponding UEI report content(s)/quantity(s), i.e., the UE may not expect any ACK (or NACK) for the transmission of the UEI report content(s)/quantity(s).
In another example, when/if the UEI report content(s)/quantity(s) comprises or corresponds to information related to TCI state(s) switch/change/update according to those specified herein in the present disclosure and/or information related to dynamic switching between STxMP SFN scheme and sTRP transmission according to those specified herein in the present disclosure, the UE could use/apply the feedback based UEI reporting scheme(s) for the corresponding UEI report content(s)/quantity(s), i.e., the UE could expect an ACK (or NACK) for the UEI report content(s)/quantity(s) and perform the corresponding operations following those specified herein in the present disclosure.
In another example, when/if the UEI report content(s)/quantity(s) comprises or corresponds to information related to panel status according to those specified herein in the present disclosure, and/or information related to MPE according to those specified herein in the present disclosure, the UE could use/apply (i) the non-feedback based UEI reporting scheme(s) for the corresponding UEI report content(s)/quantity(s), i.e., the UE may not expect any ACK (or NACK) for the transmission of the UEI report content(s)/quantity(s), and/or (ii) the feedback based UEI reporting scheme(s) for the corresponding UEI report content(s)/quantity(s), i.e., the UE could expect an ACK (or NACK) for the UEI report content(s)/quantity(s) and perform the corresponding operations following those specified herein in the present disclosure, based on or according to, e.g., network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling.
In another example, when/if the report/payload size of the UEI report(s)—e.g., including a pre-notification (PN) message/trigger—e.g., of (report-)type (A) or (report-)type (C) as specified herein in the present disclosure, and/or the (corresponding) content(s)/report quantity(s)—e.g., of (report-)type (B) or (report-)type (C) as specified herein in the present disclosure—is greater than or equal to (or less than or equal to) a threshold, the UE could use/apply the feedback based UEI reporting scheme(s) for the corresponding UEI report content(s)/quantity(s), i.e., the UE could expect an ACK (or NACK) for the UEI report content(s)/quantity(s) and perform the corresponding operations following those specified herein in the present disclosure; otherwise, e.g., when/if the report/payload size of the UEI report(s)—e.g., including a pre-notification (PN) message/trigger—e.g., of (report-)type (A) or (report-)type (C) as specified herein in the present disclosure, and/or the (corresponding) content(s)/report quantity(s)—e.g., of (report-)type (B) or (report-)type (C) as specified herein in the present disclosure—is less than or equal to (or greater than or equal to) the threshold, the UE could use/apply the non-feedback based UEI reporting scheme(s) for the corresponding UEI report content(s)/quantity(s), i.e., the UE may not expect any ACK (or NACK) for the transmission of the UEI report content(s)/quantity(s). The value(s) of the threshold could be determined according to: (i) fixed value(s) in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination or selection, which could be further sent to the network via various UL channel(s)/resource(s).

Throughout the present disclosure, a UEI report or a UEI report content or a UEI content or a content could also be referred to as or equivalent to a UEI report quantity or a report quantity as specified herein in the present disclosure such that they can be used interchangeably.

As specified herein in the present disclosure, a UE could use/apply the feedback based UEI reporting schemes for both the PN message/trigger and the UEI report content(s)/quantity(s), e.g., associated/specific to the PN message/trigger; i.e., for this case, the UE could expect to receive a first ACK (or NACK) for the PN message/trigger (if transmitted) following those specified herein in the present disclosure—i.e., the feedback based UEI reporting scheme for the PN message/trigger, and a second ACK (or NACK) for the corresponding UEI report content(s)/quantity(s)—if transmitted—following those specified herein in the present disclosure—i.e., the feedback based UEI reporting scheme for the UEI report content(s)/quantity(s). Alternatively, a UE could use/apply the feedback based UEI reporting schemes for either the PN message/trigger or the UEI report content(s)/quantity(s)—e.g., associated/specific to the PN message/trigger; i.e., for this case, the UE could expect to receive a first ACK (or NACK) for the PN message/trigger (if transmitted) following those specified herein in the present disclosure—i.e., the feedback based UEI reporting scheme for the PN message/trigger, but the UE may not expect to receive any (second) ACK (or NACK) for the corresponding UEI report content(s)/quantity(s), if transmitted—i.e., the non-feedback based UEI reporting scheme for the UEI report content(s)/quantity(s); or the UE may not expect to receive any (first) ACK (or NACK) for the PN message/trigger, if transmitted—i.e., the non-feedback based UEI reporting scheme for the PN message/trigger, but the UE could expect to receive a second ACK (or NACK) for the corresponding UEI report content(s)/quantity(s)—if transmitted—following those specified herein in the present disclosure—i.e., the feedback based UEI reporting scheme for the UEI report content(s)/quantity(s). Optionally, a UE could use/apply the non-feedback based UEI reporting schemes for both the PN message/trigger or the UEI report content(s)/quantity(s)—e.g., associated/specific to the PN message/trigger; i.e., for this case, the UE may not expect to receive any (first) ACK (or NACK) for the PN message/trigger (if transmitted)—i.e., the non-feedback based UEI reporting scheme for the PN message/trigger, and/or any (second) ACK (or NACK) for the corresponding UEI report content(s)/quantity(s)—if transmitted—i.e., the non-feedback based UEI reporting scheme for the UEI report content(s)/quantity(s). Whether (i) the UE could use/apply the feedback based UEI reporting schemes for both the PN message/trigger and the UEI report content(s)/quantity(s) as specified herein in the present disclosure, (ii) the UE could use/apply the feedback based UEI reporting schemes for either the PN message/trigger or the UEI report content(s)/quantity(s) as specified herein in the present disclosure, and/or (iii) the UE could use/apply the non-feedback based UEI reporting schemes for both the PN message/trigger and the UEI report content(s)/quantity(s) as specified herein in the present disclosure could be determined or identified according to: (1) fixed rule(s)/value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
In one example, when/if a UE uses/applies the non-feedback based UEI reporting scheme for the PN message/trigger, i.e., the UE could transmit or send the UEI report content(s)/quantity(s) after a time window/duration or after expiration of a timer starting from the transmission of the PN message/trigger according to those specified herein in the present disclosure (i.e., without receiving ACK/NACK for the PN message/trigger), the UE could use/apply the feedback based UEI reporting scheme for the corresponding UEI report content(s)/quantity(s), i.e., the UE could expect an ACK (or NACK) for the UEI report content(s)/quantity(s) and perform the corresponding operations following those specified herein in the present disclosure.
In another example, when/if the report/payload size of the UEI report(s)—e.g., including/comprising a pre-notification (PN) message/trigger—e.g., of (report-)type (A) or (report-)type (C) as specified herein in the present disclosure, and/or the (corresponding) content(s)/report quantity(s)—e.g., of (report-)type (B) or (report-)type (C) as specified herein in the present disclosure—is greater than or equal to (or less than or equal to) a threshold, the UE could use/apply the feedback based UEI reporting scheme(s) for the PN message/trigger and/or the corresponding UEI report content(s)/quantity(s) following those specified herein in the present disclosure, i.e., the UE could expect an ACK (or NACK) for the PN message/trigger and/or the corresponding UEI report content(s)/quantity(s) and perform the corresponding operations following those specified herein in the present disclosure; otherwise, e.g., when/if the report/payload size of the UEI report(s)—e.g., including/comprising a pre-notification (PN) message/trigger—e.g., of (report-)type (A) or (report-)type (C) as specified herein in the present disclosure, and/or the (corresponding) content(s)/report quantity(s)—e.g., of (report-)type (B) or (report-)type (C) as specified herein in the present disclosure—is less than or equal to (or greater than or equal to) the threshold, the UE could use/apply the non-feedback based UEI reporting scheme(s) for the PN message/trigger and/or the corresponding UEI report content(s)/quantity(s), i.e., the UE may not expect any ACK (or NACK) for the transmission of the PN message/trigger and/or the corresponding UEI report content(s)/quantity(s). The value(s) of the threshold could be determined according to: (i) fixed value(s) in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination or selection, which could be further sent to the network (e.g., the network 130) via various UL channel(s)/resource(s).

When/if the UEI reporting is enabled according to those specified herein in the present disclosure, a UE may not be expected to send a (new) PN message/trigger and/or corresponding/associated (new) UEI report(s)/content(s) when/if the UE is still in the process of sending a previous PN message/trigger and/or previous UEI report(s)/content(s) according to one or more of:
The UE has not received an ACK, within a time window as specified herein in the present disclosure, for a previous PN message/trigger
The UE has not received an ACK, within a time window as specified herein in the present disclosure, for a previous UEI report/content
The UE is still in a time duration after the transmission of a previous PN message/trigger, e.g., before X1, Y1, T1 or K1 symbols/slots/etc. after the first or last symbol/slot/etc. of the transmission of the previous PN message/trigger according to those specified herein in the present disclosure
The UE (e.g., the UE 116) is still in a time duration after reception of an ACK for the transmission of a previous PN message/trigger, e.g., before X2, Y2, T2 or K2 symbols/slots/etc. after the first or last symbol/slot/etc. of an ACK reception for the transmission of the previous PN message/trigger
The timer for a previous PN message/trigger as specified herein in the present disclosure has started but not expired yet
The timer for previous UEI report(s)/content(s) as specified herein in the present disclosure has started but not expired yet
The UE is in the process of (re-)sending or (re-)transmitting a previous PN message/trigger, and/or the maximum number of the (re-)transmissions for the previous PN message/trigger has not achieved yet
The UE is in the process of (re-)sending or (re-)transmitting a previous UEI report/content, and/or the maximum number of the (re-)transmissions for the previous UEI report/content has not achieved yet
The UE has determined, decided or identified to send a previous PN message/trigger, but the UE has not transmitted or has not finished transmitting the previous PN message/trigger
The UE has determined, decided or identified to send a previous UEI report/content, but the UE has not transmitted or has not finished transmitting the previous UEI report/content

Optionally, when/if the transmission of a PN message/trigger—e.g., of (report-)type (A) or (report-)type (C) as specified herein in the present disclosure (e.g., the first or last symbol/slot/etc. of the transmission of the PN message/trigger), and the transmission of a UEI report/content—e.g., of (report-)type (B) or (report-)type (C) as specified herein in the present disclosure (e.g., the first or last symbol/slot/etc. of the transmission of the UEI report/content) are within a time window (e.g., in symbol/slot/etc.), the PN message/trigger and the UEI report/content are associated such that the PN message/trigger is to indicate the transmission of the UEI report/content and/or the PN message/trigger is to request UL channel(s)/resource(s) for the transmission of the UEI report/content according to those specified herein in the present disclosure.

The UE could be provided, configured or indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, a prohibit timer (duration/length of the prohibit timer in slot/symbol/subframe/etc.) for the UEI measurement and/or reporting.
For example, the UE could start the prohibit timer from the first or last symbol/slot/etc. of the transmission of a UEI report, which could include, contain, comprise, provide or indicate a PN message/trigger of (report-)type (A) or (report-)type (C) as specified herein in the present disclosure, and/or UEI report content(s) of (report-)type (B) or (report-)type (C) as specified herein in the present disclosure.
For another example, the UE could start the prohibit timer X_0 symbols/slots/etc. after the first or last symbol/slot/etc. of the transmission of a UEI report, which could include, contain, comprise, provide or indicate a PN message/trigger of (report-)type (A) or (report-)type (C) as specified herein in the present disclosure, and/or UEI report content(s) of (report-)type (B) or (report-)type (C) as specified herein in the present disclosure, wherein the value of X_0 could be determined according to: (i) a fixed value in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination or selection, which could be further sent to the network via various UL channel(s)/resource(s).
For another example, the UE could start the prohibit timer from the first or last symbol/slot/etc. of the transmission of a PN message/trigger as specified herein in the present disclosure, e.g., of (report-)type (A) or (report-)type (C) as specified herein in the present disclosure.
For another example, the UE could start the prohibit timer X_1 symbols/slots/etc. after the first or last symbol/slot/etc. of the transmission of a PN message/trigger as specified herein in the present disclosure, e.g., of (report-)type (A) or (report-)type (C) as specified herein in the present disclosure, wherein the value of X_1 could be determined according to: (i) a fixed value in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination or selection, which could be further sent to the network via various UL channel(s)/resource(s).
For another example, the UE could start the prohibit timer from the first or last symbol/slot/etc. of the transmission of the UEI report content(s)/quantity(s) as specified herein in the present disclosure, e.g., of (report-)type (B) or (report-)type (C) as specified herein in the present disclosure.
For another example, the UE could start the prohibit timer X_2 symbols/slots after the first or last symbol/slot/etc. of the transmission of the UEI report content(s)/quantity(s) as specified herein in the present disclosure, e.g., of (report-)type (B) or (report-)type (C) as specified herein in the present disclosure, wherein the value of X_2 could be determined according to: (i) a fixed value in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination or selection, which could be further sent to the network via various UL channel(s)/resource(s).
For another example, the UE could start the prohibit timer from/upon/after the reception of an ACK for a UEI report, which could include, contain, comprise, provide or indicate a PN message/trigger of (report-)type (A) or (report-)type (C) as specified herein in the present disclosure, and/or UEI report content(s) of (report-)type (B) or (report-)type (C) as specified herein in the present disclosure.
For another example, the UE could start the prohibit timer Y_0 symbols/slots/etc. after the reception of an ACK for a UEI report, which could include, contain, comprise, provide or indicate a PN message/trigger of (report-)type (A) or (report-)type (C) as specified herein in the present disclosure, and/or UEI report content(s) of (report-)type (B) or (report-)type (C) as specified herein in the present disclosure, wherein the value of Y_0 could be determined according to: (i) a fixed value in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination or selection, which could be further sent to the network via various UL channel(s)/resource(s).
For another example, the UE could start the prohibit timer from/upon/after the reception of an ACK for a PN message/trigger as specified herein in the present disclosure, e.g., of (report-)type (A) or (report-)type (C) as specified herein in the present disclosure.
For another example, the UE could start the prohibit timer Y_1 symbols/slots/etc. after the reception of an ACK for a PN message/trigger as specified herein in the present disclosure, e.g., of (report-)type (A) or (report-)type (C) as specified herein in the present disclosure, wherein the value of Y_1 could be determined according to: (i) a fixed value in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination or selection, which could be further sent to the network via various UL channel(s)/resource(s).
For another example, the UE could start the prohibit timer from/upon/after the reception of an ACK for UEI report content(s)/quantity(s) as specified herein in the present disclosure, e.g., of (report-)type (B) or (report-)type (C) as specified herein in the present disclosure.
For another example, the UE could start the prohibit timer Y_2 symbols/slots/etc. after the reception of an ACK for UEI report content(s)/quantity(s) as specified herein in the present disclosure, e.g., of (report-)type (B) or (report-)type (C) as specified herein in the present disclosure, wherein the value of Y_2 could be determined according to: (i) a fixed value in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination or selection, which could be further sent to the network via various UL channel(s)/resource(s).
For another example, the UE could start the prohibit timer upon/after the detection of a DCI that triggers AP CSI-RS measurement/reporting—e.g., via the CSI request field in the triggering DCI of format 0_1.
For another example, the UE could start the prohibit timer Z_0 symbols/slots/etc. after the detection of a DCI that triggers AP CSI-RS measurement/reporting, wherein the value of Z_0 could be determined according to: (i) a fixed value in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination or selection, which could be further sent to the network via various UL channel(s)/resource(s), and/or the UE could start the prohibit timer after they have processed or decoded the DCI that triggers AP CSI-RS measurement/reporting (e.g., up to 4 slots after the detection of the triggering DCI).
For another example, the UE could start the prohibit timer upon/after the detection of a DCI that activates SP CSI-RS measurement/reporting.
For another example, the UE could start the prohibit timer Z_1 symbols/slots/etc. after the detection of a DCI that activates SP CSI-RS measurement/reporting, wherein the value of Z_1 could be determined according to: (i) a fixed value in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination or selection, which could be further sent to the network via various UL channel(s)/resource(s), and/or the UE could start the prohibit timer after they have processed or decoded the DCI that activates SP CSI-RS measurement/reporting (e.g., up to 4 slots after the detection of the activation DCI).

For these design examples, when/if the prohibit timer has started according to those specified herein in the present disclosure but not yet expired, (1) the UE is not expected to receive from the network a DCI that triggers (e.g., via the CSI request field in DCI format 0_1) AP CSI-RS measurement/reporting and/or a DCI that activates SP CSI-RS measurement/reporting, (2) the UE is not expected to perform or conduct AP CSI-RS measurement/reporting triggered by a DCI (e.g., via the CSI request field in DCI format 0_1) and/or SP CSI-RS measurement/reporting activated by a DCI, (3) the UE is not expected to apply a DCI, if received/detected, that triggers AP CSI-RS measurement/reporting (e.g., via the CSI request field in DCI format 0_1), and/or to apply a DCI, if received/detected, that activates SP CSI-RS measurement/reporting, and/or (4) the UE is not expected to transmit another or different or new UEI report(s)—e.g., including at least a PN message/trigger and the corresponding content(s) as specified herein in the present disclosure, and/or transmit another or different or new PN message/trigger, and/or transmit another or different or new UEI report content(s)/quantity(s) as specified herein in the present disclosure.

According to those specified herein in the present disclosure, a PN message/trigger and the corresponding UEI report content(s)/quantity(s) could be in a/the same report—referred to as or denoted by joint UEI reporting, or could be in separate reports—referred to as or denoted by separate UEI reporting. Specifically,
For the separate UEI reporting—the UEI report content(s)/quantity(s) is preceded or followed by the PN message/trigger, according to those specified herein in the present disclosure, the UE could transmit or send the PN message/trigger and the corresponding UEI report content(s)/quantity(s) in separate symbols/slots/etc., and/or in non-continuous/non-adjacent symbols/slots/etc. Furthermore, for the separate UEI reporting, the time window/duration/gap between the first or last symbol/slot/etc. of the transmission of the PN message/trigger and the first or last symbol/slot/etc. of the transmission of the corresponding UEI report content(s)/quantity(s) could be greater than or equal to a first threshold, wherein the first threshold could be determined according to (1) fixed value(s) in system specification(s) or per RRC configuration, e.g., at least one slot, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. In addition, for the separate UEI reporting and for the non-feedback based UEI reporting scheme(s) for the PN message/trigger as specified herein in the present disclosure, the time window/duration/gap of X1, Y1, T1 or K1 symbols/slots/etc. as specified/defined in the present disclosure and/or the timer duration/length as specified/defined herein in the present disclosure could be greater than or equal to a second threshold, wherein the second threshold could be determined according to (1) fixed value(s) in system specification(s) or per RRC configuration, e.g., at least one slot, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. Moreover, for the separate UEI reporting and for the feedback based UEI reporting scheme(s) for the PN message/trigger as specified herein in the present disclosure, the time window/duration/gap of X2, Y2, T2 or K2 symbols/slots/etc. as specified/defined in the present disclosure could be greater than or equal to a third threshold, wherein the third threshold could be determined according to (1) fixed value(s) in system specification(s) or per RRC configuration, e.g., at least one slot, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.
For the joint UEI reporting—the UEI report content(s)/quantity(s) is preceded or followed by the PN message/trigger, according to those specified herein in the present disclosure, the UE could transmit or send the PN message/trigger and the corresponding UEI report content(s)/quantity(s) in the same symbol(s)/slot(s)/etc., and/or in continuous/adjacent symbols/slots/etc. Furthermore, for the joint UEI reporting, the time window/duration/gap between the first or last symbol/slot/etc. of the transmission of the PN message/trigger and the first or last symbol/slot/etc. of the transmission of the corresponding UEI report content(s)/quantity(s) could be less than or equal to a first threshold, wherein the first threshold could be determined according to (1) fixed value(s) in system specification(s) or per RRC configuration, e.g., zero (0) symbol/slot/etc., (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals. In addition, for the non-feedback based UEI reporting scheme(s) for the PN message/trigger as specified herein in the present disclosure, the time window/duration/gap of X1, Y1, T1 or K1 symbols/slots/etc. as specified/defined in the present disclosure and/or the timer duration/length as specified/defined herein in the present disclosure could be less than or equal to a second threshold, wherein the second threshold could be determined according to (1) fixed value(s) in system specification(s) or per RRC configuration, e.g., zero (0) symbol/slot/etc., (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

Whether to use/apply the joint UEI reporting and/or the separate UEI reporting could be determined or identified by the UE according to (1) fixed rule(s)/value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or (3) UE's autonomous determination, which could be further sent to the network via various UL channels/signals.
For example, when/if the report/payload size of the UEI report(s)—e.g., including a pre-notification (PN) message/trigger—e.g., of (report-)type (A) or (report-)type (C) as specified herein in the present disclosure, and/or the (corresponding) content(s)/report quantity(s)—e.g., of (report-)type (B) or (report-)type (C) as specified herein in the present disclosure—is greater than or equal to (or less than or equal to) a threshold, the UE could use/apply the separate UEI reporting as specified/defined herein in the present disclosure to send/transmit the UEI report(s); otherwise, e.g., when/if the report/payload size of the UEI report(s)—e.g., including a pre-notification (PN) message/trigger—e.g., of (report-)type (A) or (report-)type (C) as specified herein in the present disclosure, and/or the (corresponding) content(s)/report quantity(s)—e.g., of (report-)type (B) or (report-)type (C) as specified herein in the present disclosure—is less than or equal to (or greater than or equal to) the threshold, the UE could use/apply the joint UEI reporting as specified/defined herein in the present disclosure to send or transmit the UEI report(s). The value(s) of the threshold could be determined according to: (i) fixed value(s) in system specification(s) or per RRC configuration, (ii) network's configuration(s)/indication(s), e.g., via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination or selection, which could be further sent to the network via various UL channel(s)/resource(s).
For another example, when/if the UEI report content(s)/quantity(s) comprises or corresponds to only resource indicator(s) including SSBRI(s) and/or CRI(s) along with their corresponding/associated beam metric(s) including L1-RSRP(s)/L1-SINR(s), the UE could use/apply the joint UEI reporting as specified/defined herein in the present disclosure to send or transmit the UEI report(s).
For another example, when/if the UEI report content(s)/quantity(s) comprises or corresponds to information related to TCI state(s) switch/change/update according to those specified herein in the present disclosure and/or information related to dynamic switching between STxMP SFN scheme and sTRP transmission according to those specified herein in the present disclosure, the UE could use/apply the separate UEI reporting as specified or defined herein in the present disclosure (or more specifically, the feedback based UEI reporting scheme(s)) to send or transmit the UEI report(s).
For another example, when/if the UEI report content(s)/quantity(s) comprises or corresponds to information related to panel status according to those specified herein in the present disclosure, and/or information related to MPE according to those specified herein in the present disclosure, the UE could use/apply (i) the joint UEI reporting as specified/defined herein in the present disclosure to send or transmit the UEI report(s), or (ii) the separate UEI reporting as specified or defined herein in the present disclosure (or more specifically, the non-feedback or feedback based UEI reporting scheme(s) based on or according to network's configuration(s)/indication(s) following those specified herein in the present disclosure) to send or transmit the UEI report(s), based on or according to, e.g., network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling.

For the joint UEI reporting as specified/defined herein in the present disclosure, the UEI report(s) that comprises the PN message/trigger and/or the corresponding UEI report content(s)/quantity(s) could correspond to or could be in form of two-part UCI (or referred to as or denoted by two-part UEI or two-part UEI report). For this case, part 1 of the two-part UCI, if present, could comprise at least the PN message/trigger, and could be of fixed report/payload size, and part 2 of the two-part UCI, if present, could comprise at least the UEI report content(s)/quantity(s)—e.g., associated/specific to the PN message/trigger in part 1—according to those specified herein in the present disclosure. Whether or not part 1 is present in the two-part UCI for the UEI reporting, and/or whether or not part 2 is present in the two-part UCI for the UEI reporting, and/or whether the UEI report(s) could correspond to or could be in form of 1-part UCI or 2-part UCI could be determined or identified by the UE according to: (1) fixed rule(s)/value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or (3) UE's autonomous determination, which could be further sent to the network via various UL channels/signals.
In one example, based on or according to (1), (2) and/or (3) specified/described herein, part 1 of the two-part UCI, i.e., the PN message/trigger, could be absent from the UEI report(s), while part 2 of the two-part UCI, i.e., the UEI report content(s)/quantity(s), could be present in the UEI report(s), following those specified in the embodiment-I in the present disclosure. For this case/design example, the UEI report(s) could correspond to or could be in form of or could be regarded as 1-part UCI.
In another example, based on or according to (1), (2) and/or (3) specified/described herein, part 1 of the two-part UCI, i.e., the PN message/trigger, could be present in the UEI report(s), while part 2 of the two-part UCI, i.e., the UEI report content(s)/quantity(s), could be absent from the UEI report(s)—or there would or could be no (further or additional) UEI report content(s)/quantity(s) associated/specific to the PN message/trigger to be transmitted or sent by the UE. For this case/design example, the (overall) report/payload size of the UEI report(s) could only be a few bits—e.g., 1 or 2 bit(s), and/or the (overall) report/payload size of the UEI report(s) is less than or equal to a threshold, wherein the threshold value could be determined according to: (i) fixed value(s) in system specification(s) or per RRC configuration, (ii) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination, which could be further sent to the network via various UL channels/signals. In this case, the UEI report(s) could correspond to or could be in form of or could be regarded as 1-part UCI.
In another example, based on or according to (1), (2) and/or (3) specified/described herein, both part 1 comprising the PN message/trigger and part 2 comprising the corresponding UEI report content(s)/quantity(s)—e.g., associated/specific to the PN message/trigger in part 1—could be present in the two-part UCI/UEI report(s). For this case/design example, the (overall) report/payload size of the UEI report(s) could be greater than or equal to a threshold, wherein the threshold value could be determined according to: (i) fixed value(s) in system specification(s) or per RRC configuration, (ii) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (iii) UE's autonomous determination, which could be further sent to the network (e.g., the network 130) via various UL channels/signals. Furthermore, part 1 of the two-part UEI report(s) could indicate or provide, e.g., via the PN message/trigger and/or other indicator(s), report/payload size of part 2 of the two-part UEI report(s) that comprises the UEI report content(s)/quantity(s). For instance, the PN message/trigger could indicate or provide or correspond to an index of an entry in a set of candidate values for the report/payload size, which could be higher layer configured/provided to the UE. Optionally, part 1 of the two-part UEI report(s) could indicate or provide, e.g., via the PN message/trigger and/or other indicator(s), whether or not part 2 is present in the UEI report(s). For instance, part 1 of the two-part UCI could comprise a first one-bit indicator (or the PN message/trigger could correspond to or comprise a first one-bit indicator); when/if the first one-bit indicator is set to ‘0’ (or ‘1’), part 2 could be absent from the UEI report(s)—i.e., the UEI report(s) could correspond to or could be in form of or could be regarded as 1-part UCI, and/or when/if the first one-bit indicator is set to ‘1’ (or ‘0’), part 2 that comprises the UEI report content(s)/quantity(s) could be present in the two-part UCI/UEI report(s). When/if part 1 of the two-part UCI indicates or provides that part 2 is absent from the UEI report(s), part 1 of the UEI report(s) could further indicate or provide, e.g., via the PN message/trigger and/or other indicator(s), whether or not the separate UEI reporting as specified/defined herein in the present disclosure is enabled, used or applied by the UE wherein the UEI report content(s)/quantity(s) associated/specific to the PN message/trigger could be sent or transmitted in a separate/different report from that of the PN message/trigger. For instance, part 1 of the UEI report(s) could comprise a second one-bit indicator (or the PN message/trigger could correspond to or comprise a second one-bit indicator); when/if the second one-bit indicator is set to ‘0’ (or ‘1’), there could or would be no (further or additional) UEI report content(s)/quantity(s) associated/specific to the PN message/trigger to be transmitted/sent by the UE, and/or when/if the second one-bit indicator is set to ‘1’ (or ‘0’), there could or would be (further or additional) UEI report content(s)/quantity(s) associated/specific to the PN message/trigger, which could be transmitted/sent in a separate/different report from that of the PN message/trigger (i.e., the separate UEI reporting).

In one example, when/if the UEI report(s) corresponds to or is in form of or is regarded as 1-part UCI comprising only part 1 of PN message/trigger according to those specified herein in the present disclosure, the UE could use/apply the non-feedback based UEI reporting scheme(s) for the PN message/trigger and/or the feedback based UEI reporting scheme(s) for the PN message/trigger as specified/defined herein in the present disclosure to transmit or send the PN message/trigger, and if any, the corresponding UEI report content(s)/quantity(s) following those specified herein in the present disclosure—e.g., the UE could use/apply the separate UEI reporting as defined/specified herein in the present disclosure to transmit or send the PN message/trigger and the corresponding UEI report content(s)/quantity(s).

In one example, when/if the UEI report(s) corresponds to or is in form of or is regarded as 1-part UCI comprising only part 2 of UEI report content(s)/quantity(s) according to those specified herein in the present disclosure, the UE (e.g., the UE 116) could use/apply the non-feedback based UEI reporting scheme(s) for the UEI report content(s)/quantity(s) and/or the feedback based UEI reporting scheme(s) for the UEI report content(s)/quantity(s) as specified/defined herein in the present disclosure to transmit or send the UEI report content(s)/quantity(s) and perform the corresponding operations following those specified herein in the present disclosure.

In one example, when/if the UEI report(s) corresponds to or is in form of or is regarded as 2-part UCI comprising both part 1 of PN message/trigger and part 2 of UEI report content(s)/quantity(s) according to those specified herein in the present disclosure,
the UE could expect to receive an ACK (or NACK), e.g., within a time window starting from the first or last symbol/slot/etc. of the transmission of the UEI report(s), for the two-part UEI report(s). For this case/setting, when/if the UE receives from the network an ACK, e.g., within a time window starting from the first or last symbol/slot/etc. of the transmission of the UEI report(s), for the two-part UEI report(s), after the UEI report application time as defined/specified herein in the present disclosure, the UE could apply the UEI report content(s)/quantity(s) in the two-part UCI and/or the UE could expect that the UEI report content(s)/quantity(s) in the two-part UEI report(s) would or could have become applicable following those specified herein in the present disclosure. When/if the UE does not receive from the network an ACK (or receives from the network a NACK), e.g., within a time window starting from the first or last symbol/slot/etc. of the transmission of the UEI report(s), for the two-part UEI report(s),
   for example, the UE could re-transmit or re-send the two-part UEI report(s), and after a maximum number of re-transmissions of the two-part UEI report(s), the UE could terminate or abandon the UEI reporting; for this case, when/if the UE receives from the network an ACK, e.g., within a time window starting from the first or last symbol/slot/etc. of the transmission of a re-transmitted/re-sent two-part UEI report(s), for the re-transmitted/re-sent two-part UEI report(s), after the UEI report application time as defined/specified herein in the present disclosure, the UE could apply the UEI report content(s)/quantity(s) in the two-part UCI and/or the UE could expect that the UEI report content(s)/quantity(s) in the two-part UCI would or could have become applicable following those specified herein in the present disclosure.
   for another example, the UE could re-transmit or re-send part 1 of the two-part UEI report(s)—i.e., the PN message/trigger, and after a maximum number of re-transmissions of the part 1 PN message/trigger, the UE could terminate or abandon the UEI reporting; for this case, when/if the UE receives from the network an ACK, e.g., within a time window starting from the first or last symbol/slot/etc. of the transmission of a re-transmitted/re-sent part 1 PN message/trigger, for the re-transmitted/re-sent PN message/trigger, the UE could use/apply the feedback based UEI reporting scheme(s) for the PN message/trigger, and/or the feedback or non-feedback based UEI reporting scheme(s) for the UEI report content(s)/quantity(s), following those specified herein in the present disclosure, to transmit/send the UEI report content(s)/quantity(s) associated/specific to the PN message/trigger, and perform the corresponding operations according to those specified herein in the present disclosure.
   for another example, the UE could re-transmit or re-send part 2 of the two-part UEI report(s)—i.e., the UEI report content(s)/quantity(s) associated/specific to the PN message/trigger, and after a maximum number of re-transmissions of the part 2 UEI report content(s)/quantity(s), the UE could terminate or abandon the UEI reporting; for this case, when/if the UE receives from the network an ACK, e.g., within a time window starting from the first or last symbol/slot/etc. of the transmission of a re-transmitted/re-sent part 2 UEI report content(s)/quantity(s), for the re-transmitted/re-sent part 2 UEI report content(s)/quantity(s), after the UEI report application time as defined/specified herein in the present disclosure, the UE could apply the UEI report content(s)/quantity(s) in the two-part UCI and/or the UE could expect that the UEI report content(s)/quantity(s) in the two-part UCI would or could have become applicable following those specified herein in the present disclosure.
the UE could expect to receive an ACK (or NACK), e.g., within a time window starting from the first or last symbol/slot/etc. of the transmission of the UEI report(s), for part 1 of the two-part UEI report(s)—i.e., the PN message/trigger. For this case/setting, when/if the UE receives from the network an ACK, e.g., within a time window starting from the first or last symbol/slot/etc. of the transmission of the UEI report(s), for the part 1 PN message/trigger, the UE could use/apply the feedback based UEI reporting scheme(s) for the PN message/trigger, and/or the feedback or non-feedback based UEI reporting scheme(s) for the UEI report content(s)/quantity(s), following those specified herein in the present disclosure, to transmit/send the UEI report content(s)/quantity(s) associated/specific to the PN message/trigger, and perform the corresponding operations according to those specified herein in the present disclosure. When/if the UE does not receive from the network an ACK (or receives from the network a NACK), e.g., within a time window starting from the first or last symbol/slot/etc. of the transmission of the UEI report(s), for the part 1 PN message/trigger,
   for example, the UE could re-transmit or re-send the two-part UEI report(s), and after a maximum number of re-transmissions of the two-part UEI report(s), the UE could terminate or abandon the UEI reporting; for this case, when/if the UE receives from the network an ACK, e.g., within a time window starting from the first or last symbol/slot/etc. of the transmission of a re-transmitted/re-sent two-part UEI report(s), for the re-transmitted/re-sent two-part UEI report(s), after the UEI report application time as defined/specified herein in the present disclosure, the UE could apply the UEI report content(s)/quantity(s) in the two-part UCI and/or the UE could expect that the UEI report content(s)/quantity(s) in the two-part UCI would or could have become applicable following those specified herein in the present disclosure.
   for another example, the UE could re-transmit or re-send part 1 of the two-part UEI report(s)—i.e., the PN message/trigger, and after a maximum number of re-transmissions of the part 1 PN message/trigger, the UE could terminate or abandon the UEI reporting; for this case, when/if the UE receives from the network an ACK, e.g., within a time window starting from the first or last symbol/slot/etc. of the transmission of a re-transmitted/re-sent part 1 PN message/trigger, for the re-transmitted/re-sent PN message/trigger, the UE could use/apply the feedback based UEI reporting scheme(s) for the PN message/trigger, and/or the feedback or non-feedback based UEI reporting scheme(s) for the UEI report content(s)/quantity(s), following those specified herein in the present disclosure, to transmit/send the UEI report content(s)/quantity(s) associated/specific to the PN message/trigger, and perform the corresponding operations according to those specified herein in the present disclosure.
   for another example, the UE could re-transmit or re-send part 2 of the two-part UEI report(s)—i.e., the UEI report content(s)/quantity(s) associated/specific to the PN message/trigger, and after a maximum number of re-transmissions of the part 2 UEI report content(s)/quantity(s), the UE could terminate or abandon the UEI reporting; for this case, when/if the UE receives from the network an ACK, e.g., within a time window starting from the first or last symbol/slot/etc. of the transmission of a re-transmitted/re-sent part 2 UEI report content(s)/quantity(s), for the re-transmitted/re-sent part 2 UEI report content(s)/quantity(s), after the UEI report application time as defined/specified herein in the present disclosure, the UE could apply the UEI report content(s)/quantity(s) in the two-part UCI and/or the UE could expect that the UEI report content(s)/quantity(s) in the two-part UCI would or could have become applicable following those specified herein in the present disclosure.
the UE could expect to receive an ACK (or NACK), e.g., within a time window starting from the first or last symbol/slot/etc. of the transmission of the UEI report(s), for part 2 of the two-part UEI report(s)—i.e., the UEI report content(s)/quantity(s) associated/specific to the PN message/trigger. For this case/setting, when/if the UE receives from the network an ACK, e.g., within a time window starting from the first or last symbol/slot/etc. of the transmission of the UEI report(s), for the part 2 UEI report content(s)/quantity(s), after the UEI report application time as defined/specified herein in the present disclosure, the UE could apply the UEI report content(s)/quantity(s) in the two-part UCI and/or the UE could expect that the UEI report content(s)/quantity(s) in the two-part UCI would or could have become applicable. When/if the UE does not receive from the network an ACK (or receives from the network a NACK), e.g., within a time window starting from the first or last symbol/slot/etc. of the transmission of the UEI report(s), for the part 2 UEI report content(s)/quantity(s),
   for example, the UE could re-transmit or re-send the two-part UEI report(s), and after a maximum number of re-transmissions of the two-part UEI report(s), the UE could terminate or abandon the UEI reporting; for this case, when/if the UE receives from the network an ACK, e.g., within a time window starting from the first or last symbol/slot/etc. of the transmission of a re-transmitted/re-sent two-part UEI report(s), for the re-transmitted/re-sent two-part UEI report(s), after the UEI report application time as defined/specified herein in the present disclosure, the UE could apply the UEI report content(s)/quantity(s) in the two-part UCI and/or the UE could expect that the UEI report content(s)/quantity(s) in the two-part UCI would or could have become applicable following those specified herein in the present disclosure.
   for another example, the UE could re-transmit or re-send part 1 of the two-part UEI report(s)—i.e., the PN message/trigger, and after a maximum number of re-transmissions of the part 1 PN message/trigger, the UE could terminate or abandon the UEI reporting; for this case, when/if the UE receives from the network an ACK, e.g., within a time window starting from the first or last symbol/slot/etc. of the transmission of a re-transmitted/re-sent part 1 PN message/trigger, for the re-transmitted/re-sent PN message/trigger, the UE could use/apply the feedback based UEI reporting scheme(s) for the PN message/trigger, and/or the feedback or non-feedback based UEI reporting scheme(s) for the UEI report content(s)/quantity(s), following those specified herein in the present disclosure, to transmit/send the UEI report content(s)/quantity(s) associated/specific to the PN message/trigger, and perform the corresponding operations according to those specified herein in the present disclosure.
   for another example, the UE could re-transmit or re-send part 2 of the two-part UEI report(s)—i.e., the UEI report content(s)/quantity(s) associated/specific to the PN message/trigger, and after a maximum number of re-transmissions of the part 2 UEI report content(s)/quantity(s), the UE could terminate or abandon the UEI reporting; for this case, when/if the UE receives from the network an ACK, e.g., within a time window starting from the first or last symbol/slot/etc. of the transmission of a re-transmitted/re-sent part 2 UEI report content(s)/quantity(s), for the re-transmitted/re-sent part 2 UEI report content(s)/quantity(s), after the UEI report application time as defined/specified herein in the present disclosure, the UE could apply the UEI report content(s)/quantity(s) in the two-part UCI and/or the UE could expect that the UEI report content(s)/quantity(s) in the two-part UCI would or could have become applicable following those specified herein in the present disclosure.

For these design examples, the value(s) of the time window, the maximum number of re-transmissions of the two-part UCI/UEI report(s)—e.g., in its entirety, the maximum number of re-transmissions of the part 1 PN message/trigger, and/or the maximum number of re-transmissions of the part 2 UEI report content(s)/quantity(s) could be determined according to: (1) fixed value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling, and/or (3) UE's autonomous determination, which could be further sent to the network via various UL channels/signals.

According to those specified herein in the present disclosure, an ACK (or NACK) for the PN message/trigger, e.g., in (part of) a (report-)type (A) based report or a (report-)type (C) based report, and/or the UEI report content(s)/quantity(s), e.g., in (part of) a (report-)type (B) based report or a (report-)type (C) based report, could be in various forms and sent via dynamic DCI signaling/MAC CE command.
In one example, the ACK (or NACK) could be explicitly provided or indicated to the UE, wherein the ACK (or NACK) could correspond to or could be in form of a dedicated/new DCI/PDCCH (e.g., a dedicated/new DCI format), a DCI field (e.g., a dedicated/new DCI field or a repurposed existing DCI field—e.g., set to a particular value) of a DCI format, a DCI/PDCCH validation for the UEI reporting, and/or etc.
In another example, the ACK (or NACK) could be implicitly provided or indicated to the UE, wherein the ACK (or NACK) could correspond or could be in form of:
   an UL grant/assignment, or a dynamic PUSCH scheduling, or a DCI format scheduling PUSCH transmission
   a DCI/PDCCH (e.g., of DCI format 0_1) that triggers AP CSI-RS measurement/reporting, and/or a DCI/PDCCH (e.g., of DCI format 0_1) that activates SP CSI-RS measurement/reporting
   a ‘CSI request’ field (e.g., set to a valid value) indicated/provided in a DCI that triggers AP CSI-RS measurement/reporting, and/or in a DCI that activates SP CSI-RS measurement/reporting
   transmission(s)/reception(s) of measurement RS(s) initiated/triggered by the UE via the UEI reporting as specified herein in the present disclosure
   (enhanced) TCI state(s) activation/deactivation MAC CE command(s)
   TCI state(s) update/indication—e.g., update/indication of the first TCI state(s) of a TCI codepoint or associated/specific to value 0 of coresetPoolIndex and/or update/indication of the second TCI state(s) of a TCI codepoint or associated/specific to value 1 of coresetPoolIndex—via MAC CE or dynamic DCI based L1 signaling (e.g., via ‘Transmission Configuration Indication’ field(s) in DCI format 1_1/1_2 with or without DL assignment)
   ‘TCI selection’ field in DCI format 1_1/1_2 set to valid value(s) including ‘00’, ‘01’, ‘10’ or ‘11’
   ‘SRS resource set indicator/indication’ field in DCI format 0_1/0_2 set to valid value(s) including ‘00’, ‘01’, ‘10’ or ‘11’
   a PDCCH reception in a (existing, particular or dedicated) search space set, e.g., provided by recoverySearchSpaceId or ueiSearchSpaceId where the UE could detect a DCI format with cyclic redundancy check (CRC) scrambled by cell-radio network temporary identifier (C-RNTI) or modulation and coding scheme (MCS)-C-RNTI
   a PDCCH reception that determines the completion of the contention based random access procedure
   a PDCCH reception with a DCI format scheduling a PUSCH transmission with a same HARQ process number as for the transmission of the PUSCH that carries the information related to the UEI reporting and having a toggled new data indicator (NDI) field value

A UE could expect to receive one or more of the explicit ACK (or NACK) forms and/or one or more of the implicit ACK (or NACK) forms for the PN message/trigger and/or the corresponding UEI report content(s)/quantity(s) as specified herein in the present disclosure according to: (1) fixed rule(s)/value(s) in system specification(s) or per RRC configuration, (2) network's configuration(s)/indication(s) via higher layer RRC signaling(s)/parameter(s) and/or MAC CE command(s) and/or dynamic DCI based L1 signaling(s)—e.g., based on or according to a corresponding UE's capability or capability signaling and/or one or more conditions or events including exact content(s)/report quantity(s) in the UEI report(s), latency/overhead requirement(s) for the UEI report(s), payload/report size of the UEI report(s) and/or etc., and/or (3) UE's autonomous determination, which could be further sent to the network, e.g., via the PN message/trigger, on various UL channels/signals.

Throughout the present disclosure, the UEI report(s)—including the PN message/trigger and/or the corresponding UEI report content(s)/quantity(s)—could be of new UCI type(s) or of new SR configuration(s). Furthermore, the UEI report(s) could be transmitted or sent in PUCCH and/or multiplexed with other UCI types including HARQ-ACK, CSI, SR and/or etc. Optionally, the UEI report(s) could be transmitted or sent in PUSCH and/or multiplexed with other UCI types including HARQ-ACK, CSI and/or etc. and UL data. Alternatively, the UEI report(s) could be transmitted or sent in PUSCH in form of MAC CE and/or RRC signaling(s).

For the UEI reporting procedure(s) specified/defined herein in the present disclosure, the PN message/trigger could be of or could correspond to a new UCI type—e.g., denoted by UEI_UCI, and transmitted/multiplexed on one or more UL resources including PUCCH resource(s) and/or PUSCH resource(s) according to those specified herein in the present disclosure. In this case, the one or more UL resources as described herein in the present disclosure could be used to transmit, send or carry the UEI report content(s)/report quantity(s)—e.g., corresponding/associated to the PN message/trigger or the UEI-UCI—as specified herein in the present disclosure. For this design example, when/if the UE is higher layer configured/provided nrof_UEI_UCI with value equal to O^{UEI-UCI} in higher layer parameter(s) that provides/configures the UL resource(s) including PUCCH resource(s), DG and/or CG Type-1/2 PUSCH resource(s) for transmitting the exact content(s)/report quantity(s) in the UEI report(s) according to those specified herein in the present disclosure, e.g., PUCCH-Config/PUCCH-ResourceSet/PUCCH-Resource of a PUCCH configuration/PUCCH resource set/PUCCH resource and/or configuredGrantConfig of a CG-PUSCH configuration, the UE could multiplex the UEI-UCI represented by a bitmap of O^{UEI-UCI} bits in each PUCCH transmission for the PUCCH configuration and/or for/in the PUCCH resource set and/or of the PUCCH resource, and/or in each CG-PUSCH transmission for the CG-PUSCH configuration. The O^{UEI-UCI} bits of UEI-UCI, õ₀^{UEI-UCI}, õ₁^{UEI-UCI}, . . . , õₒ_{^{UEI-UCI}}₋₁^{UEI-UCI}, could have a one-to-one mapping to O^{UEI-UCI} subsequent PUCCH and/or CG PUSCH transmission occasions (TOs) in ascending or descending order of start time. For unpaired spectrum operation, the subsequent PUCCH and/or CG-PUSCH TOs as described/specified herein in the present disclosure may exclude invalid ones where a UE may not transmit a PUCCH/PUSCH. In particular, a bit value of ‘0’ could indicate that the UE may transmit (or will not transmit) PUCCH in a corresponding PUCCH TO, and/or CG-PUSCH in a corresponding CG-PUSCH TO, to carry the UEI report content(s)/report quantity(s)—e.g., corresponding/associated to the PN message/trigger or the UEI-UCI—as specified herein in the present disclosure, and a bit value of ‘1’ could indicate that the UE will not transmit (or may transmit) PUCCH in a corresponding PUCCH TO, and/or CG-PUSCH in a corresponding CG-PUSCH TO, to carry the UEI report content(s)/report quantity(s)—e.g., corresponding/associated to the PN message/trigger or the UEI-UCI—as specified herein in the present disclosure. When the UE indicates (by) UEI-UCI a value of ‘1’ (or ‘0’) for a PUCCH TO and/or a CG-PUSCH TO according to those specified herein in the present disclosure, the UE could continue to indicate the value ‘1’ (or ‘0’) for the PUCCH TO and/or the CG-PUSCH TO by UEI-UCI multiplexed in subsequent PUCCH and/or CG-PUSCH transmissions, and the UE may not transmit PUCCH in the PUCCH TO and/or the CG-PUSCH in the CG-PUSCH TO, to carry the UEI report content(s)/report quantity(s)—e.g., corresponding/associated to the PN message/trigger or the UEI-UCI—as specified herein in the present disclosure.

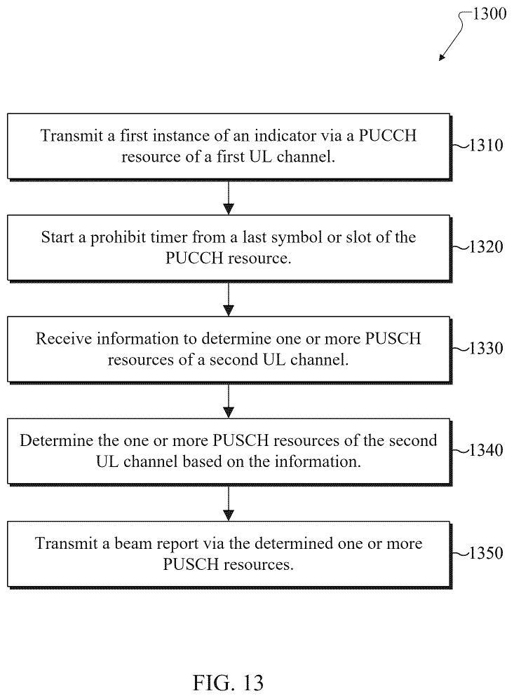

FIG. 13 illustrates an example method 1300 performed by a UE in a wireless communication system according to embodiments of the present disclosure. The method 1300 of FIG. 13 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

The method begins with the UE transmitting a first instance of an indicator via a PUCCH resource of a first UL channel (1310). The UE then starts a prohibit timer from a last symbol or slot of the PUCCH resource (1320). For example, in 1320, when the prohibit timer is running, the UE does not transmit any additional instance of the indicator.

The UE then receives information to determine one or more PUSCH resources of a second UL channel (1330). In various embodiments, when the first instance of the indicator indicates a request for an UL grant to transmit the beam report, the UE receives the information in DCI and the information includes at least time and frequency domain resource allocations to determine the one or more PUSCH resources. In various embodiments, when the first instance of the indicator indicates to notify transmission of the beam report, the UE receives the information in a RRC signaling, and the information includes at least one of a periodicity and an offset relative to the PUCCH resource and a time gap.

The UE then determines the one or more PUSCH resources of the second UL channel based on the information (1340). For example, in 1340, the determined one or more PUSCH resources start at least after the time gap from the last symbol or slot of the PUCCH resource.

The UE then transmits a beam report via the determined one or more PUSCH resources (1350). For example, in 1350, the beam report includes a beam metric of a L1-RSRP and a TCI state. In various embodiments, when the first instance of the indicator indicates to trigger CSI measurement and reporting, UE receives the information in DCI and the information includes resource configuration for one or more CSI-RSs and time and frequency domain resource allocations for determining the one or more PUSCH resources. The measures the one or more CSI-RSs based on the resource configuration and determine the beam report based on the measurement.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to transmit, via a physical uplink control channel (PUCCH) resource of a first uplink (UL) channel, a first instance of an indicator; and
a processor operably coupled with the transceiver, the processor configured to start a prohibit timer from a last symbol or slot of the PUCCH resource;
wherein the transceiver is further configured to receive information to determine one or more physical uplink shared channel (PUSCH) resources of a second UL channel;
wherein the processor is further configured to determine, based on the information, the one or more PUSCH resources of the second UL channel; and
wherein the transceiver is further configured to transmit, via the determined one or more PUSCH resources, a beam report.

2. The UE of claim 1, wherein:
when the first instance of the indicator indicates a request for an UL grant to transmit the beam report, the transceiver is further configured to receive, in downlink control information (DCI), the information, and
the information includes at least time and frequency domain resource allocations to determine the one or more PUSCH resources.

3. The UE of claim 1, wherein:
when the first instance of the indicator indicates to notify transmission of the beam report, the transceiver is further configured to receive, in a radio resource control (RRC) signaling, the information, and
the information includes at least one of:
a periodicity and an offset relative to the PUCCH resource; and
a time gap.

4. The UE of claim 3, wherein the determined one or more PUSCH resources start at least after the time gap from the last symbol or slot of the PUCCH resource.

5. The UE of claim 1, wherein, when the prohibit timer is running, the transceiver does not transmit a second instance of the indicator.

6. The UE of claim 1, wherein the beam report includes:
a beam metric of layer-1 reference signal receive power (L1-RSRP); and
a transmission configuration indication (TCI) state.

7. The UE of claim 1, wherein:
when the first instance of the indicator indicates to trigger channel state information (CSI) measurement and reporting, the transceiver is further configured to receive, in downlink control information (DCI), the information;
the information includes:
resource configuration for one or more CSI reference signals (CSI-RSs); and
time and frequency domain resource allocations for determining the one or more PUSCH resources;
the transceiver is further configured to measure, based on the resource configuration, the one or more CSI-RSs; and
the processor is further configured to determine, based on the measurement, the beam report.

8. A base station (BS), comprising:
a processor; and
a transceiver operably coupled to the processor, the transceiver configured to:
receive, via a physical uplink control channel (PUCCH) resource of a first uplink (UL) channel, a first instance of an indicator, wherein a prohibit timer runs from a last symbol or slot of the PUCCH resource;
transmit information to indicate one or more physical uplink shared channel (PUSCH) resources of a second UL channel; and
receive, via the one or more PUSCH resources, a beam report.

9. The BS of claim 8, wherein:
when the first instance of the indicator indicates a request for an UL grant for the beam report, the transceiver is further configured to transmit, in downlink control information (DCI), the information, and
the information includes at least time and frequency domain resource allocations to indicate the one or more PUSCH resources.

10. The BS of claim 8, wherein:
when the first instance of the indicator indicates to notify transmission of the beam report, the transceiver is further configured to transmit, in a radio resource control (RRC) signaling, the information, and
the information includes at least one of:
a periodicity and an offset relative to the PUCCH resource; and
a time gap.

11. The BS of claim 10, wherein the one or more PUSCH resources start at least after the time gap from the last symbol or slot of the PUCCH resource.

12. The BS of claim 8, wherein, when the prohibit timer is running, the transceiver does not receive a second instance of the indicator.

13. The BS of claim 8, wherein the beam report includes:
a beam metric of layer-1 reference signal receive power (L1-RSRP); and
a transmission configuration indication (TCI) state.

14. The BS of claim 8, wherein:
when the first instance of the indicator indicates to trigger channel state information (CSI) measurement and reporting, the transceiver is further configured to transmit, in downlink control information (DCI), the information;
the information includes:
a resource configuration for one or more CSI reference signals (CSI-RSs); and
time and frequency domain resource allocations for the one or more PUSCH resources; and
the beam report is based on the one or more CSI-RSs.

15. A method performed by a user equipment (UE), the method comprising:
transmitting, via a physical uplink control channel (PUCCH) resource of a first uplink (UL) channel, a first instance of an indicator;
starting a prohibit timer from a last symbol or slot of the PUCCH resource;
receiving information to determine one or more physical uplink shared channel (PUSCH) resources of a second UL channel;
determining, based on the information, the one or more PUSCH resources of the second UL channel; and
transmitting, via the determined one or more PUSCH resources, a beam report.

16. The method of claim 15, wherein:
receiving the information further comprises, when the first instance of the indicator indicates a request for an UL grant to transmit the beam report, receiving, in downlink control information (DCI), the information, and
the information includes at least time and frequency domain resource allocations to determine the one or more PUSCH resources.

17. The method of claim 15, wherein:
receiving the information further comprises, when the first instance of the indicator indicates to notify transmission of the beam report, receiving, in a radio resource control (RRC) signaling, the information, and
the information includes at least one of:
a periodicity and an offset relative to the PUCCH resource; and
a time gap.

18. The method of claim 17, wherein the determined one or more PUSCH resources start at least after the time gap from the last symbol or slot of the PUCCH resource.

19. The method of claim 15, wherein, when the prohibit timer is running, a second instance of the indicator is not transmitted.

20. The method of claim 15, wherein the beam report includes:
a beam metric of layer-1 reference signal receive power (L1-RSRP); and
a transmission configuration indication (TCI) state.
